(19) United States
(12) Patent Application Publication
(10) Pub. No.: US 2025/0383750 A1
(43) Pub. Date: Dec. 18, 2025

(54) DEVICES, METHODS, AND GRAPHICAL USER INTERFACES FOR MANIPULATING VIRTUAL OBJECTS IN A THREE-DIMENSIONAL ENVIRONMENT

(71) Applicant: Apple Inc., Cupertino, CA (US)

(72) Inventors: David LUI, San Jose, CA (US); Ian A. MCCALL, Sunnyvale, CA (US); Shuai SONG, San Jose, CA (US); Jonathan RAVASZ, Sunnyvale, CA (US); Giancarlo YERKES, San Francisco, CA (US); Jay MOON, San Francisco, CA (US); Stephen O. LEMAY, Palo Alto, CA (US)

(21) Appl. No.: 19/222,462

(22) Filed: May 29, 2025

Related U.S. Application Data
(60) Provisional application No. 63/657,940, filed on Jun. 9, 2024.

(51) Int. Cl. G06F 3/04815; G06F 3/04845; G06T 19/20

(52) U.S. Cl. CPC G06F 3/04815; G06F 3/04845; G06T 19/20; G06T 2200/24; G06T 2219/024; G06T 2219/2016

(57) ABSTRACT

In some embodiments, a computer system snaps a virtual object to a surface within a three-dimensional environment when one or more criteria are met. In some embodiments, a computer system displays a representation of a respective type of virtual object with one or more values for one or more visual characteristics in a three-dimensional environment.

### CROSS REFERENCE TO RELATED APPLICATIONS

This application claims the benefit of U.S. Provisional Application No. 63/657,940, filed Jun. 9, 2024, the entire disclosure of which is herein incorporated by reference for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, while displaying, via a display generation component, a virtual object at a first location that is a first distance from a first surface in a three-dimensional environment, a computer system detects a first input, via one or more input devices, corresponding to moving the virtual object to a second location within the three-dimensional environment that is a second distance, different from the first distance, from the first surface, wherein the first location is further than a threshold distance from the first surface and the second location is closer than the threshold distance from the first surface. In some embodiments, in response to detecting the first input, in accordance with a determination that one or more snapping criteria are satisfied while the virtual object is the second distance from the first surface, the computer system moves the virtual object to a third location that is closer to the first surface than the first location and the second location. In some embodiments, in response to detecting the first input, in accordance with a determination that the one or more snapping criteria are not satisfied while the virtual object is the second distance from the first surface, the computer system moves the virtual object to the second location without moving the virtual object closer to the first surface.

In some embodiments, while displaying via one or more display generation components, a representation of a respective type of virtual object at a first pose in a three-dimensional environment, wherein the displayed representation of the respective type of virtual object includes a first value for a first visual characteristic, a computer system receives a request to display a representation of the respective type of virtual object with a second value for the first visual characteristic, wherein the second value for the first visual characteristic is different from the first value for the first visual characteristic. In some embodiments, in response to receiving the request to display a representation of the respective type of virtual object with the second value for the first visual characteristic, the computer system displays, via the one or more display generation components, a representation of the respective type of virtual object with a second value for the first visual characteristic with the first pose in the three-dimensional environment, wherein displaying the virtual object with the second value for the first visual characteristic includes displaying the virtual object without the first value for the first visual characteristic.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7AD illustrate examples of a computer system snapping a virtual object to a surface within a three-dimensional environment, in accordance with some embodiments.

FIG. 8 is a flowchart illustrating an example method of a computer system snapping a virtual object to a surface within a three-dimensional environment, in accordance with some embodiments.

FIGS. 9A-9JJ illustrate examples of a computer system displaying representations of respective types of virtual objects in a three-dimensional environment, in accordance with some embodiments.

FIG. 10 is a flowchart illustrating an example method of a computer system displaying a representation of a respective type of virtual object in a three-dimensional environment, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, while displaying, via a display generation component, a virtual object at a first location that is a first distance from a first surface in a three-dimensional environment, a computer system detects a first input, via one or more input devices, corresponding to moving the virtual object to a second location within the three-dimensional environment that is a second distance, different from the first distance, from the first surface, wherein the first location is further than a threshold distance from the first surface and the second location is closer than the threshold distance from the first surface. In some embodiments, in response to detecting the first input, in accordance with a determination that one or more snapping criteria are satisfied while the virtual object is the second distance from the first surface, the computer system moves the virtual object to a third location that is closer to the first surface than the first location and the second location. In some embodiments, in response to detecting the first input, in accordance with a determination that the one or more snapping criteria are not satisfied while the virtual object is the second distance from the first surface, the computer system moves the virtual object to the second location without moving the virtual object closer to the first surface.

In some embodiments, while displaying via one or more display generation components, a representation of a respective type of virtual object at a first pose in a three-dimensional environment, wherein the displayed representation of the respective type of virtual object includes a first value for a first visual characteristic, a computer system receives a request to display a representation of the respective type of virtual object with a second value for the first visual characteristic, wherein the second value for the first visual characteristic is different from the first value for the first visual characteristic. In some embodiments, in response to receiving the request to display a representation of the respective type of virtual object with the second value for the first visual characteristic, the computer system displays, via the one or more display generation components, a representation of the respective type of virtual object with a second value for the first visual characteristic with the first pose in the three-dimensional environment, wherein displaying the virtual object with the second value for the first visual characteristic includes displaying the virtual object without the first value for the first visual characteristic.

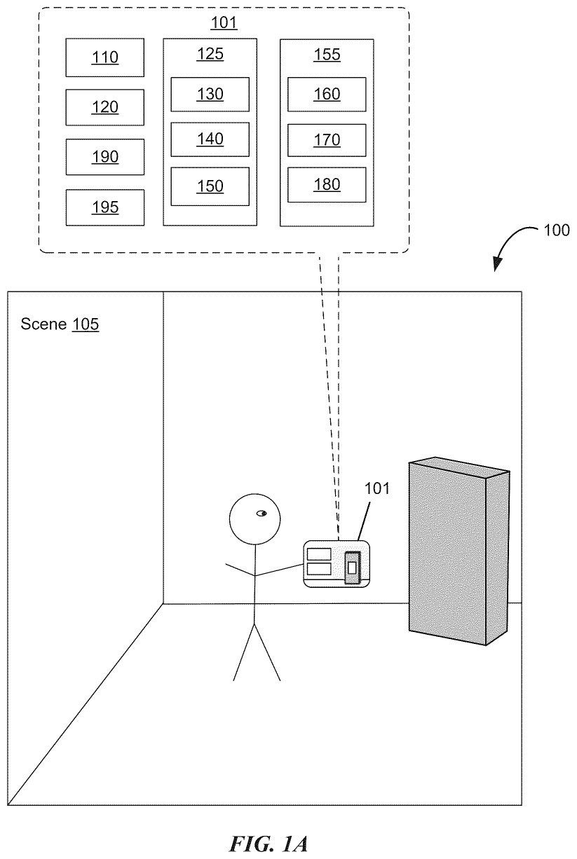

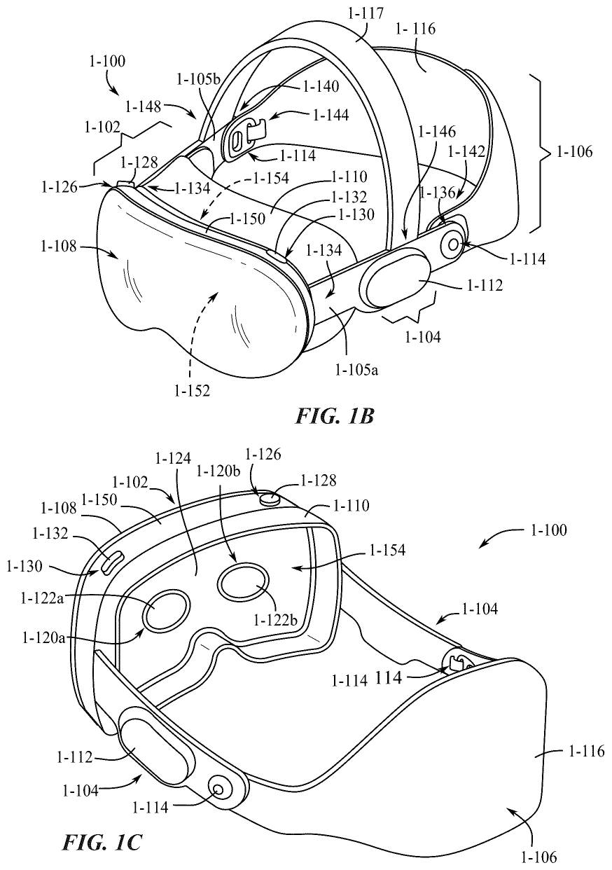

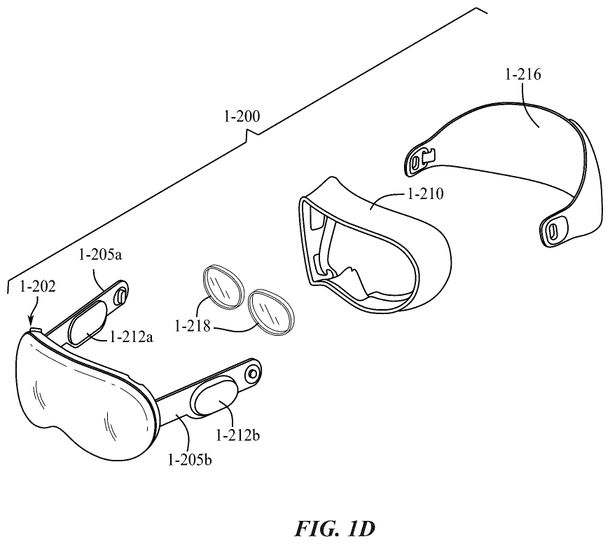

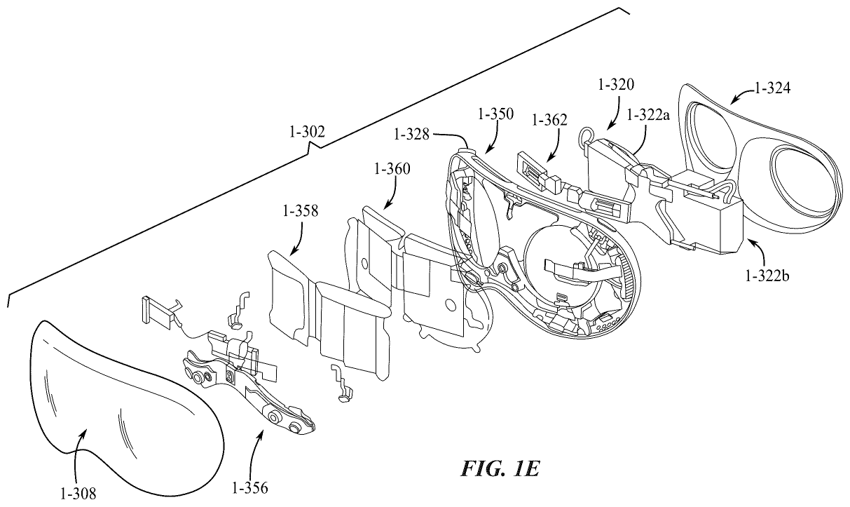

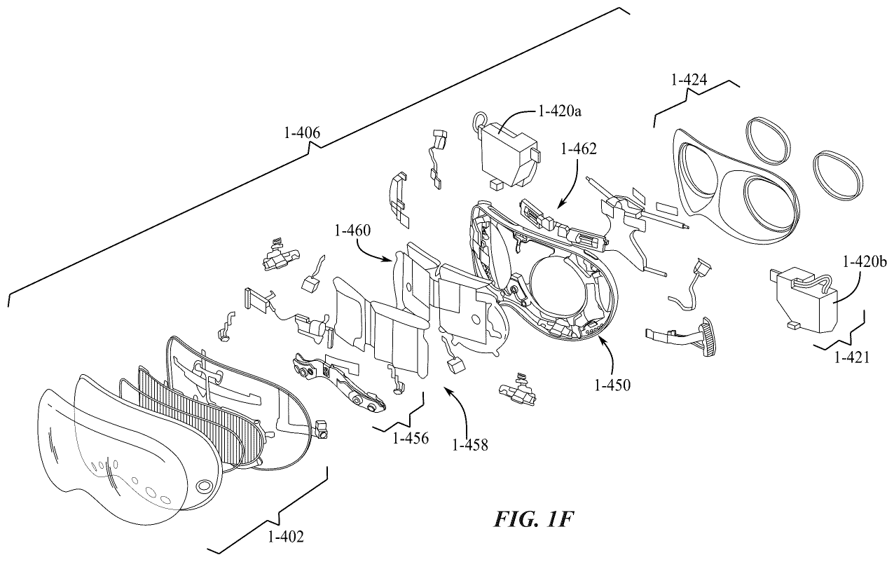

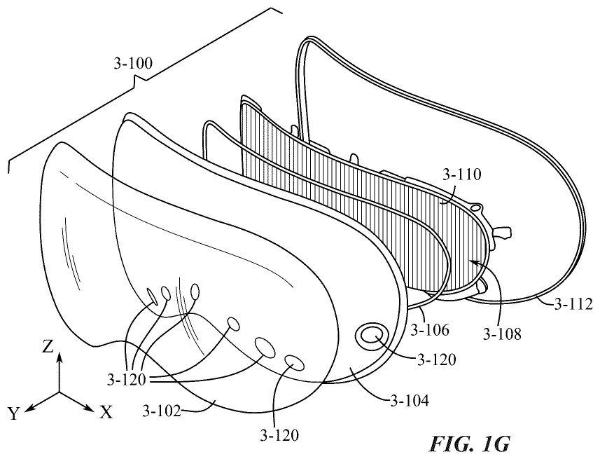

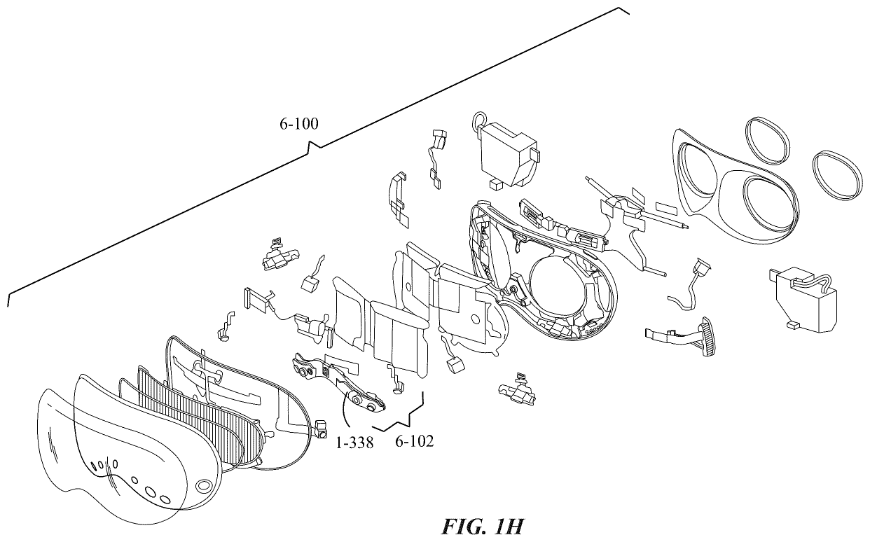

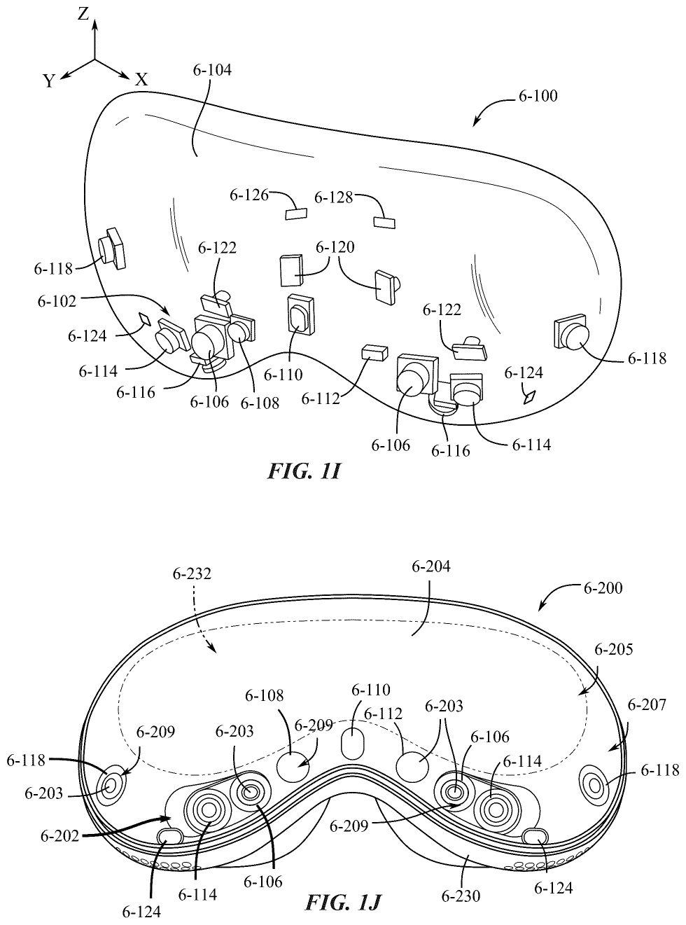

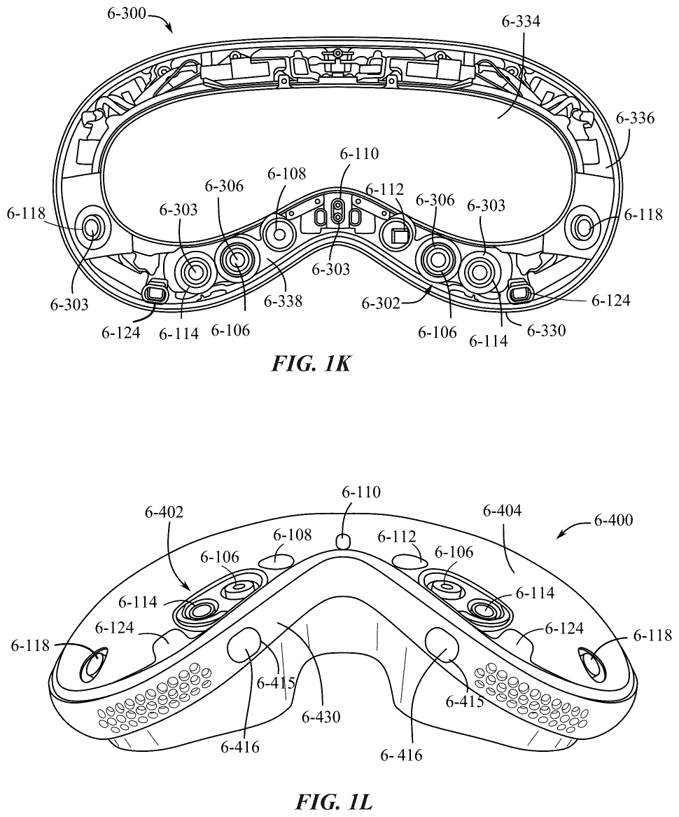

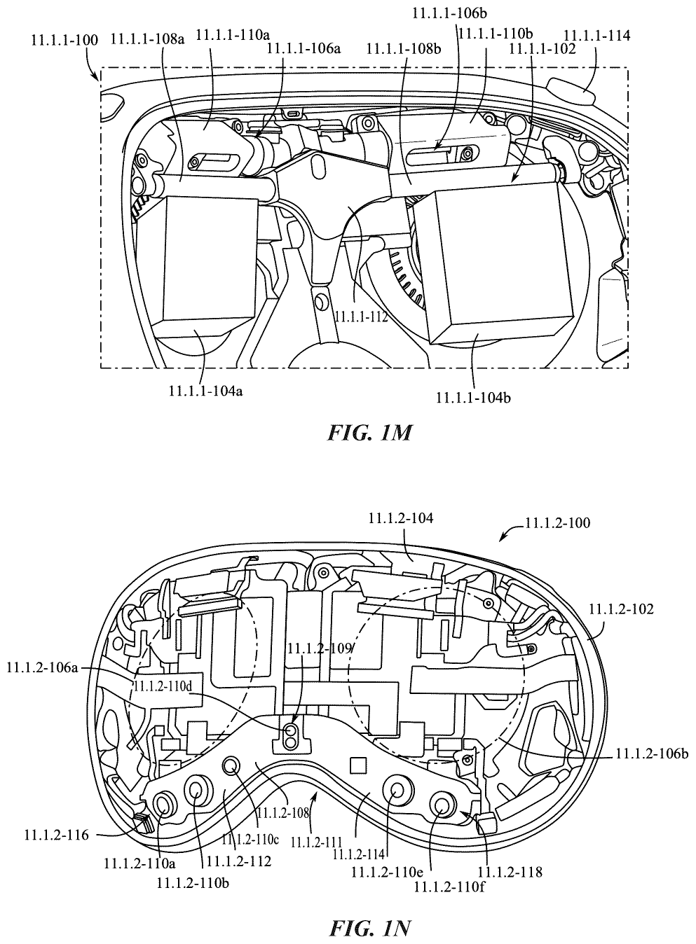

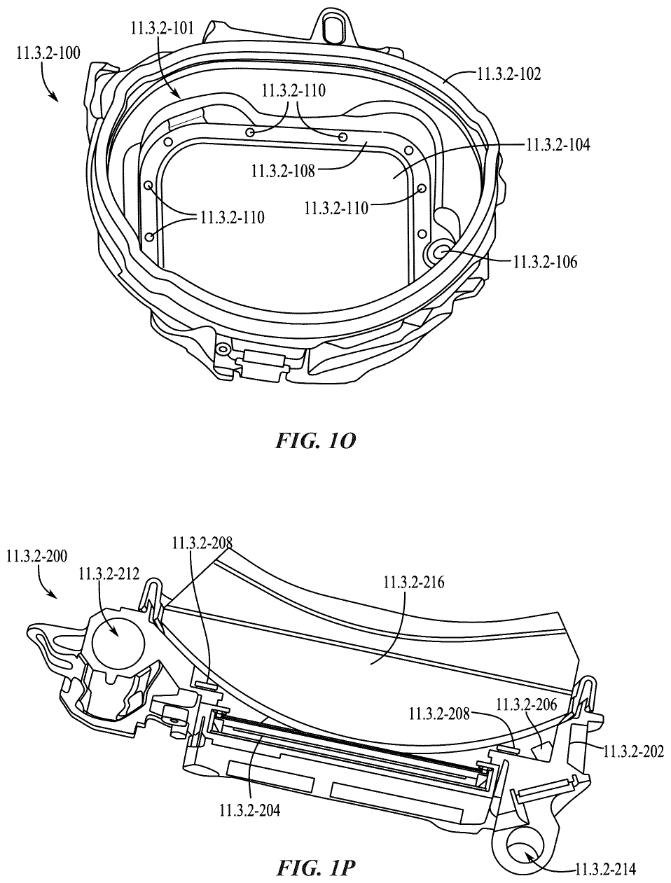

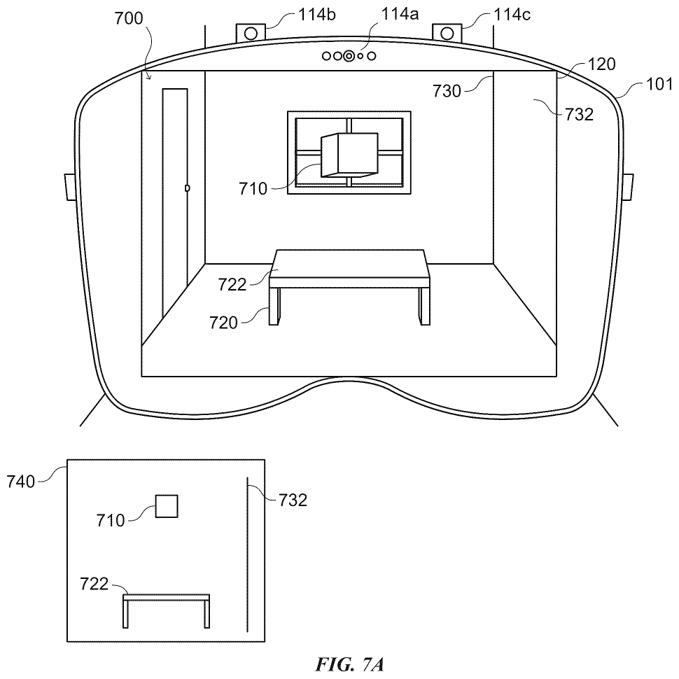

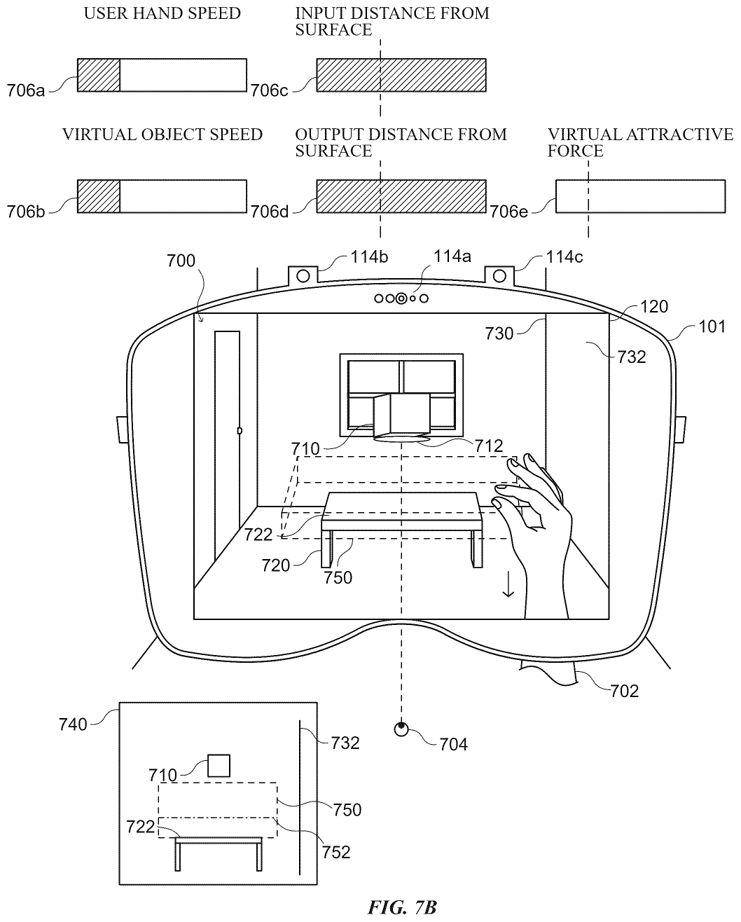

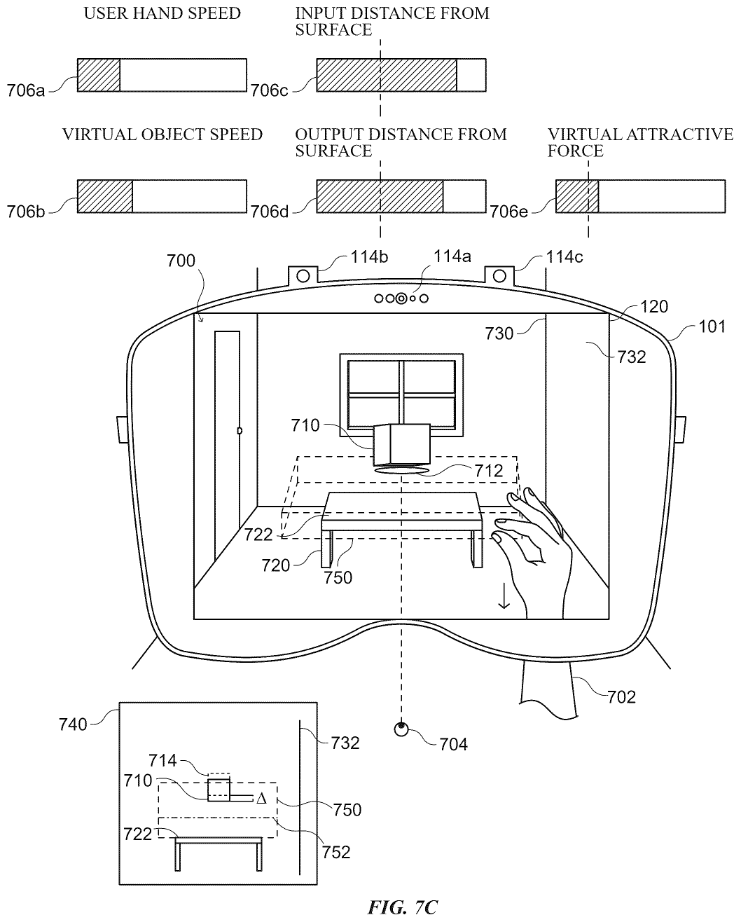

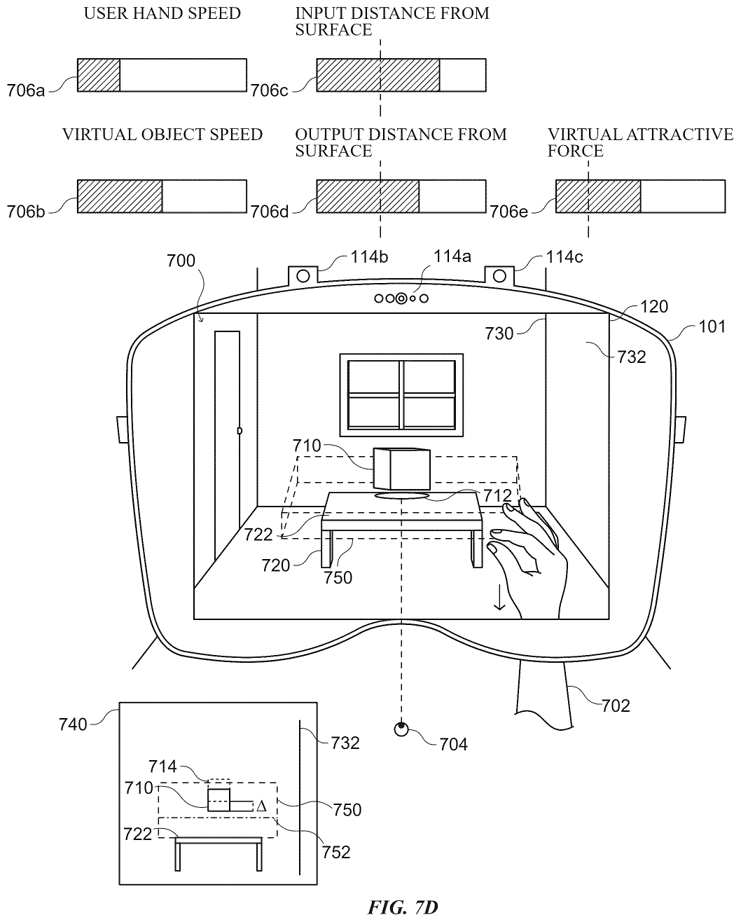

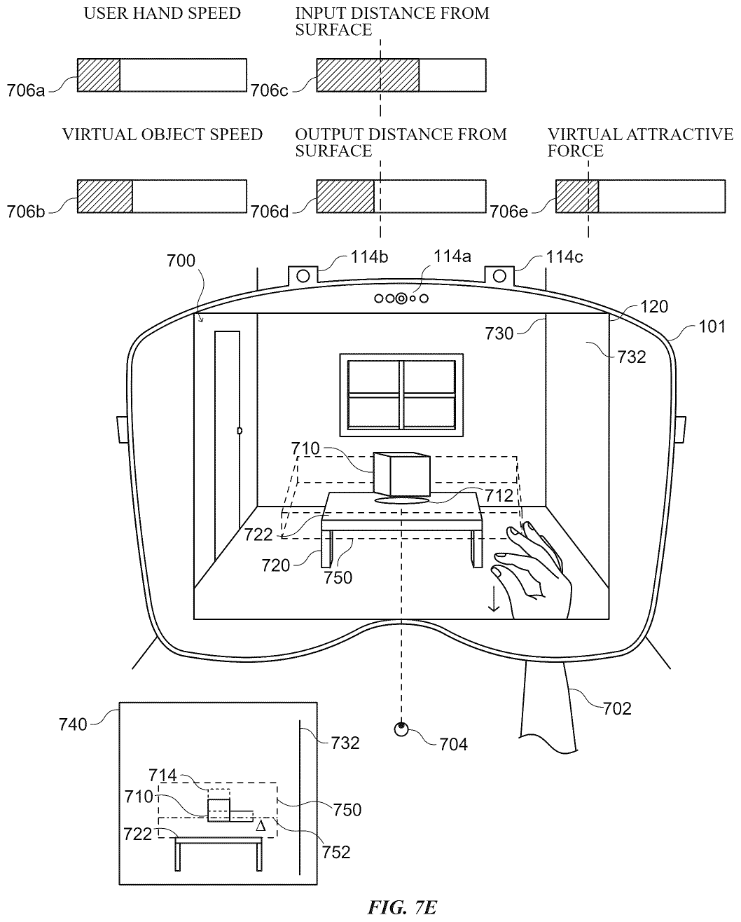

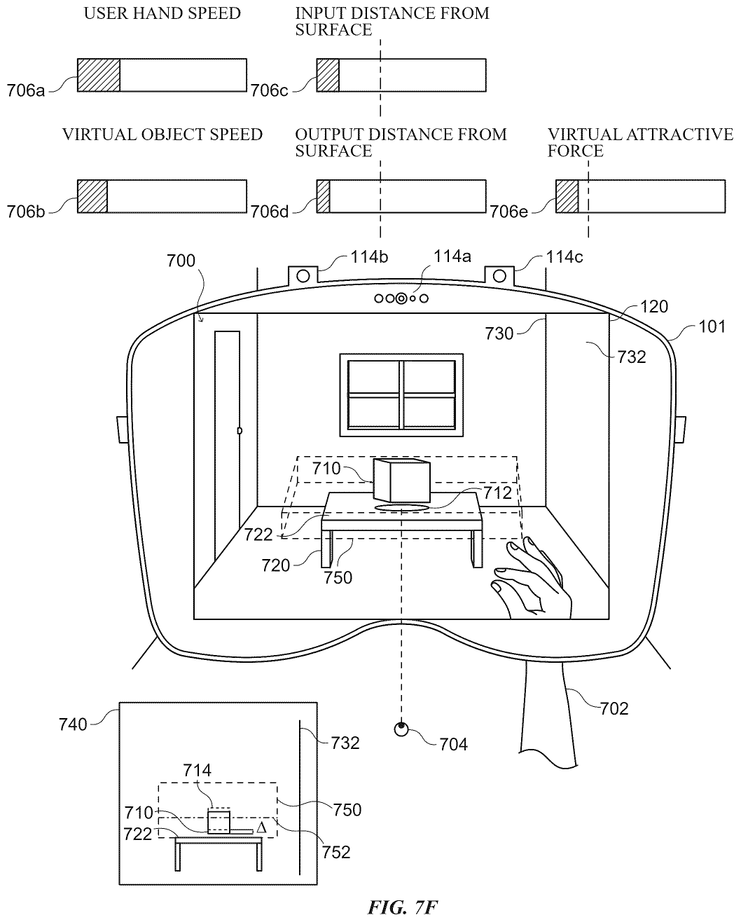

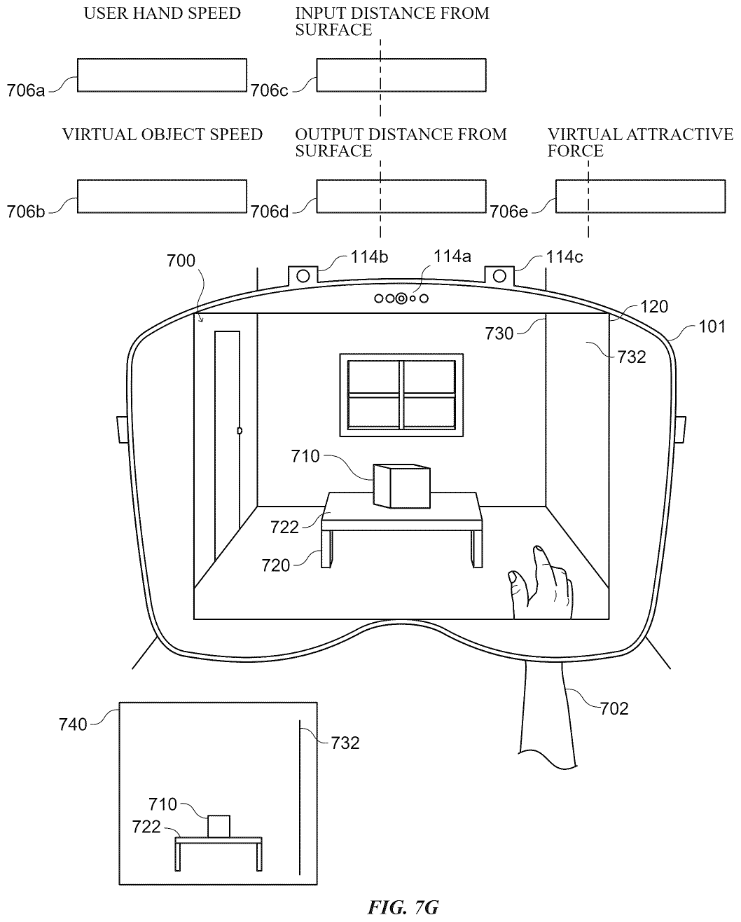

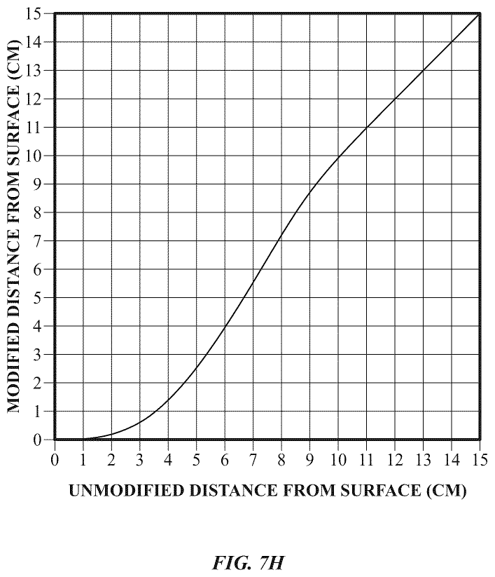

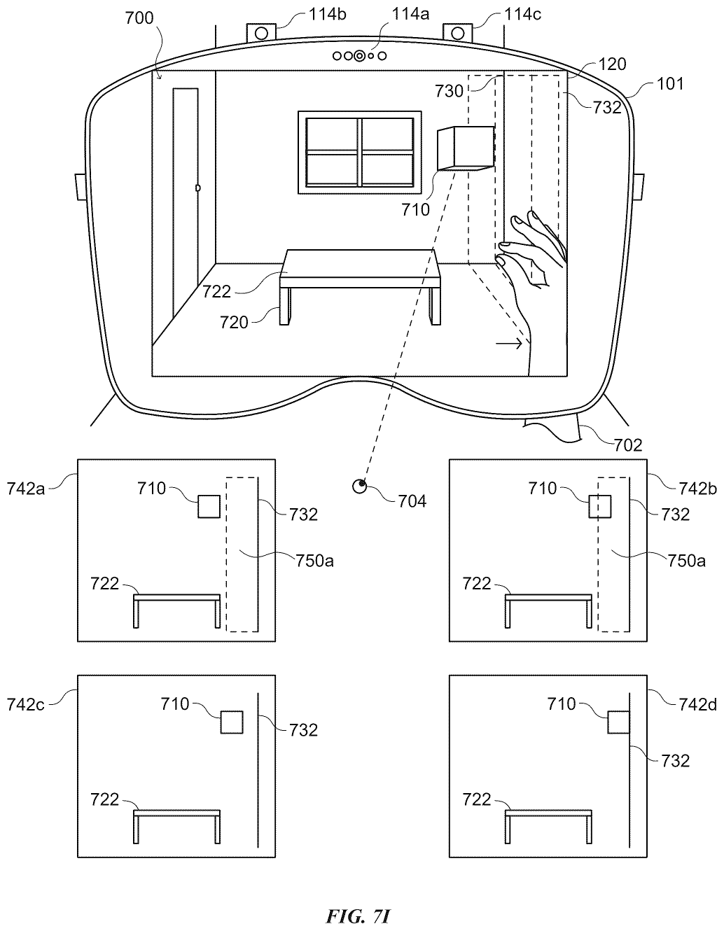

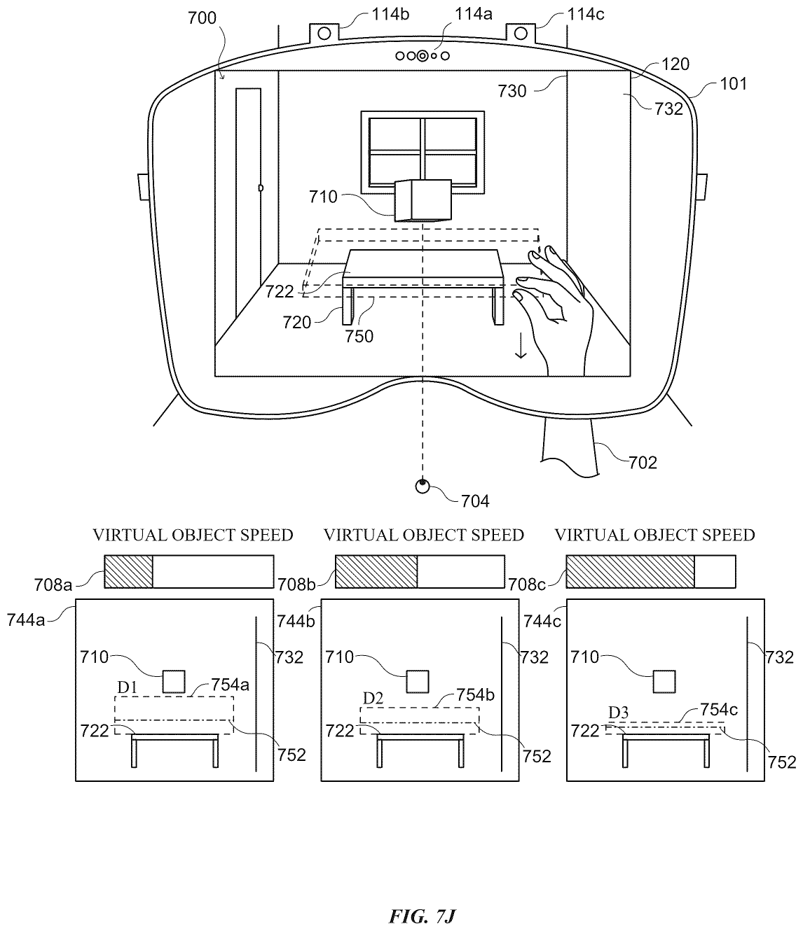

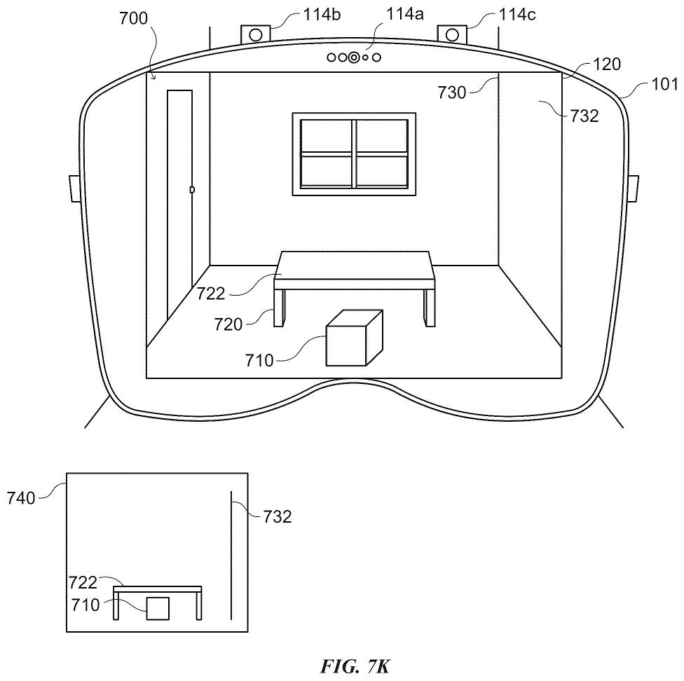

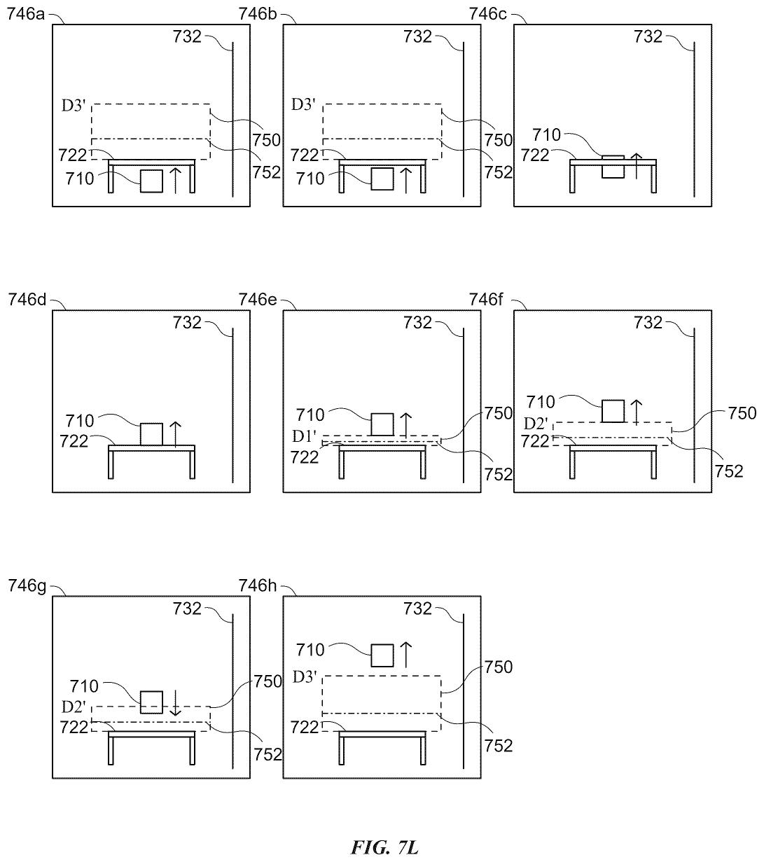

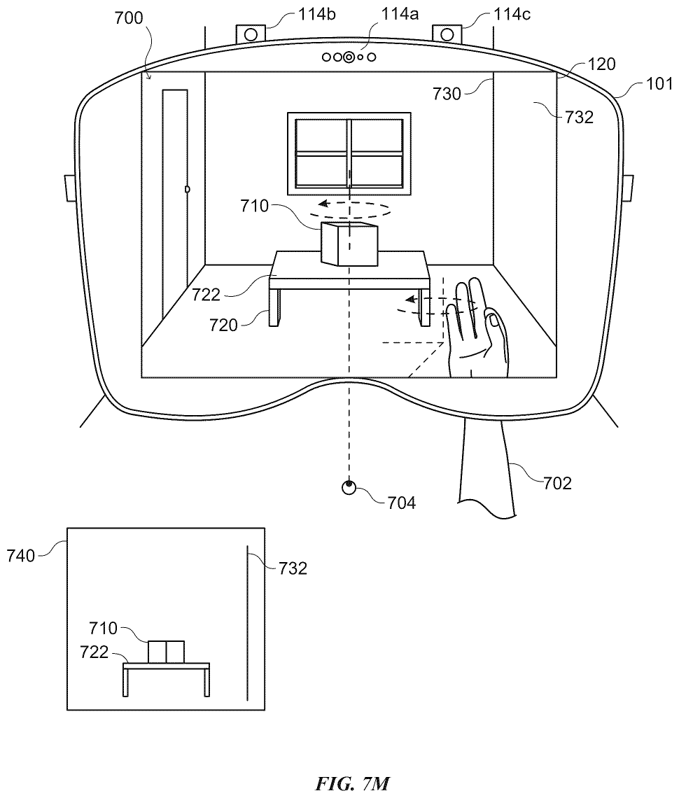

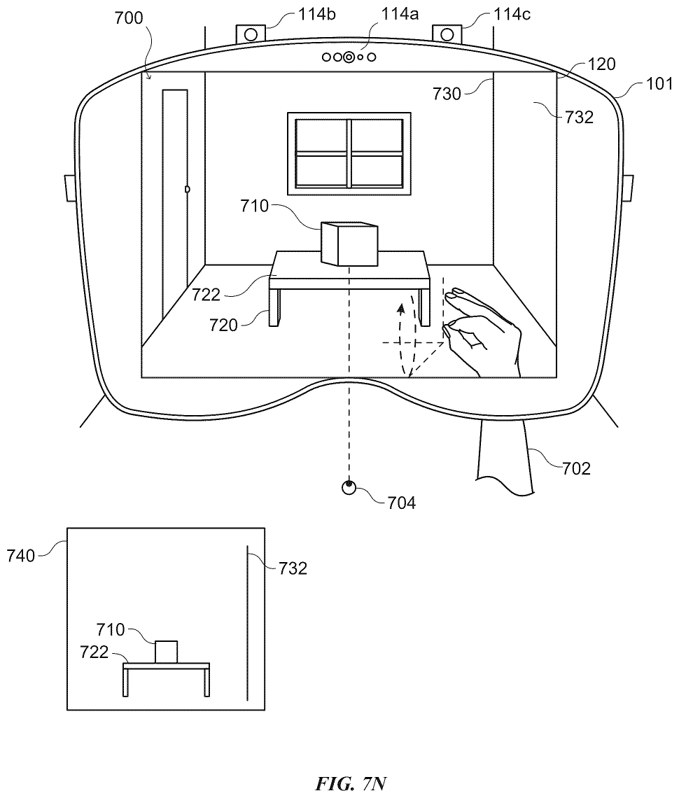

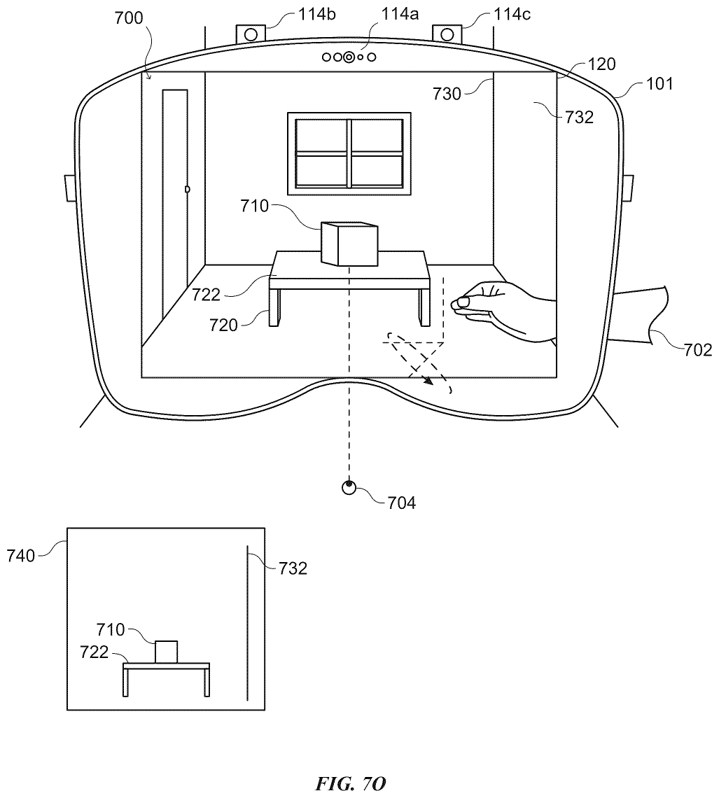

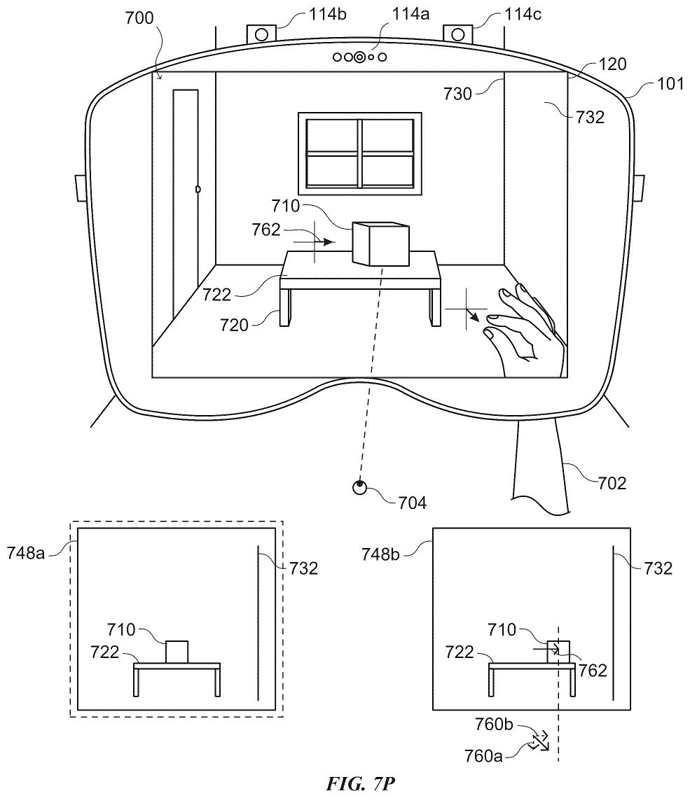

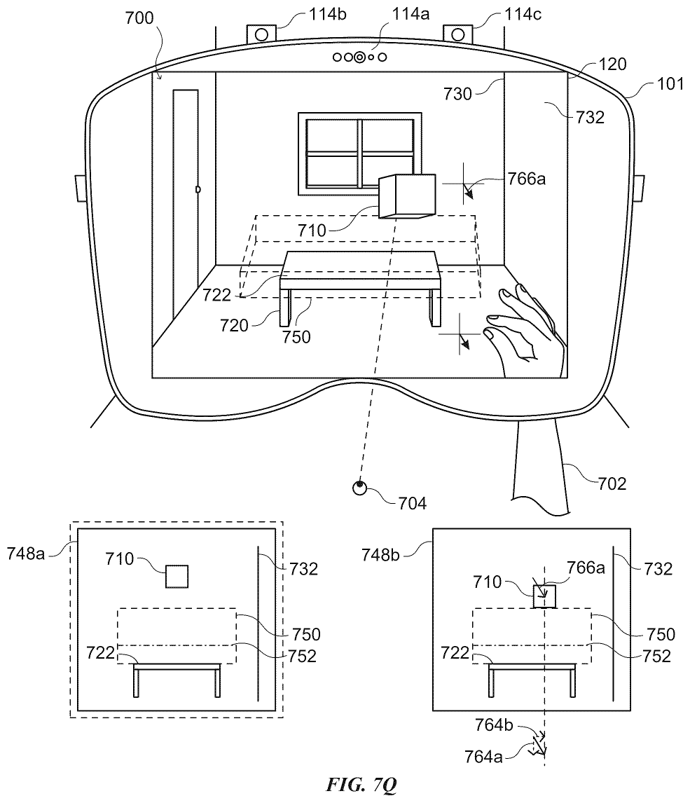

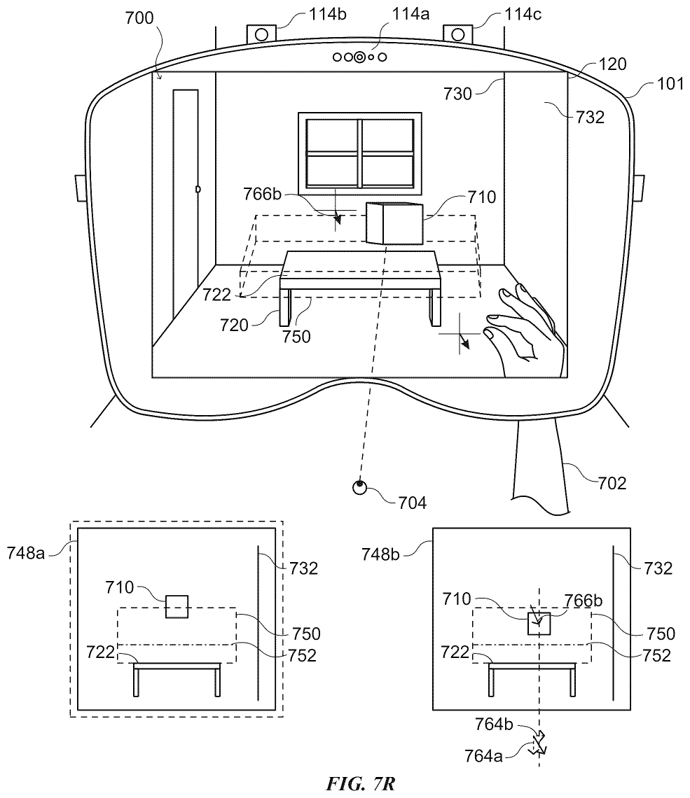

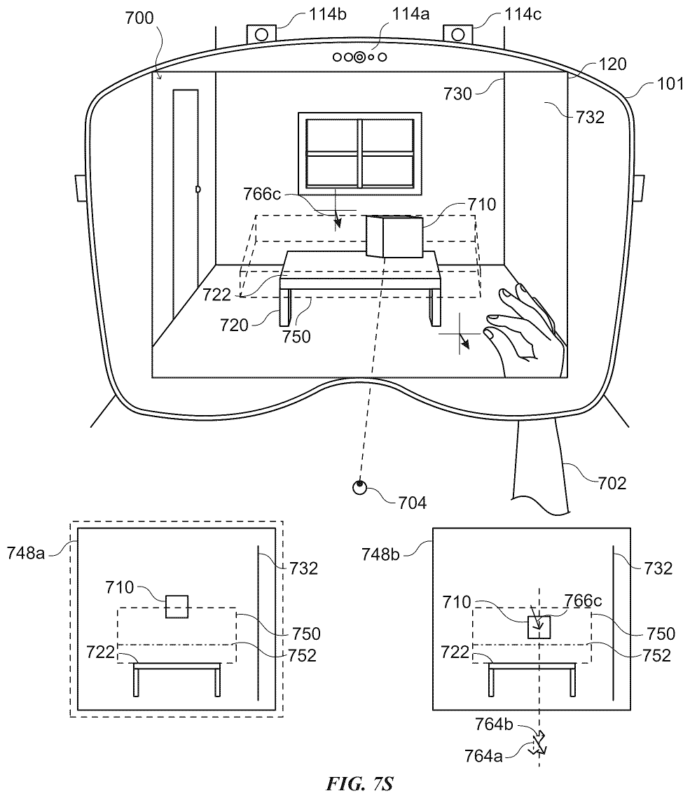

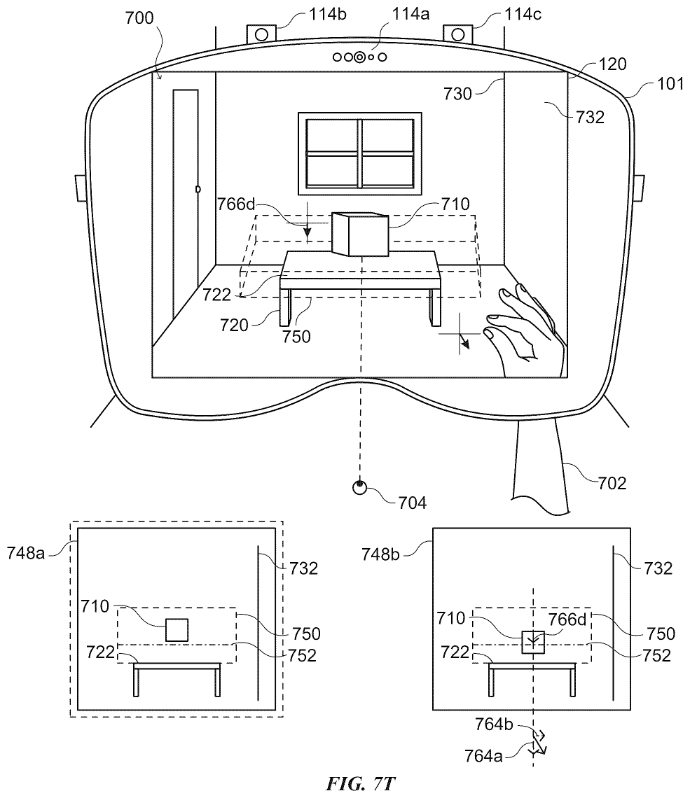

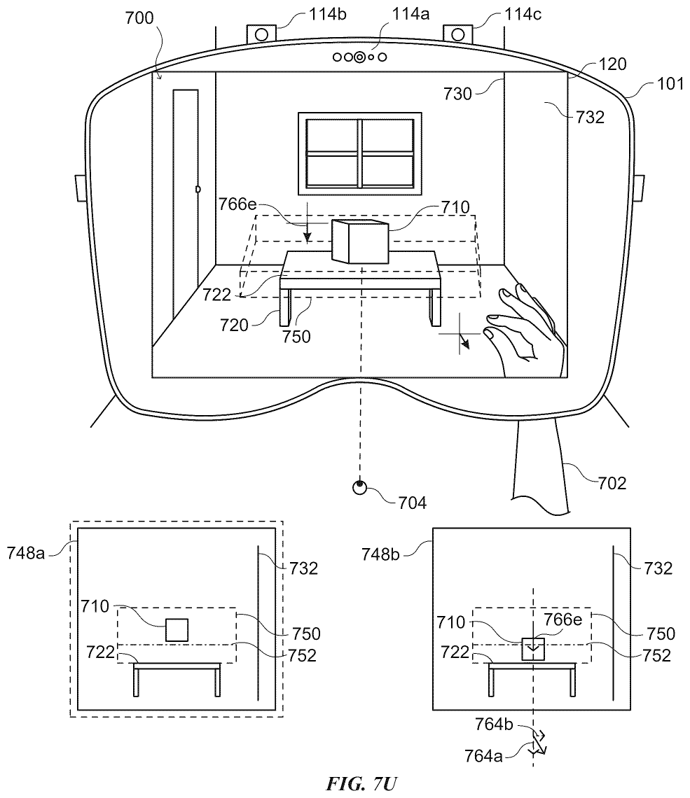

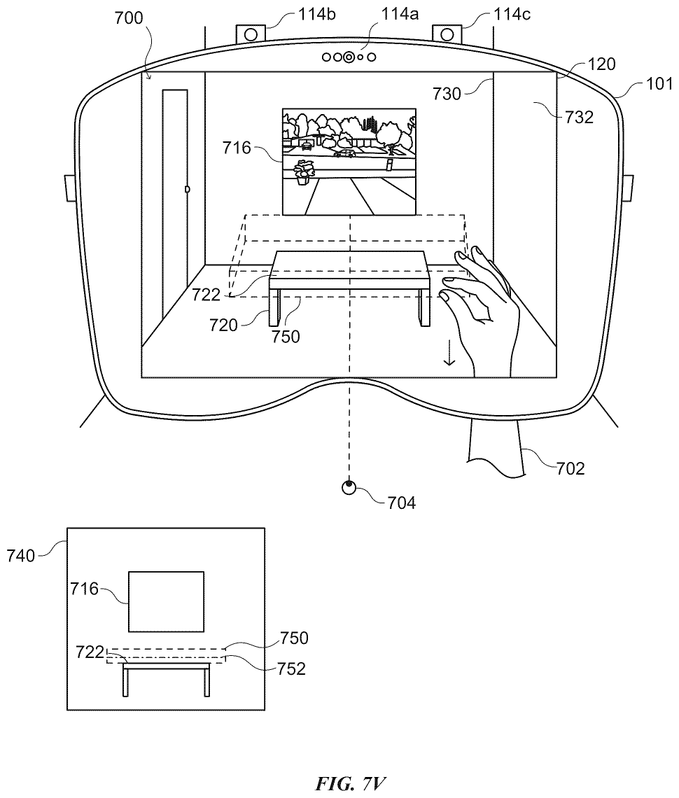

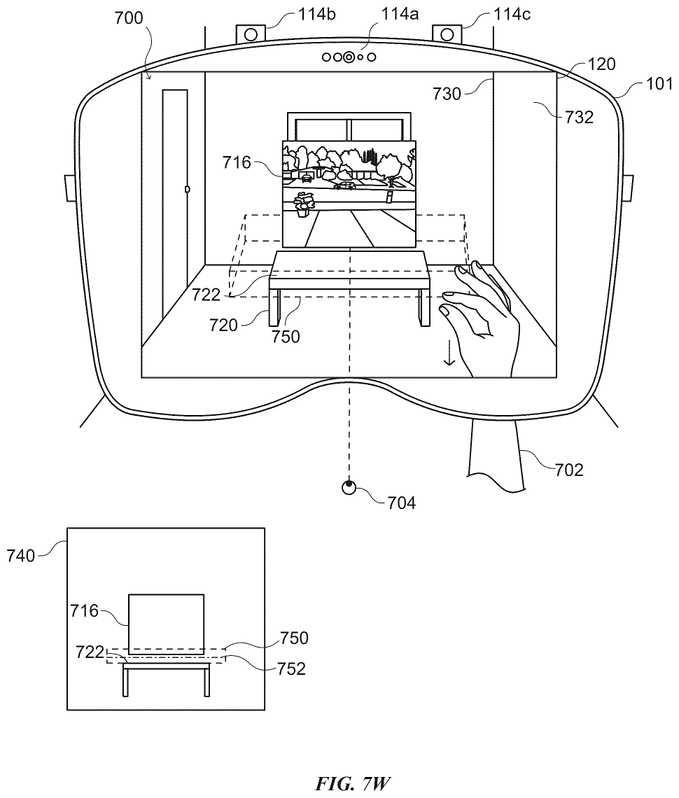

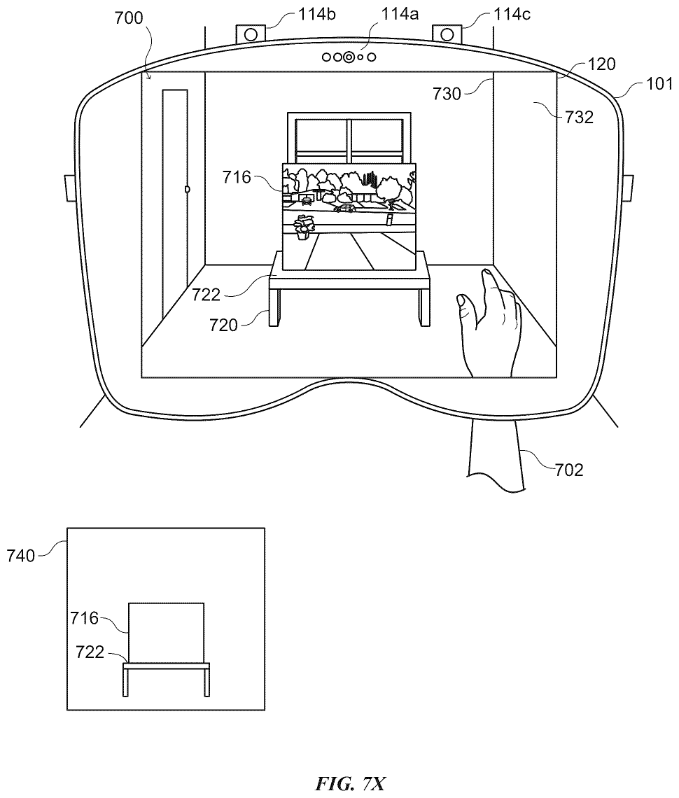

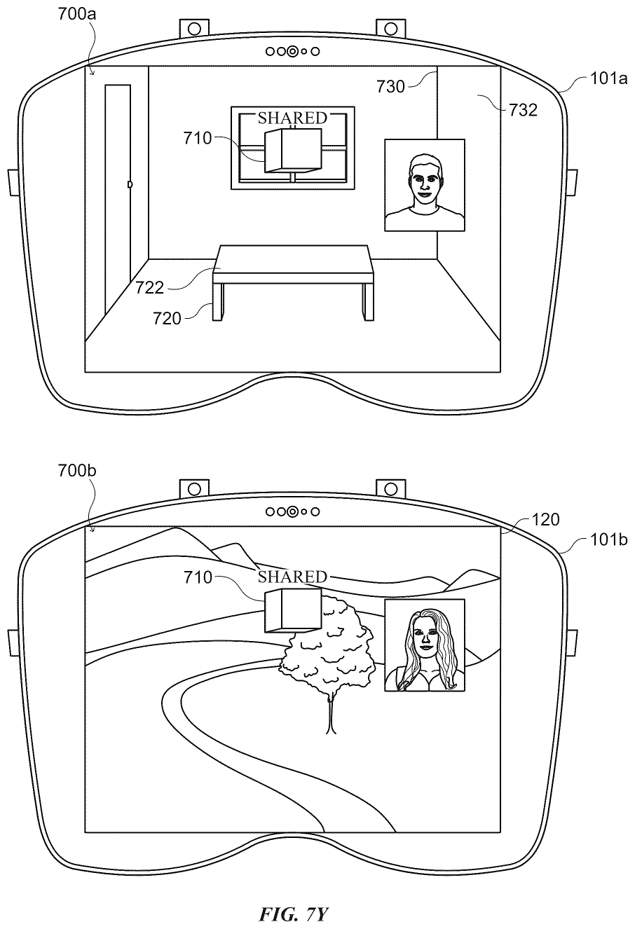

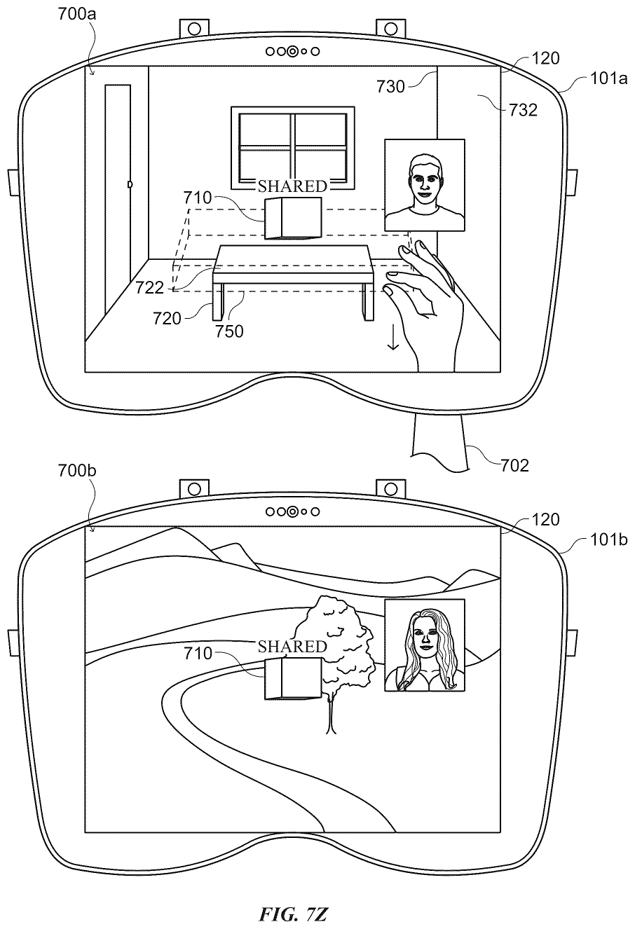

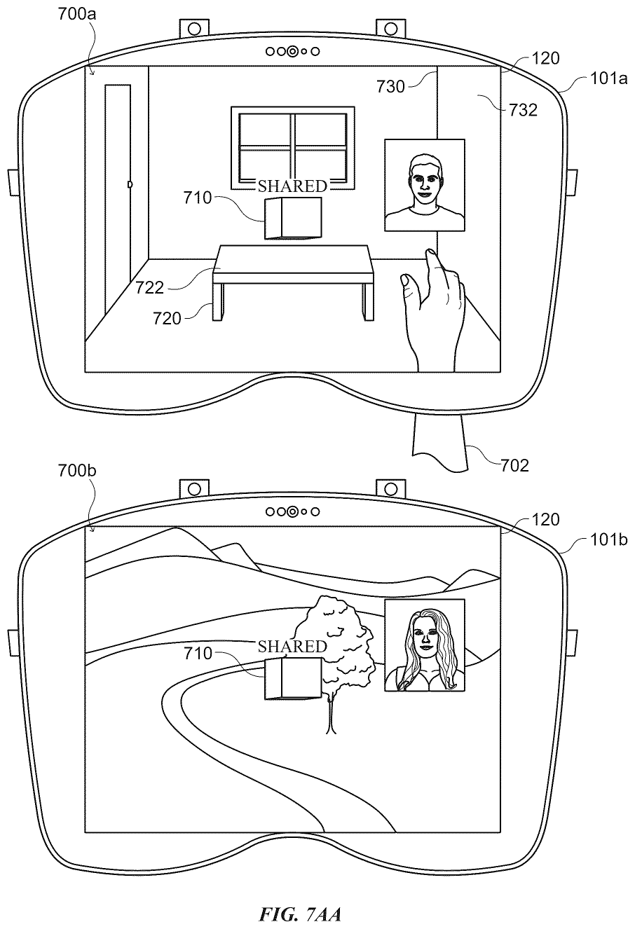

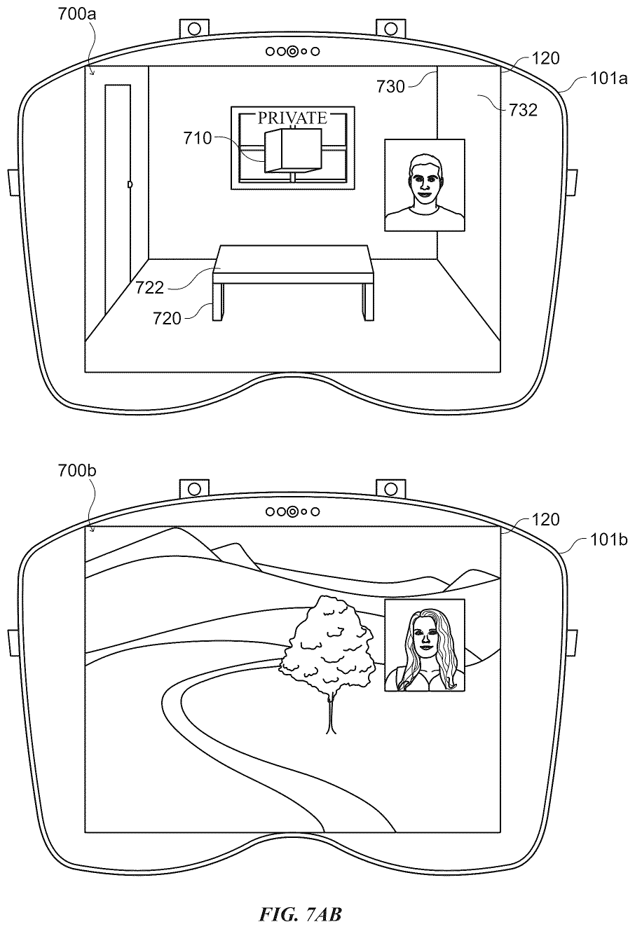

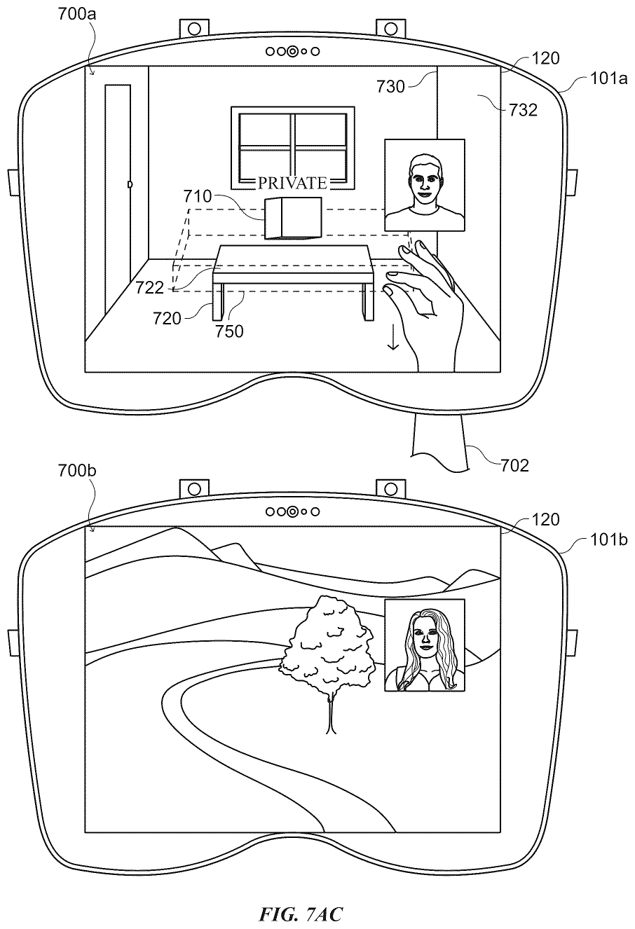

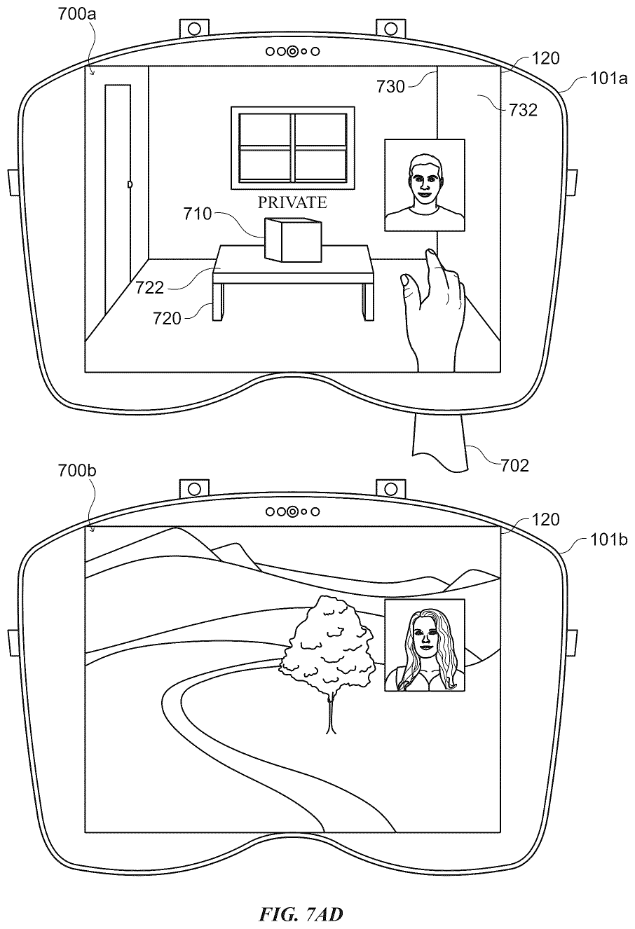

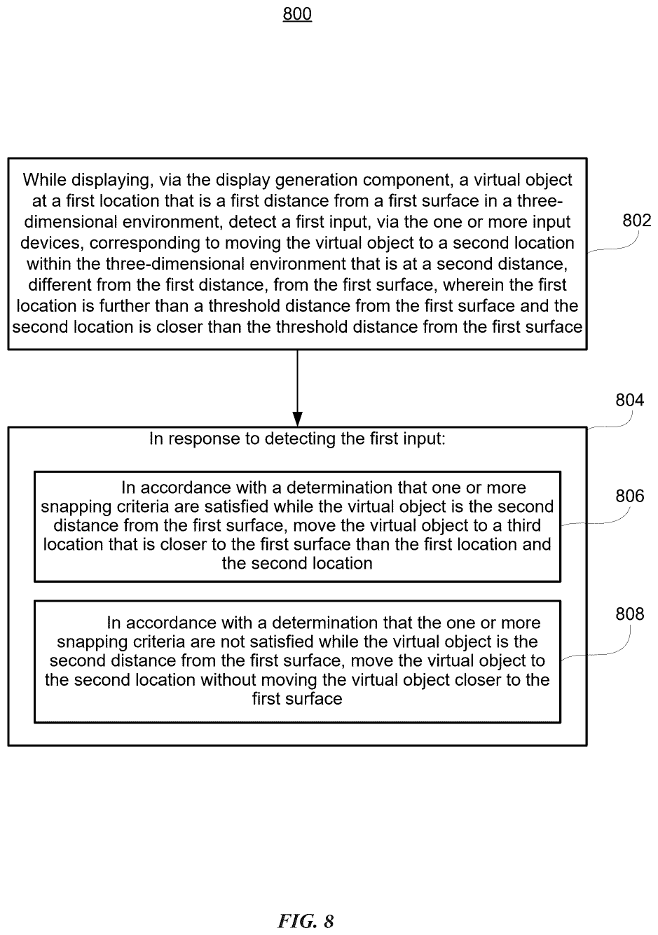

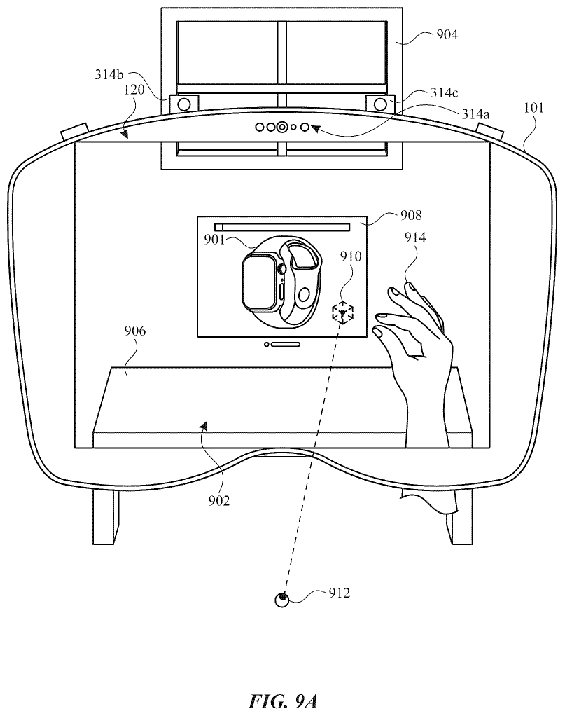

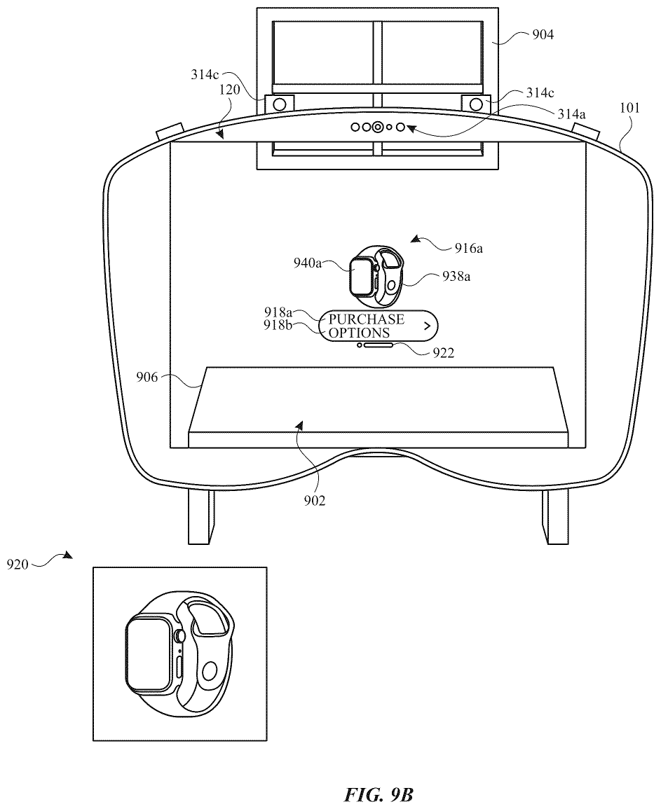

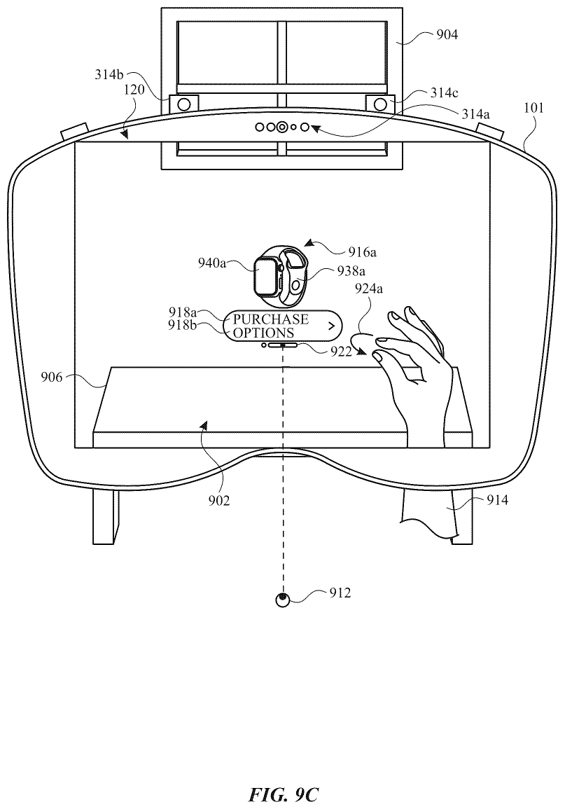

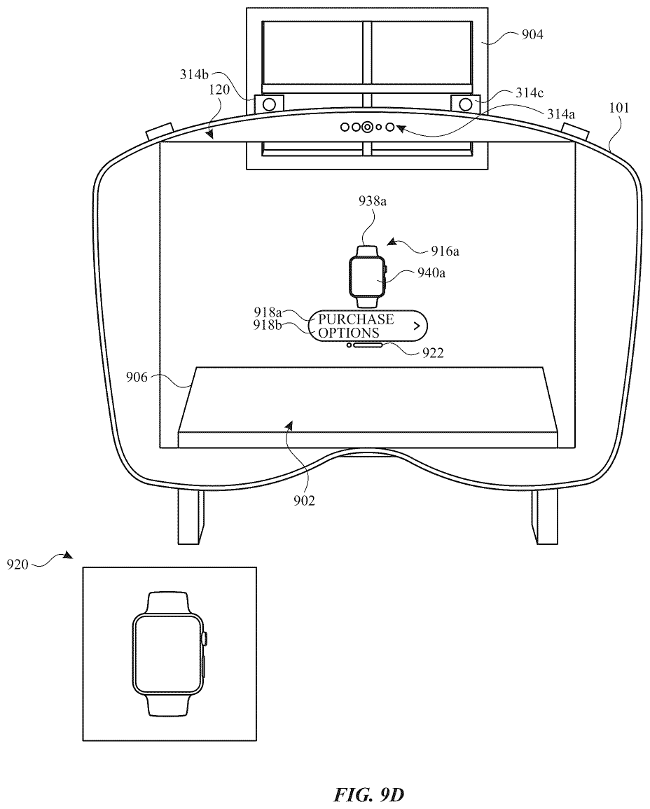

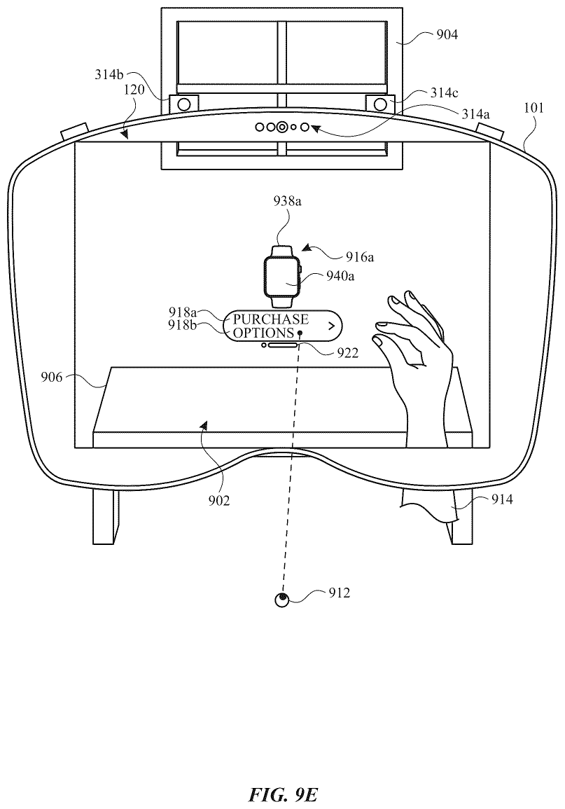

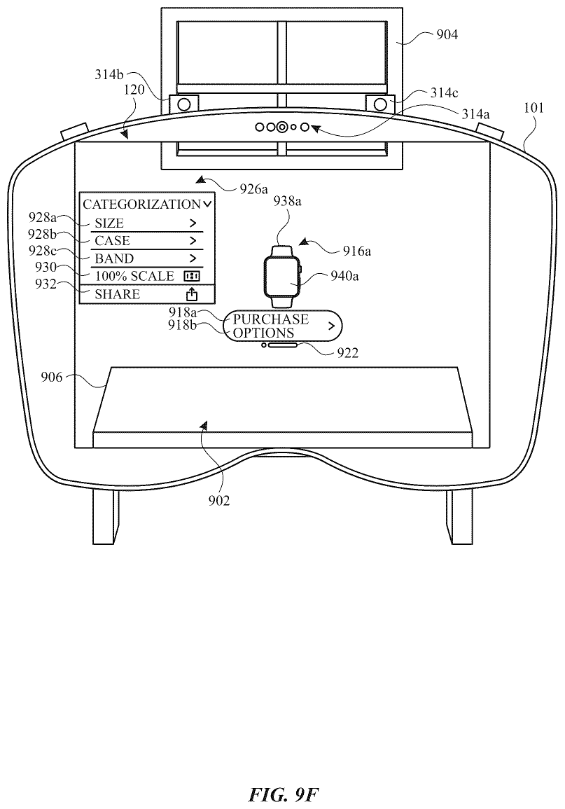

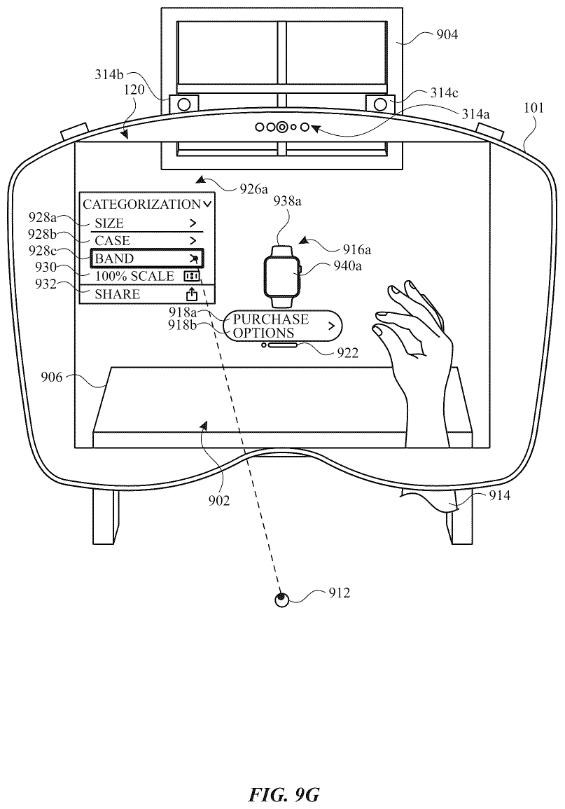

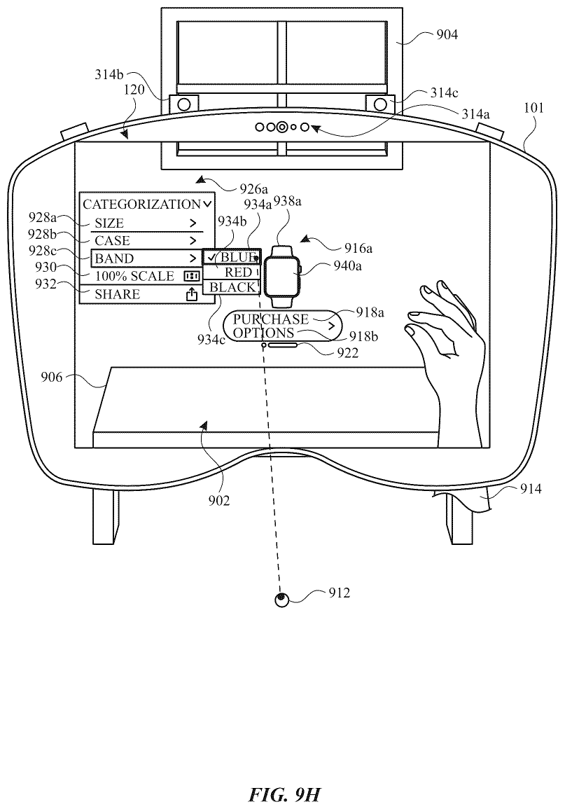

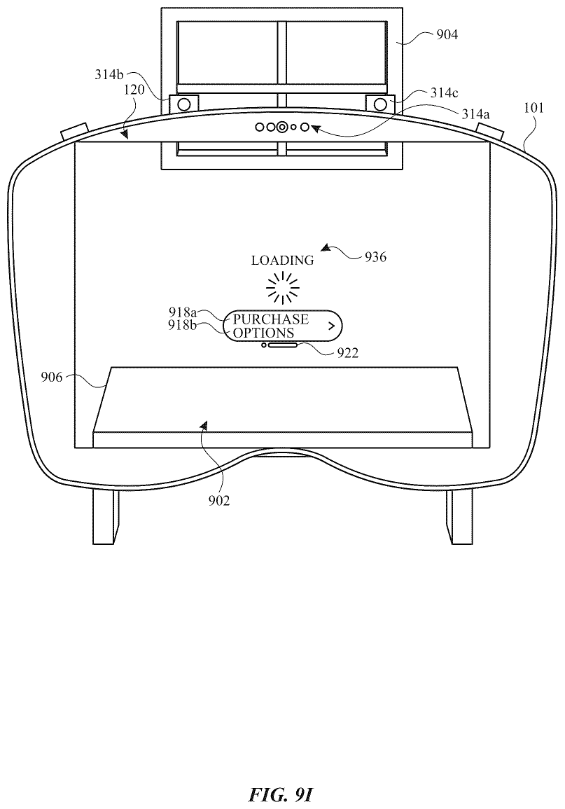

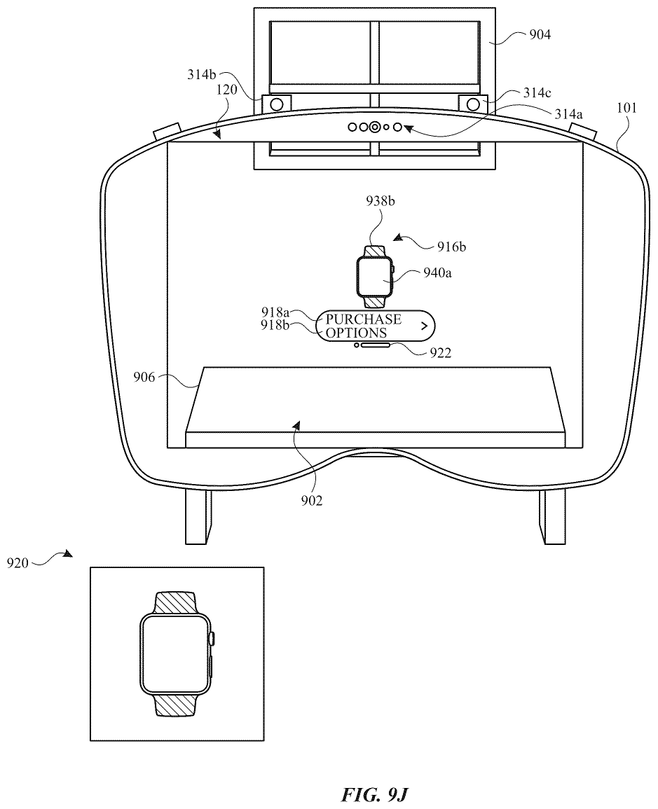

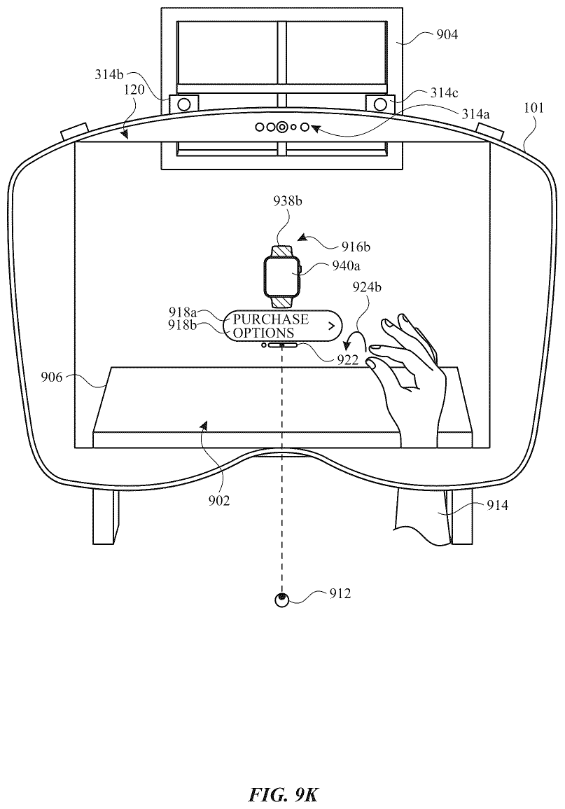

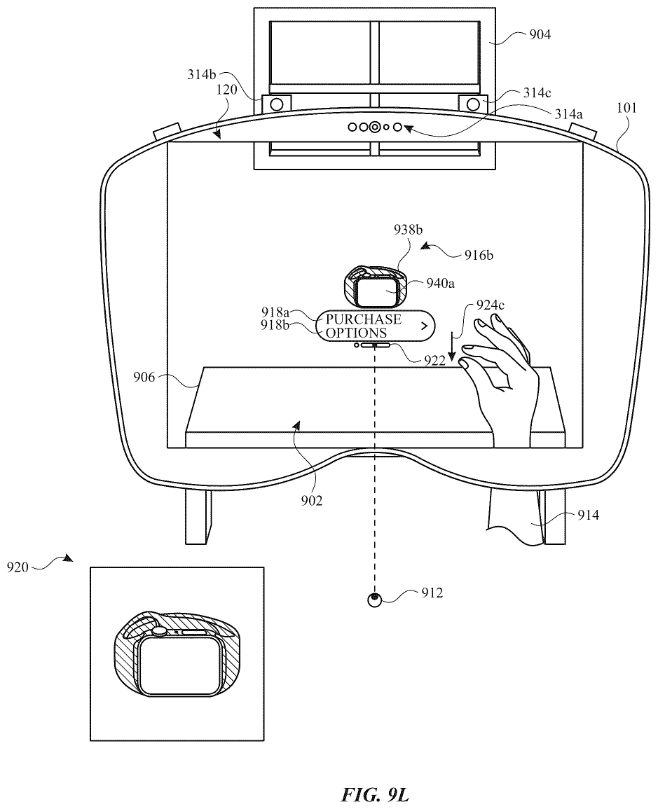

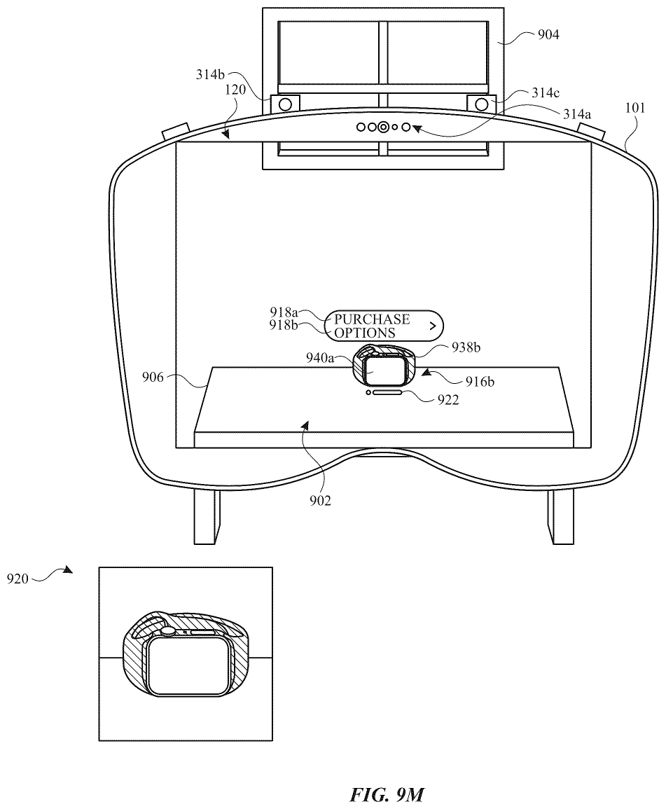

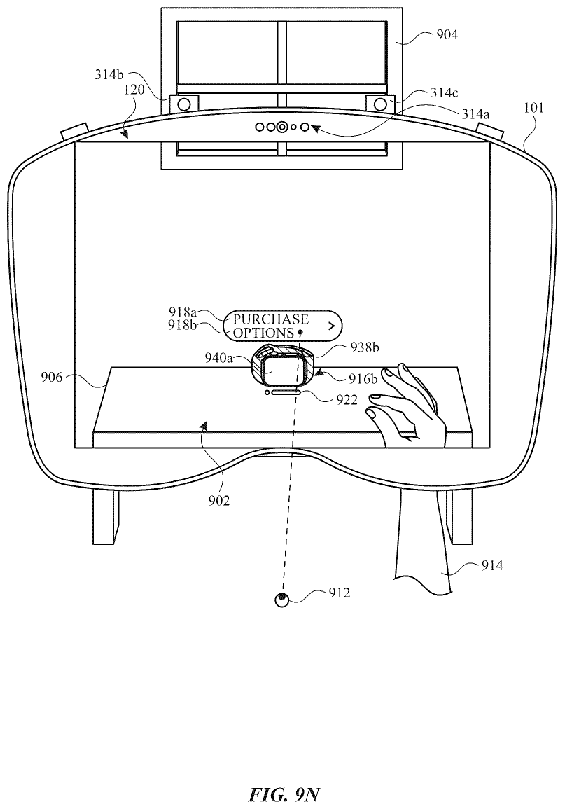

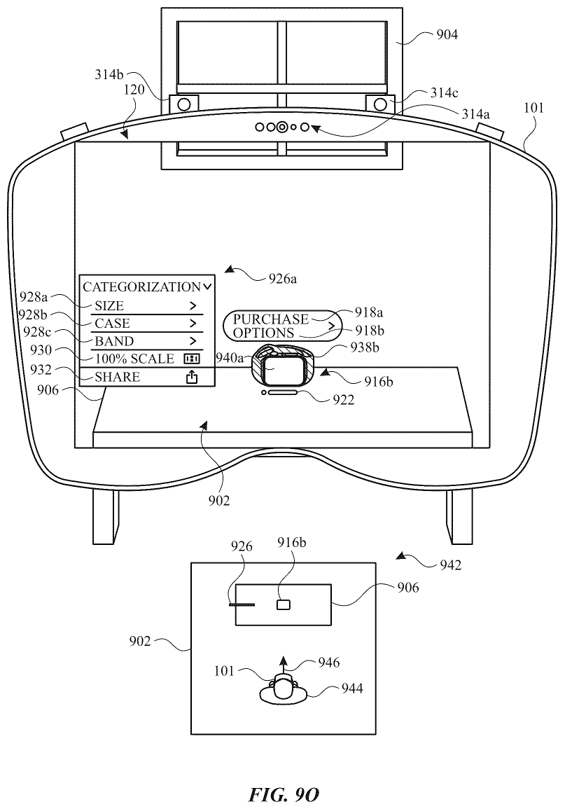

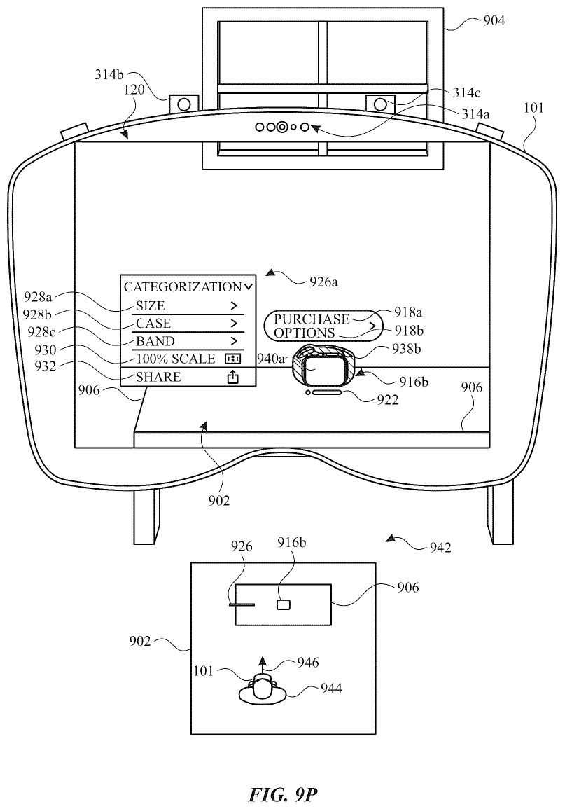

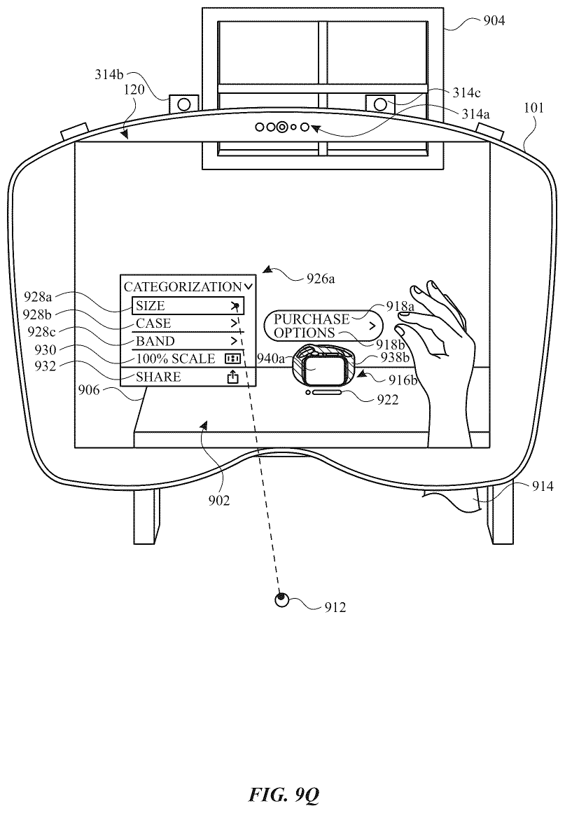

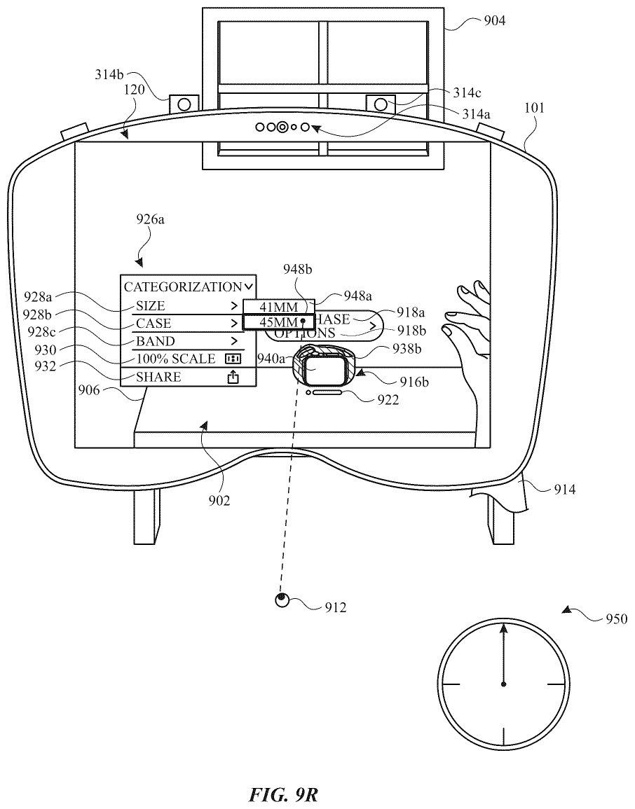

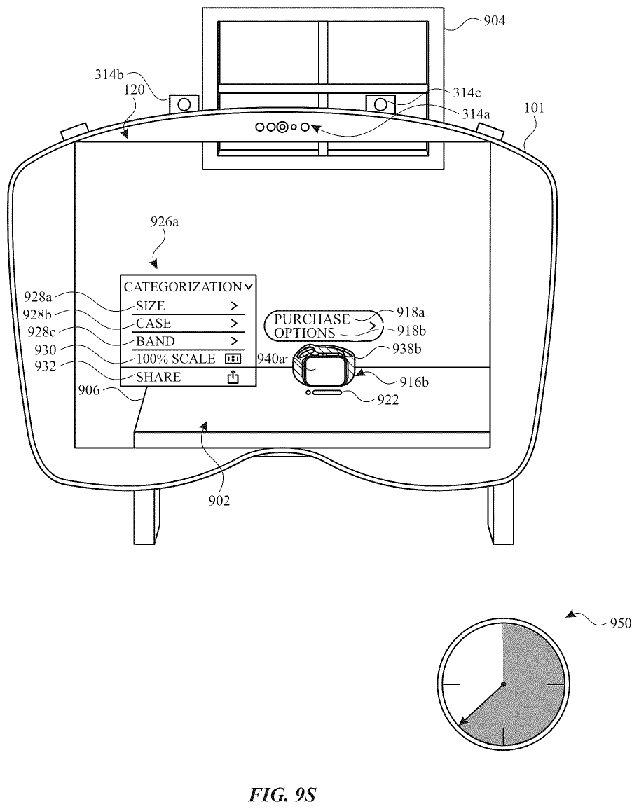

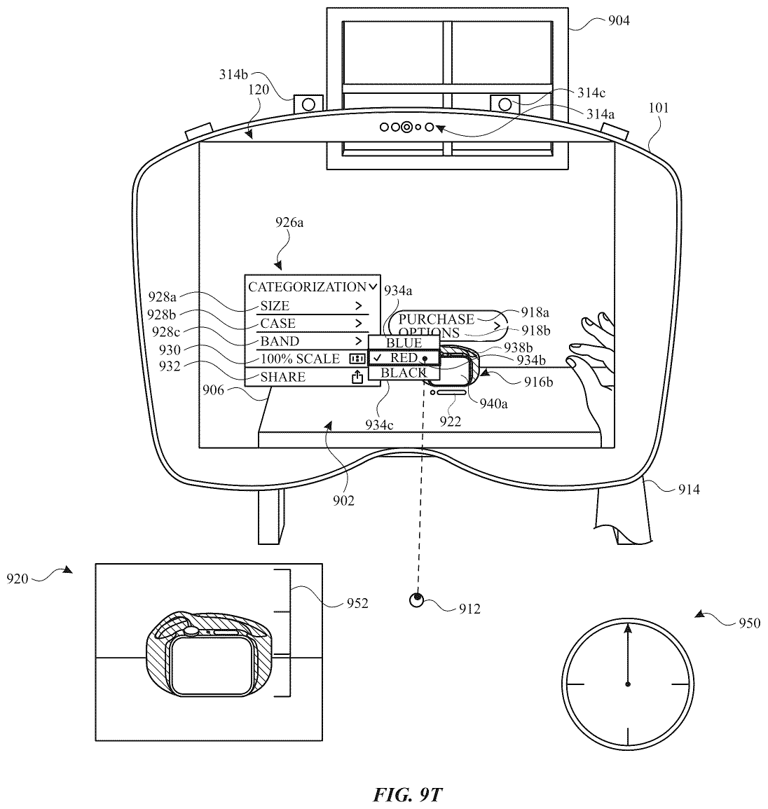

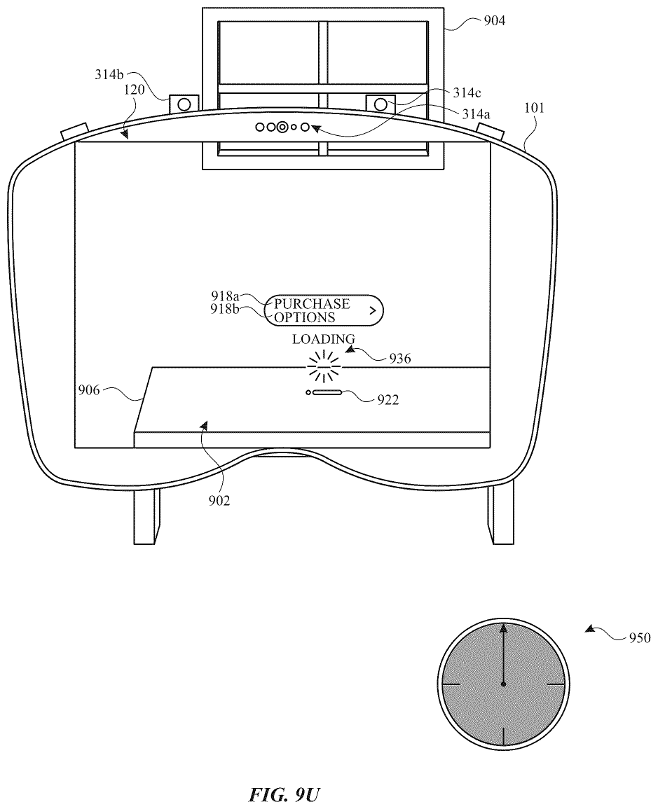

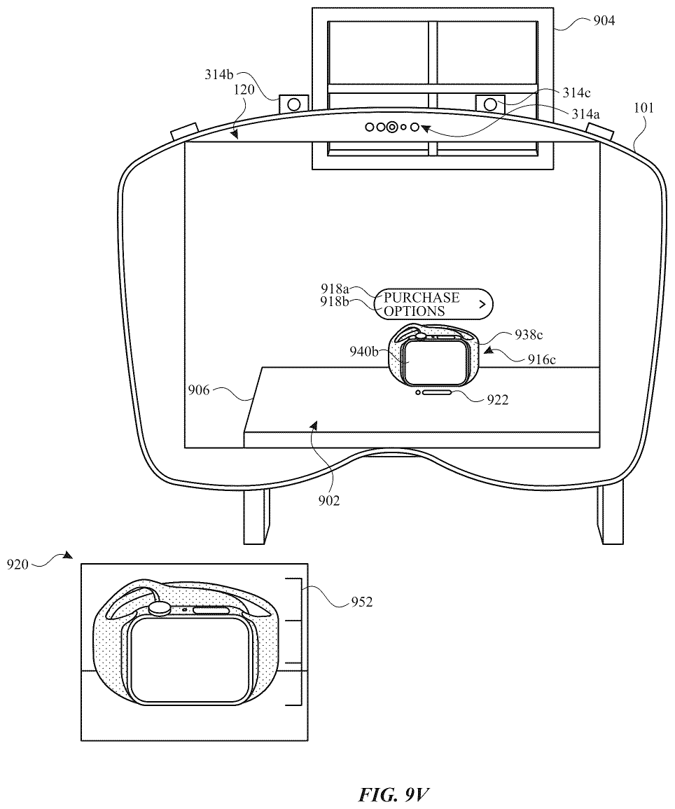

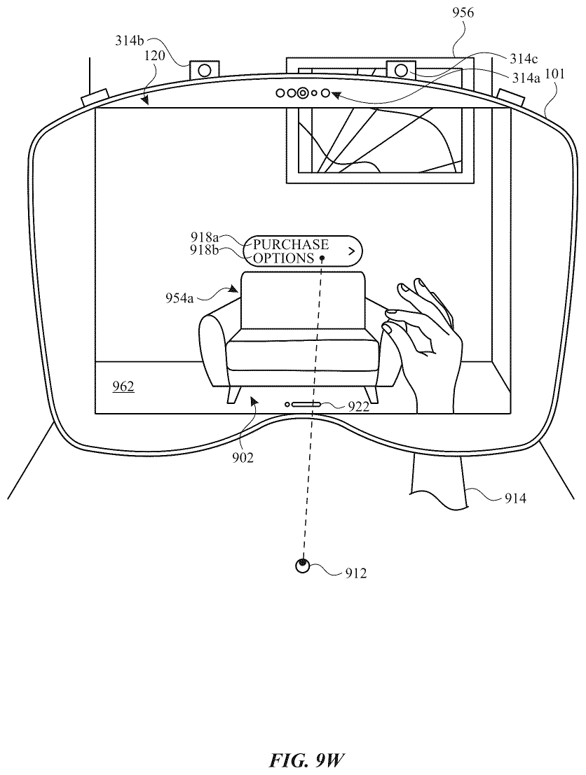

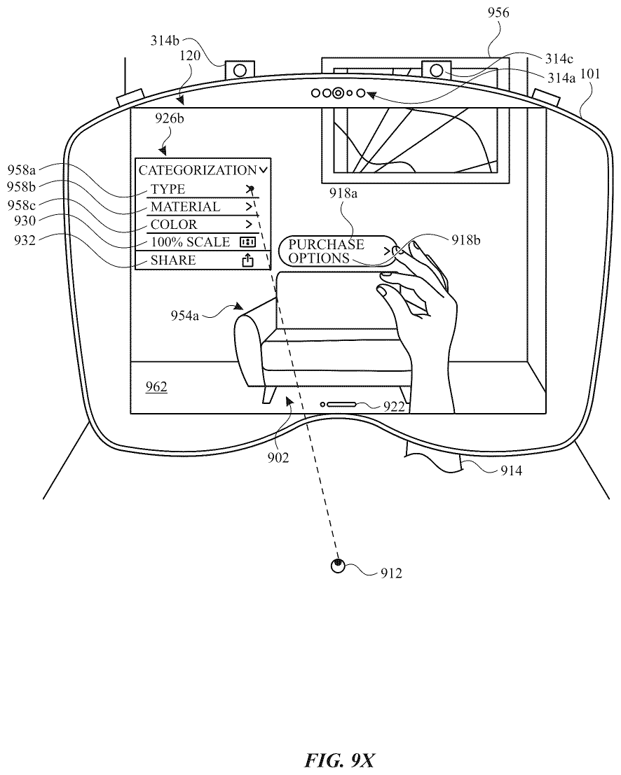

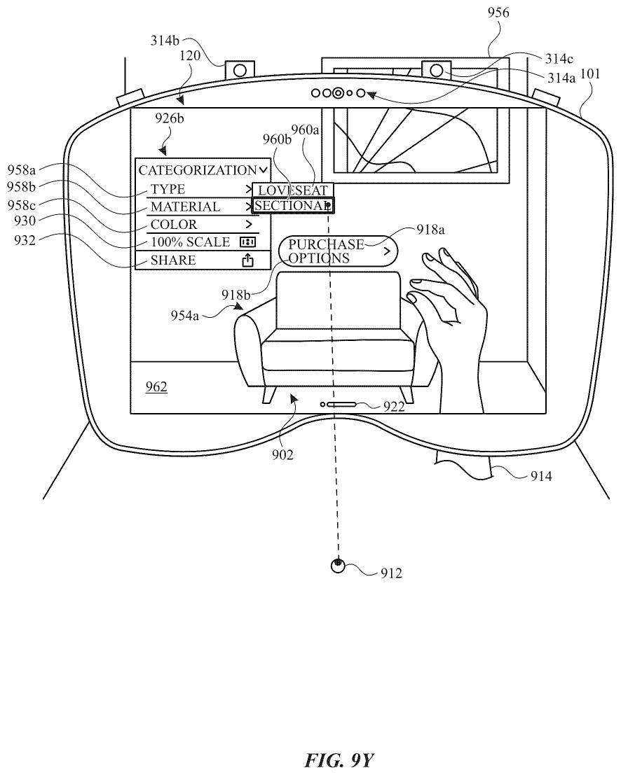

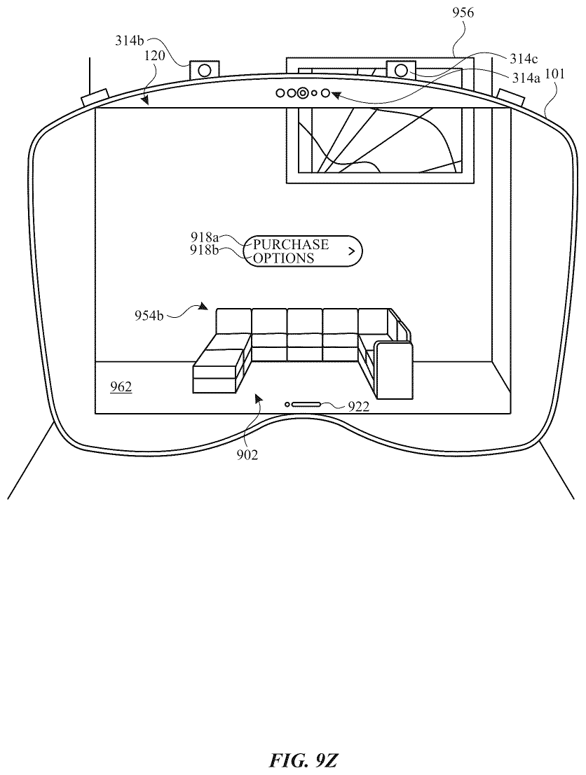

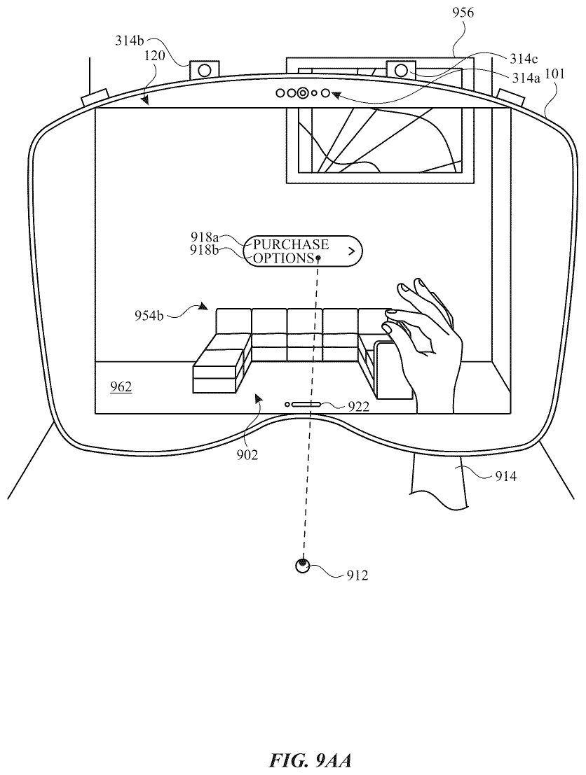

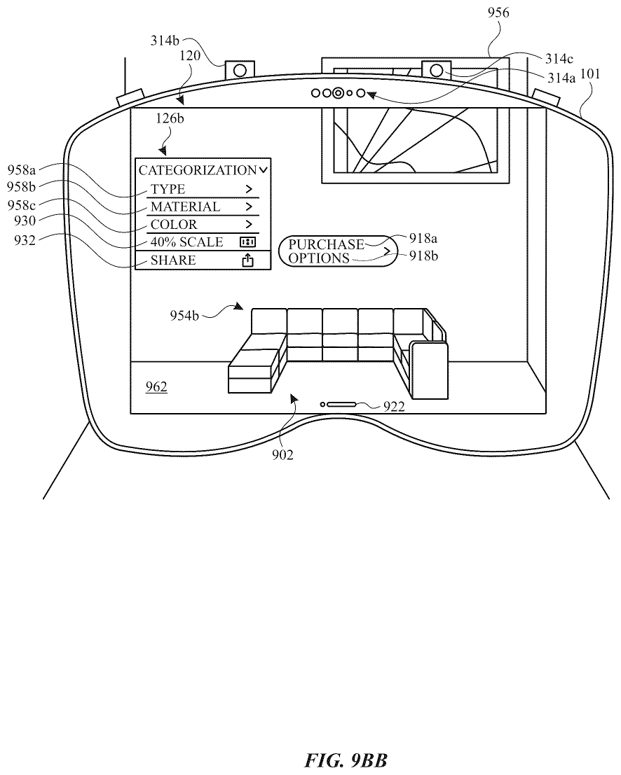

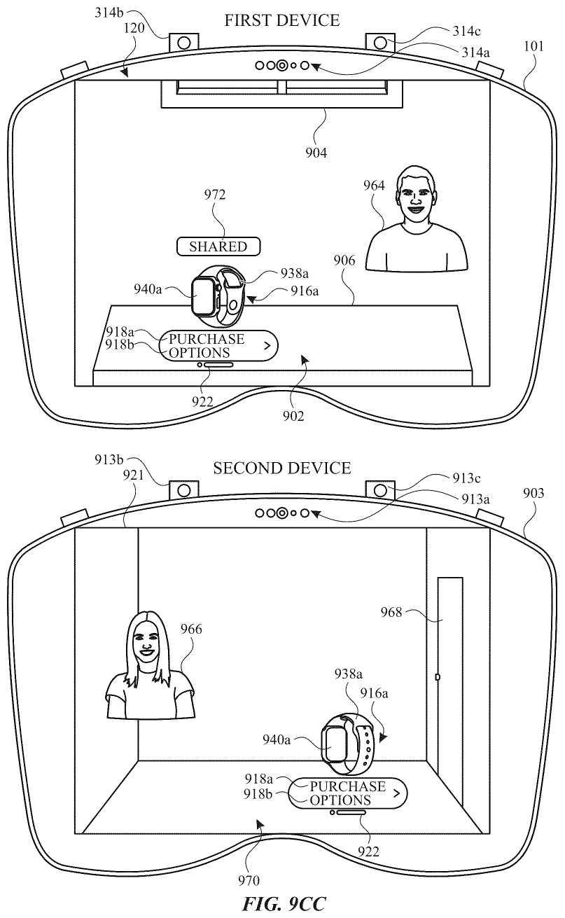

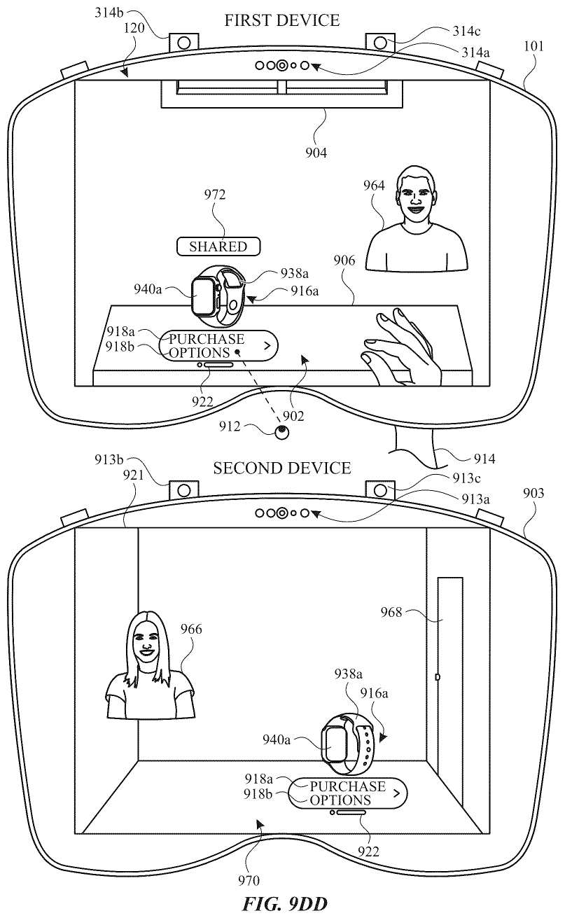

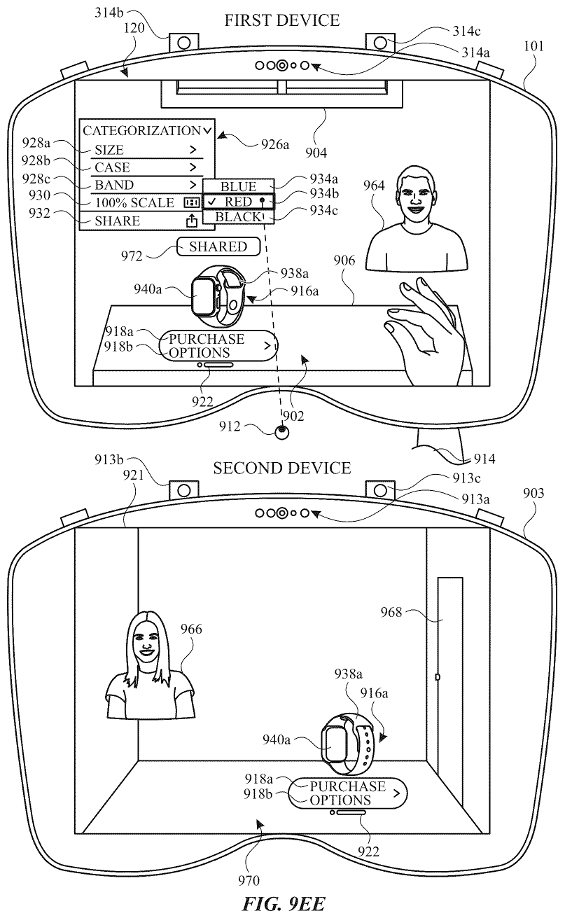

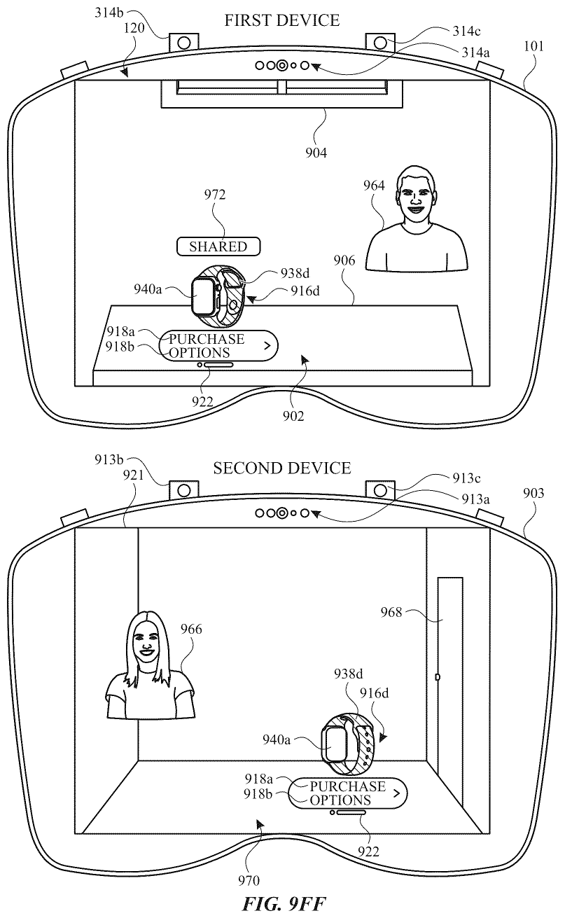

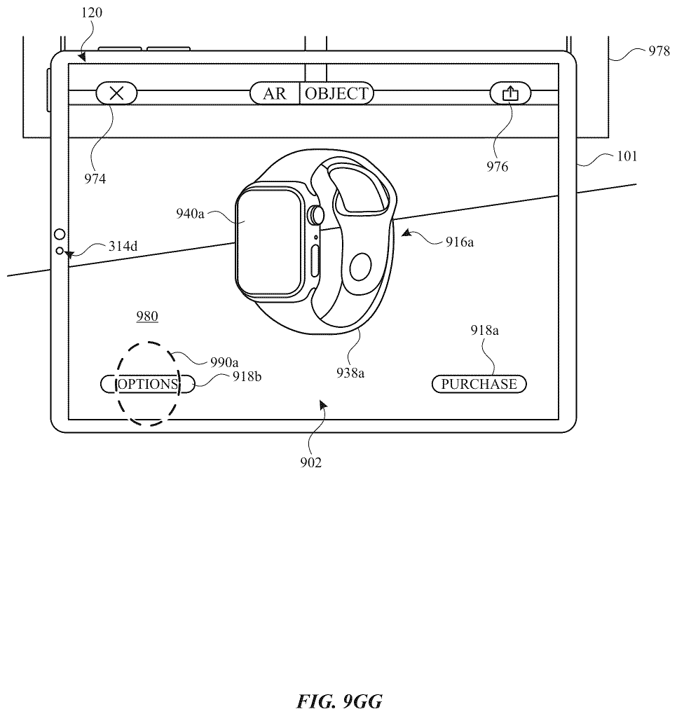

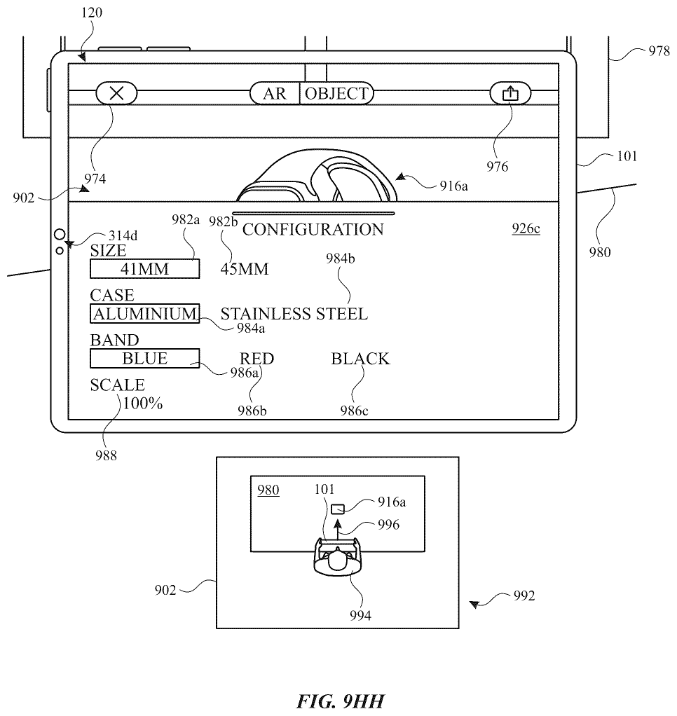

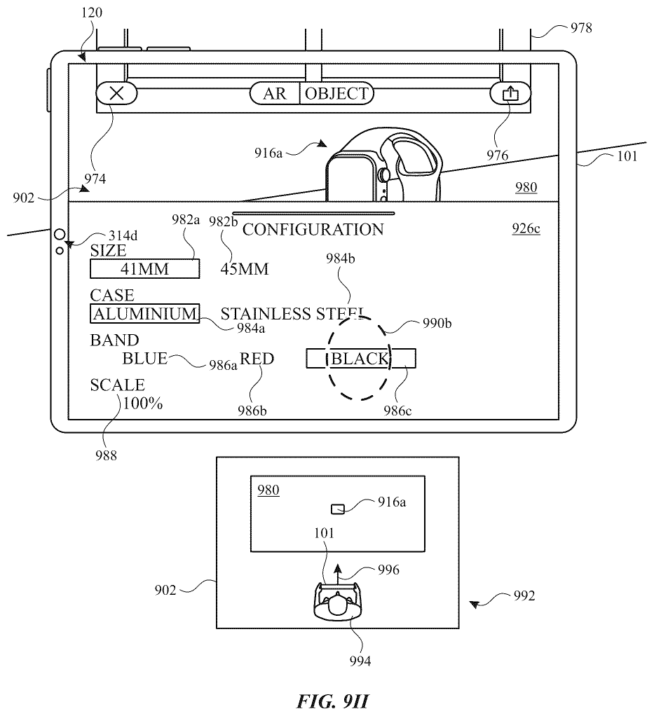

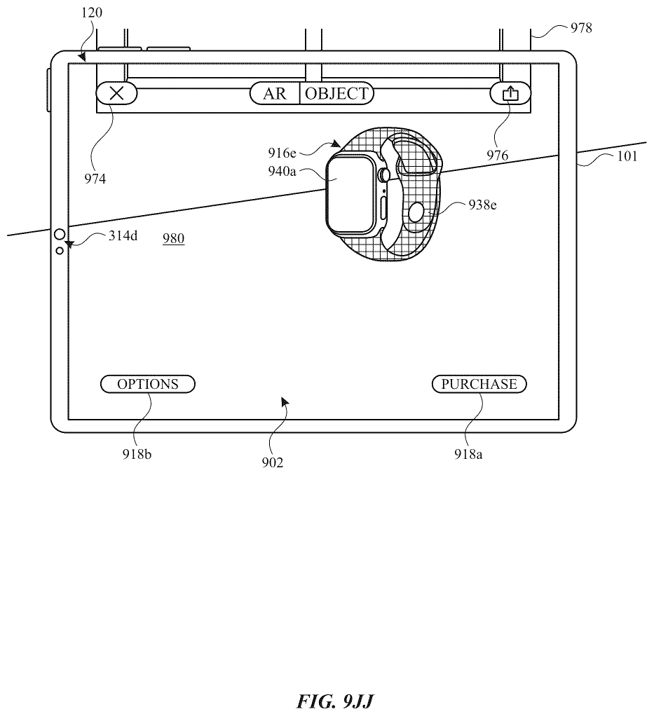

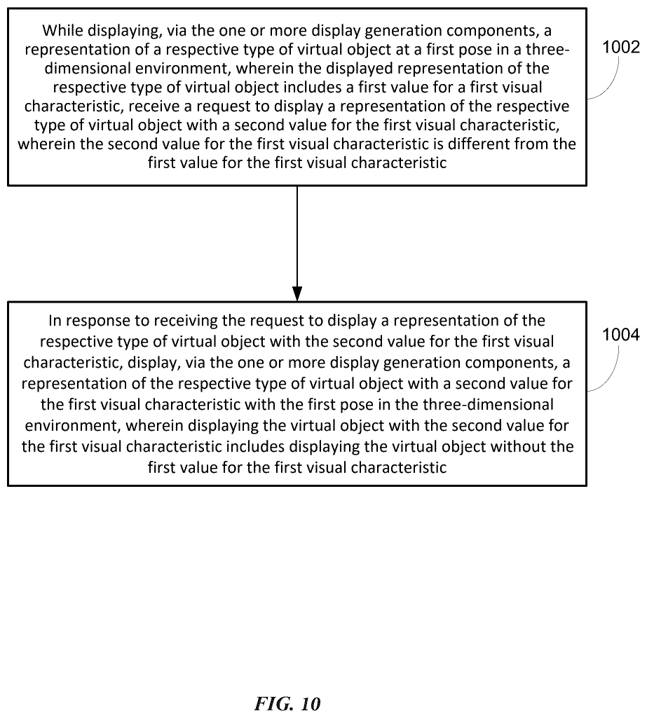

FIGS. 1A-6 provide a description of example computer systems for providing XR experiences to users (such as described below with respect to methods 800 and/or 1000). FIGS. 7A-7AD illustrate examples of a computer system snapping a virtual object to a surface within a three-dimensional environment. FIG. 8 is a flowchart illustrating an example method of a computer system snapping a virtual object to a surface within a three-dimensional environment. The user interfaces in FIGS. 7A-7AD are used to illustrate the processes in FIG. 8. FIGS. 9A-9JJ illustrate examples of a computer system displaying representations of respective types of virtual objects in a three-dimensional environment. FIG. 10 is flowchart illustrating an example method of a computer system displaying a representation of a respective type of virtual object in a three-dimensional environment. The user interfaces of FIGS. 9A-9JJ are used to illustrate the processes in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

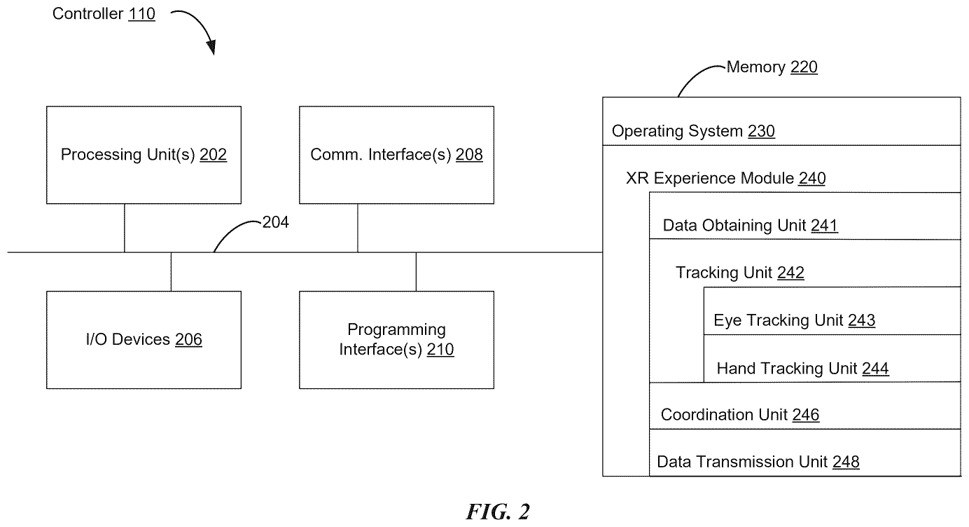

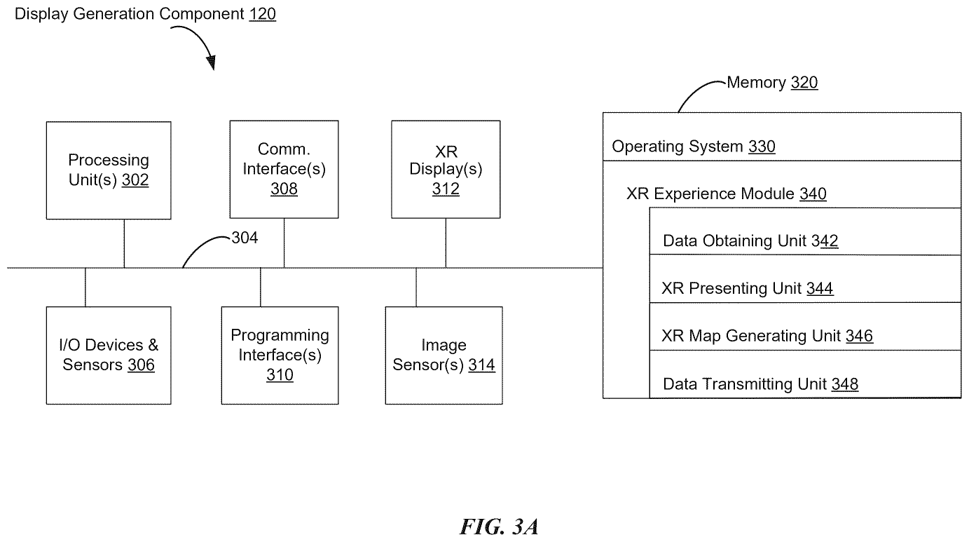

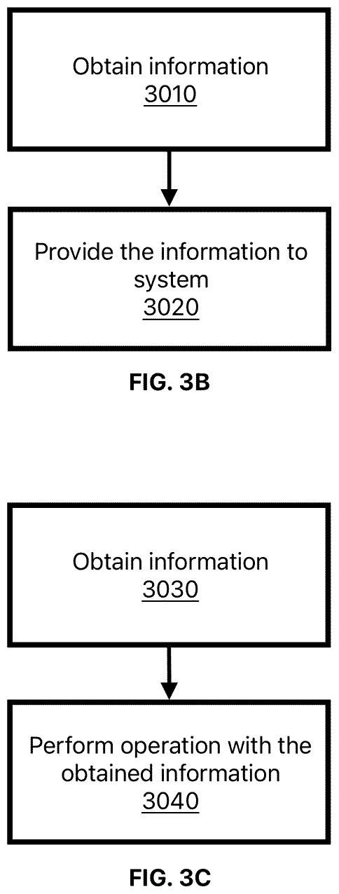

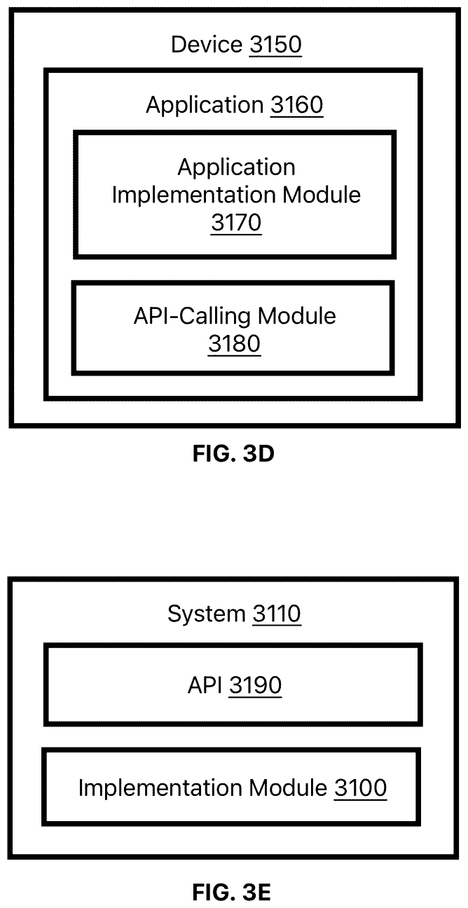

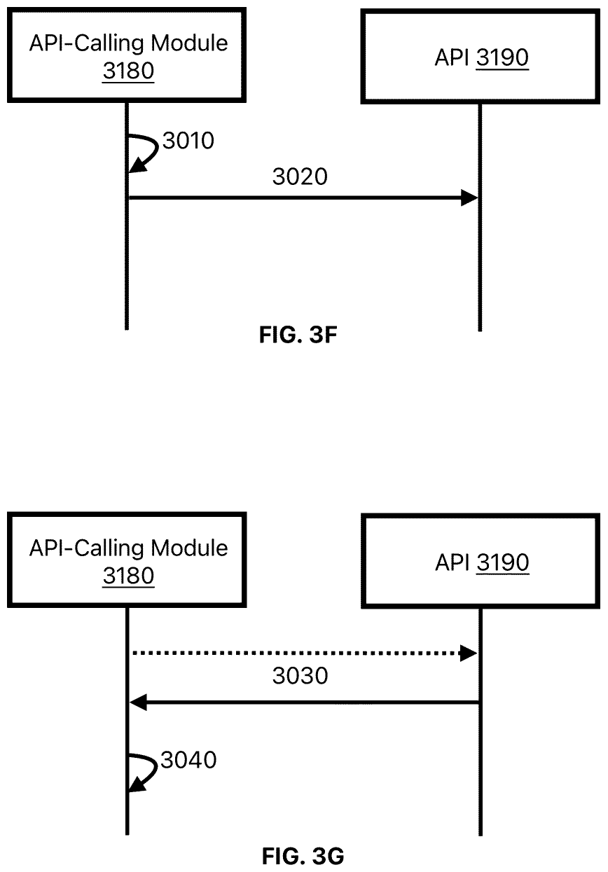

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

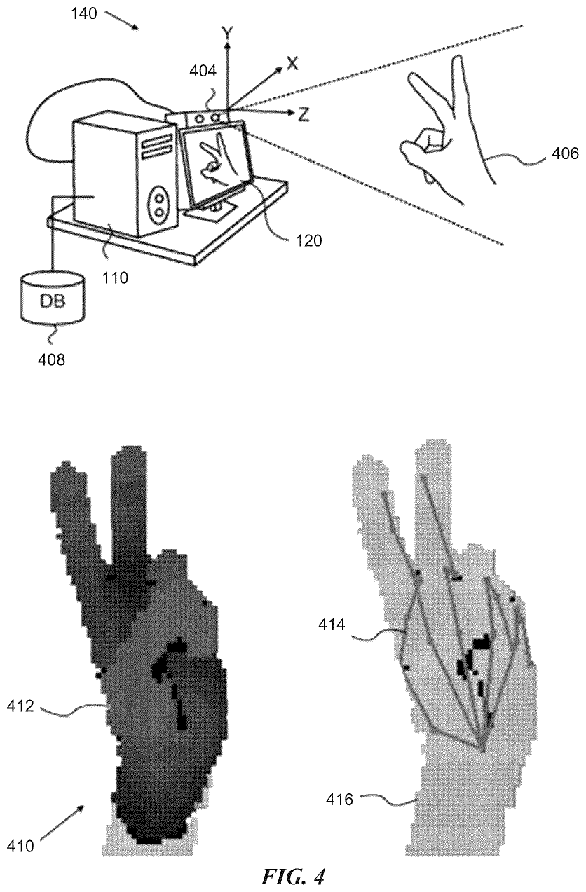

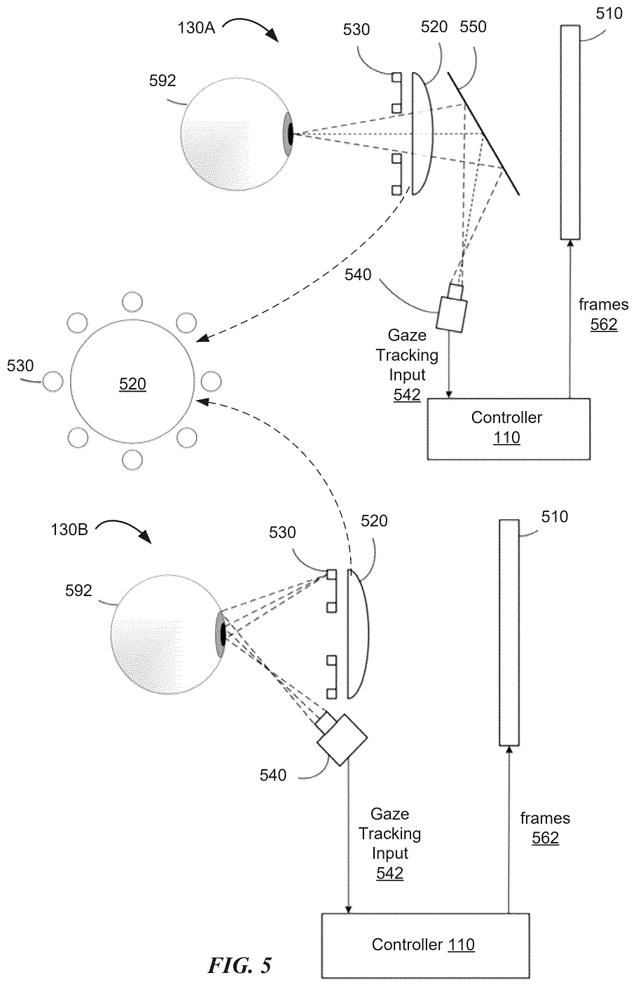

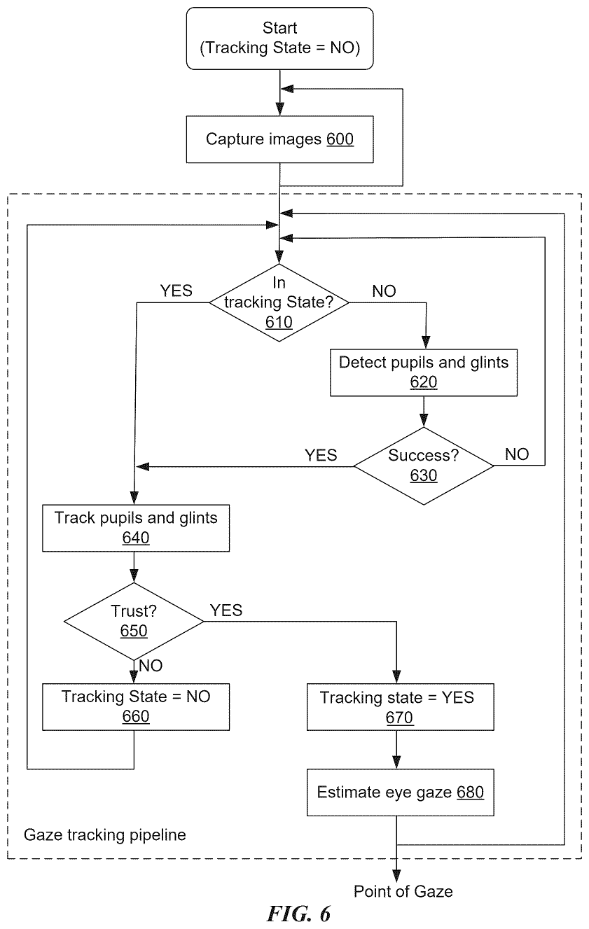

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8) and/or method 1000 (FIG. 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7AD illustrate examples of a computer system snapping a virtual object to a surface within a three-dimensional environment, in accordance with some embodiments.

FIG. 7A illustrates a computer system 101 displaying, via a display generation component 120, a three-dimensional environment 700 (e.g., a three-dimensional user interface). It should be understood that, in some embodiments, computer system 101 utilizes one or more techniques described with reference to FIGS. 7A-7AD in a two-dimensional environment without departing from the scope of the disclosure. As described above with reference to FIGS. 1-6, computer system 101 optionally includes a display generation component 120 (e.g., a head-mounted display) and a plurality of image sensors 114a-c (e.g., image sensors 314 of FIG. 3). Image sensors 114a-c optionally include one or more of a visible light camera, an infrared camera, a depth sensor, or any other sensor computer system 101 would be able to use to capture one or more images of a user or a part of the user (e.g., one or more hands of the user, such as a hand of the user) while the user interacts with computer system 101. In some embodiments, computer system 101 displays the user interface or three-dimensional environment 700 to the user (e.g., and/or the three-dimensional environment 700 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes a virtual object 710, a table 720 with a first surface 722, and a wall 730 with a second surface 732. For ease of discussion, also shown in FIG. 7A is a two-dimensional view 740, which illustrates a two-dimensional, front view of the physical environment around computer system 101 that is not displayed to the user.

As discussed in more detail below, in the example of FIG. 7A, display generation component 120 is illustrated as displaying content in three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7AD.

Display generation component 120 has a viewport (e.g., a field of view captured by external image sensors 114b and 114c and/or visible to the user via display generation component 120) that corresponds to the content shown in FIG. 7A. Because display generation component 120 is optionally a head-mounted device, the viewport of display generation component 120 is optionally the same as or similar to the field of view of the user.

As discussed herein, the user performs one or more air pinch gestures (e.g., with hand 702 in FIG. 7B) to provide one or more user inputs directed to content displayed by computer system 101. Such depiction is intended to be exemplary rather than limiting; the user optionally provides user inputs using different air gestures and/or using other forms of input as described with reference to method 800.

As shown in FIG. 7A, computer system 101 displays three-dimensional environment 700 that includes a visual representation of virtual object 710, table 720, first surface 722, wall 730, and second surface 732. Virtual object 710 is a digital representation of a physical item, application, content item, entity, or any construct that may be manipulated or interacted with in three-dimensional environment 700, as described in greater detail with respect to method 800. Depicted below virtual object 710 in three-dimensional environment 700, is table 720, which is optionally a generic table with a first surface 722, which refers to a digitally represented plane or contour within three-dimensional environment 700, as described in greater detail with respect to method 800. First surface 722 is represented as a horizontal surface that matches the top, flat surface of table 720. In some embodiments, computer system 101 displays wall 730 to the side of virtual object within three-dimensional environment 700. In some embodiments, wall 730 includes second surface 732, which also refers to a digitally represented plane or contour within three-dimensional environment 700. Second surface 732 is represented as a vertical surface that matches the plane or contour of wall 730.

In some embodiments, computer system 101 detects hand 702 of the user performing a gesture (e.g., an air pinch), as illustrated in FIG. 7B, indicating to computer system 101 that the user wishes to interact with virtual object 710. As shown in FIG. 7B, computer system 101 optionally detects hand 702 performing the air gesture while a gaze of the user, illustrated by gaze 704, is directed to virtual object 710 in three-dimensional environment 700. In some embodiments, upon detecting hand 702 performing the gesture, computer system 101 renders a virtual representation of a snapping zone 750 with boundaries illustrated as dotted lines in three-dimensional environment 700 (e.g., optionally displayed to the user via display generation component 120) and two-dimensional view 740. The boundaries of snapping zone 750 illustrate one or more threshold distances from the first surface which, when crossed by virtual object 710, as detected by computer system 101, cause computer system 101 to perform one or more snapping mechanisms, as described in greater detail with respect to method 800 (and below). In some embodiments, the boundaries of snapping zone 750 horizontally extend beyond the sides of table 720 to allow for a certain amount of imprecision from the user when moving virtual object 710 through three-dimensional environment 700. In some embodiments, upon detecting hand 702 performing the gesture, computer system 101 displays, via display generation component 120, a baseplate 712 of virtual object 710, which refers to a visual or structural element of virtual object 710 that is able to be snapped to a surface (e.g., first surface 722 or second surface 732), as described in greater detail with respect to method 800.

In some embodiments, computer system 101 detects hand 702 moving while performing an air pinch, as illustrated in FIG. 7B (e.g., downwards, relative to three-dimensional environment 700). To aid in the discussion of one or more snapping mechanisms described herein, FIGS. 7B-7G provide a visual depiction of a user hand speed 706a (e.g., the speed of hand 702 as it moves through the physical environment around computer system 101), a virtual object speed 706b (e.g., the speed of virtual object 710 as it is moved through three-dimensional environment 700), an input distance from the surface 706c (e.g., the distance that virtual object 710 should be at from first surface 722 as a result of the unmodified input of hand 702), an output distance from the surface 706d (e.g., the distance that virtual object 710 is at from first surface 722 as a result of the optionally modified input of hand 702), a virtual attractive force 706e (e.g., a simulated force within three-dimensional environment 700 that influences one or more movement characteristics of virtual object 710, as described in greater detail with respect to method 800). As shown in FIG. 7B, when virtual object 710 is outside of snapping zone 750 (e.g., as shown in three-dimensional environment 700 and two-dimensional view 740), there is no virtual attractive force 706e acting on virtual object 710 (e.g., as shown by virtual attractive force 706e being set to zero). As such, the speed of hand 702 corresponds directly to the speed of virtual object 710 within three-dimensional environment 700 (e.g., as shown by user hand speed 706a being equal to virtual object speed 706b), and virtual object 710 moves towards first surface 722 by the same amount as the distance input by hand 702 (e.g., as shown by input distance from the surface 706c being equal to output distance from the surface 706d).

In some embodiments, computer system 101 detects hand 702 move further downwards with respect to FIG. 7B, as shown in FIG. 7C. As a result, computer system 101 moves virtual object 710 below the threshold distance from first surface 722 defined by the boundaries of snapping zone 750, and in response computer system 101 begins to apply a virtual attractive force to one or more movement characteristics of virtual object 710. As shown in FIG. 7C, while the speed of hand 702 is the same as in FIG. 7B (e.g., the user moves hand 702 with a consistent speed), the speed of virtual object 710 within three-dimensional environment 700 is faster than in FIG. 7B (e.g., virtual object 710 accelerates as a result of virtual attractive force 706e). Similarly, while hand 702 attempts to move virtual object 710 by an input distance which would leave virtual object 710 in the position illustrated in two-dimensional view 740 by input distance virtual object 714, the output movement of virtual object 710 is larger than the input movement of virtual object 710 due to virtual attractive force 706e, causing computer system 101 to move virtual object 710 by more than the input distance within three-dimensional environment 700 (e.g., as shown by output distance from the surface 706d being smaller than input distance from the surface 706c and virtual object 710 being lower than input distance virtual object 714). That is, for every unit of distance input by hand 702, virtual object 710 moves by the unit of distance plus an additional distance based on the strength of virtual attractive force 706e. The difference between the input movement and the output movement (e.g., or between the input distance from the surface and the output distance from the surface) is represented by A in two-dimensional view 740.

In some embodiments, computer system 101 detects hand 702 move further downwards with respect to FIG. 7C while maintaining the gesture, as shown in FIG. 7D. As a result, virtual object 710 moves further into snapping zone 750, which corresponds to a larger virtual attractive force 706e acting on virtual object 710 (e.g., because virtual attractive force 706e increases as virtual object 710 moves towards first surface 722, as described in greater detail with respect to method 800). As such, as shown in FIG. 7D, while the speed of hand 702 is the same as in FIGS. 7B and 7C, the speed of virtual object 710 within three-dimensional environment 700 is faster than in FIG. 7C (e.g., virtual object 710 accelerates further as a result of the larger virtual attractive force 706e). Similarly, while hand 702 attempts to move virtual object 710 by an input distance similar to the input distance of FIG. 7C, the output movement of virtual object 710 in FIG. 7D is larger than the output movement of virtual object 710 in FIG. 7C, as shown by the difference between the input movement and the output movement A (e.g., or the difference between the input distance from the surface 706c and the output distance from the surface 706d) being larger in FIG. 7D.

In some embodiments, computer system 101 detects hand 702 move further downwards with respect to FIG. 7D, as shown in FIG. 7E. As a result, virtual object 710 moves further into snapping zone 750, crossing a virtual attractive force threshold 752, which refers to a specific distance from first surface 722 within three-dimensional environment 700 that signifies a change in the relationship between the magnitude of virtual attractive force 706e exerted on virtual object 710 and the distance of virtual object 710 to first surface 722 (e.g., once virtual object 710 crosses virtual attractive force threshold 752, virtual attractive force 706e begins to decrease as virtual object 710 moves closer to first surface 722), as described in greater detail with respect to method 800. As such, the speed of virtual object 710 within three-dimensional environment 700 optionally begins to slow. Since computer system 101 detects that virtual object 710 has just crossed virtual attractive force threshold 752, the effect of the smaller virtual attractive force 706e is not yet noticeable from the perspective of the user, as an increasing virtual attractive force has been exerted on virtual object 710 until this point.

In some embodiments, computer system 101 detects hand 702 move further downwards with respect to FIG. 7E while maintaining the gesture, as shown in FIG. 7F. As a result, virtual object 710 moves closer to first surface 722, which corresponds to a smaller virtual attractive force 706e acting on virtual object 710. In some embodiments, virtual attractive force 706e decreases past a point where its magnitude would be equal to zero (e.g., illustrated as a dotted line on virtual attractive force 706e) and becomes negative, causing computer system 101 to simulate first surface 722 repelling virtual object 710, as described in greater detail with respect to method 800. As such, as shown in FIG. 7F, virtual object speed 702b has continued to slow (e.g., virtual object speed 702b is now slower than user hand speed 702a). Similarly, as a result of the negative virtual attractive force 706e, for every unit of distance input by hand 702, virtual object 710 now moves by the unit of distance minus a respective distance based on virtual attractive force 706e, meaning that the difference between the input movement and the output movement A (e.g., or the difference between the input distance from the surface 706c and the output distance from the surface 706d) will continue to decrease until it reaches zero when virtual object 710 rests on first surface 722.

In some embodiments, computer system 101 detects hand 702 release the gesture (e.g., separate the fingers forming the air pinch), as shown in FIG. 7G, which causes computer system 101 to snap virtual object 710 to first surface 722, as described in greater detail with respect to method 800. In some embodiments, snapping virtual object 710 to first surface 722 causes computer system 101 to cease displaying baseplate 712.

In some embodiments, FIG. 7H illustrates an example graph of an input distance from a surface (e.g., unmodified distance from surface) vs. an output distance from the surface (e.g., modified distance from surface). In this example graph, the unmodified and modified distances from the surface are equal to each other at distances greater than 10 cm from the surface, meaning that the snapping threshold distance is equal to 10 cm. Similarly, the input and output distances are equal to each other in FIG. 7B, since virtual object 710 is outside of snapping zone 750 and virtual attractive force 706e is equal to zero. Then, from 10 cm to approximately 4 cm, the modified distance begins to outpace the unmodified distance, meaning that for every unit distance input by the user, computer system 101 moves the virtual object by the unit distance plus an additional distance (e.g., the additional distance determined by the strength of virtual attractive force 706e in FIGS. 7C and 7D). For instance, when the virtual object is 10 cm away from the surface, and the user attempts to move the virtual object by 1 cm, computer system 101 moves the object by approximately 1.3 cm. Then, if the user attempts to move the virtual object by 1 cm again, computer system 101 moves the object by approximately 1.5 cm, showing that the object is accelerating towards the surface as a result of a virtual attractive force (e.g., similar to the increasing virtual attractive force 702e of FIGS. 7C and 7D).

When the virtual object is approximately 4 cm away from the surface (e.g., or 6 cm away from the surface in unmodified units), the modified distance begins to slow relative to the unmodified distance, but for every unit distance input by the user, computer system 101 continues to move the virtual object by more than the unit distance (e.g., the virtual attractive force beginning to decrease after virtual object 710 crosses virtual attractive threshold 752, as shown in FIG. 7E, but not yet negative as to repel virtual object 710 from first surface 722). For example, when the virtual object is approximately 4 cm away from the surface (e.g., or 6 cm away from the surface in unmodified units), and the user attempts to move the virtual object by 1 cm, computer system 101 moves the object by approximately 1.4 cm.

Next, when the virtual object is approximately 2 cm away from the surface (e.g., or 4.6 cm away from the surface in unmodified units), the modified distance and the unmodified distance change approximately equally relative to each other (e.g., virtual attractive force 706e being approximately equal to zero at some point between FIGS. 7E and 7F). For example, when the virtual object is approximately 2 cm away from the surface (e.g., or 4.6 cm away from the surface in unmodified units), and the user attempts to move the virtual object by 1 cm, computer system 101 moves the object by approximately 1 cm.

Finally, when the virtual object is approximately 1 cm away from the surface (e.g., or 3.6 cm away from the surface in unmodified units), the unmodified distance begins to outpace the modified distance, meaning that for every unit distance input by the user, computer system 101 moves the virtual object by less than the unit distance (e.g., based on the strength of the negative virtual attractive force 706e, as shown in FIG. 7F). For example, when the virtual object is approximately 1 cm away from the surface (e.g., or 3.6 cm away from the surface in unmodified units), and the user attempts to move the virtual object by 1 cm, computer system 101 moves the object by approximately 0.6 cm.

Referring back to the example of FIG. 7B, in some embodiments, after detecting hand 702 of the user perform a gesture (e.g., an air pinch), as illustrated in FIG. 7B, computer system 101 instead detects hand 702 move towards second surface 732 of wall 730 while maintaining the gesture, as illustrated in FIG. 7I. In some embodiments, when virtual object 710 is within a certain distance from second surface 732 (e.g., or is closer to second surface 732 than first surface 722), computer system 101 renders a virtual representation of a snapping zone 750a (e.g., and optionally ceases to display snapping zone 750) with boundaries illustrated as dotted lines in three-dimensional environment 700 (e.g., optionally displayed to the user via display generation component 120) and two-dimensional views 742a and 742b. For ease of discussion, the following interactions between virtual object 710, second surface 732, and snapping zone 750a are discussed with reference to two-dimensional views 742a-742d.

Two-dimensional view 742a corresponds to the scene depicted in three-dimensional environment 700, where virtual object 710 is positioned outside of snapping zone 750a. In some embodiments, computer system 101 detects hand 702 continuing to move virtual object 710 towards second surface 732, as illustrated in two-dimensional view 742b, and in response computer system 101 moves virtual object 710 closer to second surface 732 and within the boundaries of snapping zone 750a. In some embodiments, moving virtual object 710 within snapping zone 750a has one or more characteristics of moving virtual object 710 within snapping zone 750. In some embodiments, computer system 101 detects hand 702 releasing the gesture, as illustrated the in alternate scenarios of two-dimensional views 742c and 742d. In two-dimensional view 742c, upon determining that one or more snapping criteria are not met (e.g., when virtual object 710a is a first type of virtual object that cannot snap to second surface 732 because it cannot snap to vertical surfaces or to the particular material/texture of second surface 732, as described in greater detail with respect to method 800), computer system 101 does not snap virtual object 710a to second surface 732 and maintains the position of virtual object 710a. In two-dimensional view 742d, upon determining that the one or more snapping criteria are met, computer system 101 moves and snaps virtual object 710b to second surface 732.

In some embodiments, after detecting hand 702 of the user performing a gesture (e.g., an air pinch and drag), as illustrated in FIG. 7B, computer system 101 detects hand 702 move towards first surface 722 to a first position at a certain speed, as illustrated in FIG. 7J, where the first position is equal to the position of virtual object 710 in FIG. 7C. In some embodiments, the boundaries of snapping zone 750 are based on the speed of virtual object 710 as it moves within three-dimensional environment 700, as illustrated in two-dimensional views 744a-744c. For example, when virtual object 710 moves to the first position at a speed 708a, snapping zone 754a has a height equal to D1; when virtual object 710 moves to the first position at a speed 708b, snapping zone 754b has a height equal to D2; and when virtual object 710 moves to the first position at a speed 708c, snapping zone 754c has a height equal to D3, where speed 708a<speed 708b<speed 708c and D1>D2>D3 (e.g., demonstrating an inverse proportional relationship between the speed of movement and the height of the snapping zone). In some embodiments, despite the first position being equal to the position of virtual object 710 in FIG. 7C and virtual object 710 being within snapping zone 750 in FIG. 7C, virtual object 710 is not within snapping zones 754a-754c due to the faster speeds of virtual object 710.

In some embodiments, the height and/or dimensions of the snapping zone are based on the direction from which the object approached the surface as illustrated in FIG. 7K. In the example of FIG. 7K, computer system 101 displays three-dimensional environment 700 with virtual object 710 below table 720 and first surface 722. For ease of discussion, the following interactions between virtual object 710, first surface 722, and snapping zone 750 are discussed with reference to two-dimensional views 746a-746h. In some embodiments, computer system 101 detects hand 702 of the user perform a gesture (e.g., an air pinch) while gaze 704 is directed to virtual object 710, as illustrated in two-dimensional view 746a, indicating to computer system 101 that the user wishes to interact with virtual object 710. In some embodiments, upon detecting hand 702 perform the gesture, computer system 101 renders a virtual representation of snapping zone 750 with boundaries equal to the boundaries of snapping zone 750 in FIGS. 7B-7F, as illustrated in two-dimensional view 746a.

In some embodiments, computer system 101 detects hand 702 moving, as illustrated in two-dimensional view 746b, while maintaining the gesture (e.g., the air pinch) (e.g., upwards, relative to three-dimensional environment 700). In some embodiments, computer system 101 detects hand 702 move further upwards with respect to two-dimensional view 746b while maintaining the gesture, as shown in two-dimensional view 746c. As a result, virtual object 710 crosses first surface 722, causing computer system 101 to collapse snapping zone 750 (e.g., cease to render snapping zone 750, as described in greater detail with respect to method 800). In some embodiments, when computer system 101 detects hand 702 release the gesture while virtual object 710 is in the position shown in two-dimensional view 746c, computer system 101 does not snap virtual object 710 to first surface 722. In some embodiments, computer system 101 detects hand 702 move further upwards with respect to two-dimensional view 746c while maintaining the gesture, as shown in two-dimensional view 746d. As a result, virtual object 710 completely crosses first surface 722 until the bottom of virtual object 710 is flush with first surface 722, and snapping zone 750 remains collapsed. In some embodiments, when computer system 101 detects hand 702 release the gesture while virtual object 710 is in the position shown in two-dimensional view 746d, computer system 101 does not snap virtual object 710 to first surface 722 despite virtual object 710 being above/at the same height as first surface 722.

In some embodiments, computer system 101 detects hand 702 move further upwards with respect to two-dimensional view 746d while maintaining the gesture, as shown in two-dimensional view 746e. As a result, computer system 101 moves virtual object 710 to a height D1′ from first surface 722, and renders snapping zone 750 with a boundary height of D1′ equal to the height of virtual object 710 from first surface 722. In some embodiments, computer system 101 detects hand 702 move further upwards with respect to two-dimensional view 746e while maintaining the gesture, as shown in two-dimensional view 746f. As a result, computer system 101 moves virtual object 710 to a height D2′ from first surface 722, and changes the height of the boundary of snapping zone 750 to be D2′, equal to the distance of virtual object 710 from first surface 722 (e.g., computer system 101 matches the height of the boundary of snapping zone 750 to be equal to the distance of virtual object 710 from first surface 722 while the height of the boundary of snapping zone 750 is less than a maximum height, the maximum height optionally being equal to the height of the snapping zone as illustrated in two-dimensional views 746a and 746b, as described in greater detail with respect to method 800). In some embodiments, when computer system 101 detects hand 702 release the gesture while virtual object 710 is in the positions shown in two-dimensional views 746e and 746f, computer system 101 does not snap virtual object 710 to first surface 722 despite virtual object 710 being at the same height as snapping zone 750.

In some embodiments, after virtual object 710 reaches the position shown in two-dimensional view 746f, computer system 101 detects hand 702 move downwards with respect to two-dimensional view 746f while maintaining the gesture, as shown in two-dimensional view 746g. As a result, computer system 101 moves virtual object 710 to a position within snapping zone 750 based on the user input and maintains the height of the boundary of snapping zone 750 at D2′. In some embodiments, when computer system 101 detects hand 702 release the gesture while virtual object 710 is in the position shown in two-dimensional view 746g, provided that there are no other factors that would prohibit snapping, computer system 101 moves and snaps virtual object 710 to first surface 722, as illustrated in FIG. 7G. In some embodiments, after virtual object 710 reaches the position shown in two-dimensional view 746f, computer system 101 detects hand 702 move further upwards with respect to two-dimensional view 746f while maintaining the gesture, as shown in two-dimensional view 746h. As a result, computer system 101 moves virtual object 710 past a maximum height D3′ of the boundary of snapping zone 750 and computer system 101 changes the height of the boundary of snapping zone 750 to be D3′ and stop matching the height of virtual object 710.

In some embodiments, when an object is snapped to a surface, the computer system optionally restricts certain rotations of the object as illustrated in FIGS. 7M-7O. In some embodiments, while virtual object 710 is snapped to first surface 722, computer system 101 detects hand 702 perform a gesture corresponding to rotation about an axis perpendicular to first surface 722 (e.g., an air pinch and rotation of hand 702 about the perpendicular axis), as illustrated in FIG. 7M. As a result, computer system 101 rotates virtual object 710 about the perpendicular axis in accordance with the gesture. In some embodiments, while virtual object 710 is snapped to first surface 722, computer system 101 detects hand 702 perform a gesture corresponding to rotation about an axis parallel to first surface 722 (e.g., a horizontal axis, as illustrated in FIG. 7N, or a depth axis, as illustrated in FIG. 7O). As a result, computer system 101 does not rotate virtual object 710 about the parallel axis in accordance with the gesture, since doing so would cause virtual object 710 to cross through first surface 722.

In some embodiments, while virtual object 710 is snapped to first surface 722, computer system 101 detects hand 702 performing a gesture corresponding to movement in two axes, with a perpendicular movement component 760a acting along the perpendicular axis and a parallel movement component 760b acting along the parallel axis, as illustrated in FIG. 7P. As a result, computer system 101 moves virtual object 710 from a previous position shown in a two-dimensional view of the previous state 748a to a current position shown in a two-dimensional-view of the current state 749a. In some embodiments, a displacement 762 between the previous position and the current position is based on parallel movement component 760b acting along the parallel axis and optionally a portion of perpendicular movement component 760a, translated to act along the parallel axis, as described in greater detail with respect to method 800. In some embodiments, when displacement 762 includes the portion of perpendicular movement component 760a, displacement 762 is larger than a displacement based solely on parallel movement component 760b, as shown in two-dimensional view of the current state 748b.

In some embodiments, after computer system 101 detects hand 702 of the user perform a gesture (e.g., an air pinch), as illustrated in FIG. 7B, computer system 101 detects hand 702 moving downwards and rightwards, with a perpendicular movement component 764a acting along the perpendicular axis and a parallel movement component 764b acting along the parallel axis, where the magnitude of perpendicular movement component 764a is larger than the magnitude of parallel movement component 764b, as illustrated in FIG. 7Q. As a result, computer system 101 moves virtual object 710 from a previous position shown in a two-dimensional view of the previous state 748b to a current position shown in a two-dimensional view of the current state 749b. In some embodiments, a displacement 766a between the previous position and the current position is based on perpendicular movement component 760a acting along the perpendicular axis and parallel movement component 760b acting along the parallel axis, since virtual object 710 is not within a distance from first surface 722 where computer system 101 activates axis locking (e.g., outside of snapping zone 750). In some embodiments, displacement 766a is based on perpendicular movement component 760a acting along the perpendicular axis and a portion of parallel movement component 760b acting along the parallel axis, since computer system 101 activates axis locking when a movement component in one direction is larger than a movement component in a different direction in favor of the direction associated with the larger movement component, as described in greater detail with respect to method 800.

In some embodiments, after computer system 101 detects hand 702 of the user perform a gesture (e.g., an air pinch), as illustrated in FIG. 7B, and when the position of virtual object 710 is closer to first surface 722 than the position illustrated in FIG. 7Q, computer system 101 detects hand 702 moving downwards and rightwards, with perpendicular movement component 764a acting along the perpendicular axis and parallel movement component 764b acting along the parallel axis, where the magnitude of perpendicular movement component 764a is larger than the magnitude of parallel movement component 764b, as illustrated in FIGS. 7R and 7S.

In some embodiments, computer system 101 moves virtual object 710 from a previous position shown in a two-dimensional view of the previous state 748c to a current position shown in a two-dimensional view of the current state 749c, as illustrated in FIG. 7R. In some embodiments, a displacement 766b between the previous position and the current position is based on perpendicular movement component 764a acting along the perpendicular axis and a portion of parallel movement component 764b acting along the parallel axis, as illustrated in FIG. 7R. In some embodiments, computer system 101 activates axis locking when a movement component in one direction is larger than a movement component in a different direction in favor of the direction associated with the larger movement component and/or when virtual object 710 is within a certain axis locking distance from first surface 722 (e.g., the boundary of snapping zone 750) in favor of the axis perpendicular to first surface 722, as described in greater detail with respect to method 800.

In some embodiments, computer system 101 moves virtual object 710 from the previous position shown in two-dimensional view of the previous state 748c to a current position shown in a two-dimensional view of the current state 749d, as illustrated in FIG. 7S. In some embodiments, a displacement 766c between the previous position and the current position is based on perpendicular movement component 764a plus a first portion of parallel movement component 764b acting along the perpendicular axis and a second portion of parallel movement component 764b acting along the parallel axis, as illustrated in FIG. 7S. In some embodiments, computer system 101 activates axis locking when a movement component in one direction is larger than a movement component in a different direction in favor of the direction associated with the larger movement component and/or when virtual object 710 is within a certain axis locking distance from first surface 722 (e.g., the boundary of snapping zone 750) in favor of the axis perpendicular to first surface 722, as described in greater detail with respect to method 800. In some embodiments, the magnitude of displacement 766c is larger than the magnitude of displacement 766b.

In some embodiments, after computer system 101 detects hand 702 of the user perform a gesture (e.g., an air pinch), as illustrated in FIG. 7B, and when the position of virtual object 710 is closer to first surface 722 than the position illustrated in FIGS. 7R and 7S, computer system 101 detects hand 702 moving downwards and rightwards, with perpendicular movement component 764a acting along the perpendicular axis and parallel movement component 764b acting along the parallel axis, where the magnitude of perpendicular movement component 764a is larger than the magnitude of parallel movement component 764b, as illustrated in FIGS. 7T and 7U.

In some embodiments, computer system 101 moves virtual object 710 from a previous position shown in a two-dimensional view of the previous state 748d to a current position shown in a two-dimensional view of the current state 749e, as illustrated in FIG. 7T. In some embodiments, a displacement 766d between the previous position and the current position is based on perpendicular movement component 764a acting along the perpendicular axis, as illustrated in FIG. 7T. In some embodiments, computer system 101 activates axis locking when a movement component in one direction is larger than a movement component in a different direction in favor of the direction associated with the larger movement component and/or when virtual object 710 is within a certain axis locking distance from first surface 722 (e.g., the boundary of snapping zone 750) in favor of the axis perpendicular to first surface 722, as described in greater detail with respect to method 800. Axis locking refers to the restriction of the movement of virtual object 710 to a particular directional axis and/or the suppression of movement in one or more directional axes different from the particular directional axis, as described in greater detail with respect to method 800.

In some embodiments, computer system 101 moves virtual object 710 from the previous position shown in two-dimensional view of the previous state 748d to a current position shown in a two-dimensional view of the current state 749f, as illustrated in FIG. 7U. In some embodiments, a displacement 766e between the previous position and the current position is based on perpendicular movement component 764a plus a first portion of parallel movement component 764b acting along the perpendicular axis, as illustrated in FIG. 7U. In some embodiments, computer system 101 activates axis locking when a movement component in one direction is larger than a movement component in a different direction in favor of the direction associated with the larger movement component and/or when virtual object 710 is within a certain axis locking distance from first surface 722 (e.g., the boundary of snapping zone 750) in favor of the axis perpendicular to first surface 722, as described in greater detail with respect to method 800. In some embodiments, the magnitude of displacement 766e is larger than the magnitude of displacement 766d.

In some embodiments, computer system 101 displays three-dimensional environment 700 with a virtual object above first surface 722, where the virtual object is a window 716 (e.g., a graphical user interface element that represents a contained view or section of the virtual space, as described in greater detail with respect to method 800), as illustrated in FIG. 7V. In some embodiments, computer system 101 detects hand 702 of the user perform a gesture (e.g., an air pinch), as illustrated in FIG. 7V, indicating to computer system 101 that the user wishes to interact with window 716. As shown in FIG. 7V, computer system 101 optionally detects hand 702 perform the air gesture while a gaze of the user, illustrated by gaze 704, is directed to window 716 in three-dimensional environment 700. In some embodiments, upon detecting hand 702 performing the gesture, computer system 101 renders a virtual representation of a snapping zone 750 with boundaries illustrated as dotted lines in three-dimensional environment 700 (e.g., optionally displayed to the user via display generation component 120) and two-dimensional view 740. The boundaries of snapping zone 750 illustrate one or more threshold distances from the first surface that virtual object 710 must cross for one or more snapping mechanisms to be performed by computer system 101, as described in greater detail with respect to method 800.

In some embodiments, computer system 101 detects hand 702 maintaining the gesture (e.g., the air pinch) and moving in a particular direction (e.g., downwards, relative to three-dimensional environment 700) as illustrated in FIG. 7V. In some embodiments, computer system 101 detects hand 702 move downwards with respect to FIG. 7V while maintaining the gesture, as shown in FIG. 7W. In some embodiments, upon detecting window 716 cross the boundary of snapping zone 750, computer system 101 moves window 716 according to one or more snapping mechanisms, as described in greater detail above with respect the one or more snapping mechanisms applied to virtual object 710. In some embodiments, after computer system 101 detects hand 702 continuing to move window 716 closer to first surface 722 and then releasing the gesture (e.g., separating the fingers forming the air pinch), as illustrated in FIG. 7X, computer system 101 snaps window 716 to first surface 722, as described in greater detail with respect to method 800.

In some embodiments, computer system 101a is in a communication session (e.g., a real-time interaction during which two or more participants engage in the exchange of information across a network, as described in greater detail with respect to method 800) with a computer system 101b, as illustrated in FIG. 7Y. In some embodiments, computer system 101a displays environment 700a with virtual object 710 at a first position above first surface 722, and computer system 101b displays environment 700b with virtual object 710 at the first position or at a similar position to the first position in environment 700b, as illustrated in FIG. 7Y. In some embodiments, virtual object 710 is shared between both computer system 101a and 101b, as described in more detail with respect to method 800. In some embodiments, computer system 101a detects hand 702 of the user perform a gesture (e.g., an air pinch), as illustrated in FIG. 7Z, indicating to computer system 101a that the user wishes to interact with virtual object 710. In some embodiments, upon detecting hand 702 perform the gesture, computer system 101a renders a virtual representation of a snapping zone 750 with boundaries illustrated as dotted lines in environment 700a (e.g., optionally displayed to the user of computer system 101a via display generation component 120). Meanwhile, computer system 101b does not render snapping zone 750 in environment 700b (e.g., because there is no table 720 in environment 700b). The boundaries of snapping zone 750 illustrate one or more threshold distances from the first surface that virtual object 710 must cross for one or more snapping mechanisms to be performed by computer system 101a, as described in greater detail with respect to method 800.

In some embodiments, computer system 101a detects hand 702 maintaining the gesture (e.g., the air pinch) and moving in a particular direction (e.g., downwards, relative to three-dimensional environment 700), as illustrated in FIG. 7Z. As a result, computer systems 101a and 101b both move virtual object 710 based on the input from hand 702 in environments 700a and 700b, respectively. As illustrated in FIG. 7Z, while in environment 700a virtual object 710 is positioned within snapping zone 750, environment 700b does not include snapping zone 750, and virtual object 710 is not positioned within a snapping zone. As a result, computer system 101a does not engage one or more snapping mechanisms, such as the virtual attractive force. In some embodiments, when environment 700b includes a snapping zone, such as snapping zone 750, at the same or similar position as snapping zone 750 in environment 700a, computer systems 101a and 101b engage one or more snapping mechanisms. In some embodiments, while virtual object 710 is within snapping zone 750 in environment 700a, computer system 101a detects hand 702 releasing the gesture (e.g., separating the fingers forming the air pinch), as illustrated in FIG. 7AA. In response to the detection, computer system 101a does not snap and/or move virtual object 710 to first surface 722 because virtual object 710 is shared with computer system 101b. Similarly, computer system 101b does not snap and/or move virtual object 710, which maintains its position in environment 700b.

In some embodiments, computer system 101a is in a communication session with computer system 101b, as illustrated in FIG. 7AB. In some embodiments, computer system 101a displays environment 700a with virtual object 710 at a first position above first surface 722, and computer system 101b displays environment 700b without displaying virtual object 710, as illustrated in FIG. 7AB. In some embodiments, virtual object 710 is private, meaning it is only displayed by computer system 101a in environment 700a, and computer system 101b optionally has no information about virtual object 710. In some embodiments, computer system 101a detects hand 702 of the user perform a gesture (e.g., an air pinch), as illustrated in FIG. 7AC, indicating to computer system 101a that the user wishes to interact with virtual object 710. In some embodiments, upon detecting hand 702 perform the gesture, computer system 101a renders a virtual representation of a snapping zone 750 with boundaries illustrated as dotted lines in environment 700a (e.g., optionally displayed to the user of computer system 101a via display generation component 120). Meanwhile, computer system 101b does not render snapping zone 750 in environment 700b (e.g., because computer system 101b has no information on virtual object 710). The boundaries of snapping zone 750 illustrate one or more threshold distances from the first surface that virtual object 710 must cross for one or more snapping mechanisms to be performed by computer system 101a, as described in greater detail with respect to method 800.

In some embodiments, computer system 101a detects hand 702 maintaining the gesture (e.g., the air pinch) and moving in a particular direction (e.g., downwards, relative to three-dimensional environment 700), as illustrated in FIG. 7AC. As a result, computer system 101a moves virtual object 710 based on the input from hand 702 in environment 700a, respectively. As illustrated in FIG. 7AC, while in environment 700a virtual object 710 is positioned within snapping zone 750, environment 700b does not include snapping zone 750 or virtual object 710. As a result, computer system 101a engages one or more snapping mechanisms, such as the virtual attractive force. In some embodiments, while virtual object 710 is within snapping zone 750 in environment 700a, computer system 101a detects hand 702 releasing the gesture (e.g., separating the fingers forming the air pinch), as illustrated in FIG. 7AD. In response to the detection, computer system 101a snaps and optionally moves virtual object 710 to first surface 722 because virtual object 710 is private to computer system 101a.

FIG. 8 is a flowchart illustrating an example method 800 of a computer system snapping a virtual object to a surface within a three-dimensional environment. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with a display generation component and one or more input devices, such as computer system 101 in communication with display generation component 120 as shown in FIG. 8A. In some embodiments, the computer system is or includes an electronic device, such as a mobile device (e.g., a tablet, a smartphone, a media player, or a wearable device), or a computer. In some embodiments, the display generation component is a display integrated with the computer system (e.g., optionally a touch screen display), external display such as a monitor, projector, television, or a hardware component (e.g., optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device.

In some embodiments, while displaying, via the display generation component, a virtual object (e.g., a two-dimensional virtual object, or a three-dimensional virtual object) at a first location that is a first distance from a first surface in a three-dimensional environment, the computer system detects (802) a first input, via the one or more input devices, corresponding to moving the virtual object to a second location within the three-dimensional environment that is at a second distance, different from the first distance, from the first surface, wherein the first location is further than a threshold distance from the first surface and the second location is closer than the threshold distance from the first surface, such as hand 702 performing a gesture (e.g., performing an air pinch and moving while holding the air pinch) requesting movement of virtual object 710 as shown in FIGS. 7B and 7C.

In some embodiments, the three-dimensional environment is generated, displayed, or otherwise caused to be viewable by the computer system. For example, the three-dimensional environment is an extended reality (XR) environment, such as a virtual reality (VR) environment, a mixed reality (MR) environment, or an augmented reality (AR) environment. In some embodiments, the three-dimensional environment at least partially or entirely includes the physical environment of the user of the computer system. In some embodiments, the three-dimensional environment includes one or more virtual objects and/or representations of objects in a physical environment of a user of the computer system. In some embodiments, a virtual object is a digital representation of a physical item (e.g., electronic devices, tools, furniture, or the like), application, content item (e.g., videos, images, documents, or the like displayed in a content window), entity, or any construct that may be manipulated or interacted with in the three-dimensional environment. For example, the virtual object may be a virtual representation of a physical item, such as a laptop, and may be snapped onto a physical or virtual table to mimic the real-world interaction of placing a laptop on a physical surface. In some embodiments, mimicking the real-world interaction of placing the laptop on the table include ensuring the virtual laptop aligns with the surface of the table accurately, reflecting real-world physics like gravity and/or stability (e.g., if the virtual laptop is positioned near the edge of the table, the system may automatically adjust its placement to ensure it sits solidly on the table top), casting a shadow on the table, or any action that may be taken to enhance the realism of the interaction. As another example, in a workspace within three-dimensional environment, the virtual object may be a productivity application that the user can place on a physical or virtual desk, allowing interaction as if it were a physical device.

In some embodiments, the virtual object has one or more properties that define its behavior, appearance, and interaction capabilities within the three-dimensional environment. For example, the one or more properties may include, but are not limited to, visual attributes (e.g., color, texture, and/or shape), physical simulations (e.g., mass, friction, and/or elasticity), interaction affordances (e.g., grabbable, scalable, and/or rotatable), and context-aware properties (e.g., visibility based on user location or orientation, snapping behavior to surfaces). In some embodiments, the first surface refers to a digitally represented plane or contour within the three-dimensional environment, serving as a point of interaction or reference for virtual objects, facilitating their placement, movement, or other forms of interaction. In some embodiments, the first surface represents or coincides with a physical surface within the three-dimensional environment, such as in applications involving passive passthrough technology, where digital content is displayed/overlaid onto the three-dimensional environment visible via the display generation component from a viewpoint of the user. In some embodiments, the first surface is a virtual representation of a physical object's surface. For example, the first surface may be the top of a physical table, the wall of a room, the floor, or any other tangible object's surface that may be recognized and utilized within the three-dimensional environment for virtual object interaction. In some embodiments, the first surface has one or more properties, such as an orientation (e.g., horizontal, vertical, and/or angled), a texture (e.g., smooth, rough, patterned, and/or the physical texture of a real-world object), and interactive properties (e.g., static, dynamic, responsive to virtual and/or physical objects).

In some embodiments, the first location refers to the initial position or point within the three-dimensional environment where the virtual object is displayed or placed prior to any interaction or movement, optionally representing the object's position when it is not yet snapped to any surface (e.g., the virtual object, at the first location, is not within a snapping threshold distance of any surface in the three-dimensional environment). In some embodiments, the first location is a position within the three-dimensional environment outside of a snapping zone, as described in greater detail with respect to the snapping zone below. In some embodiments, the first distance refers to the measure of separation between the initial position of the virtual object (e.g., the first location) and a designated reference point or surface (e.g., the first surface) within the three-dimensional environment. In some embodiments, the first distance is larger than a threshold distance of a snapping zone (e.g., the distance between the first surface and a boundary of the snapping zone), as described in greater detail with respect to the snapping zone below.

In some embodiments, moving the virtual object refers to the process of changing the position of the virtual object within the three-dimensional environment from one location to another. In some embodiments, the movement of the virtual object is guided by user input or by automated system commands. In some embodiments, moving the virtual object is facilitated by the system's interpretation of one or more inputs from the one or more input devices, such as hand gestures captured by motion sensors (e.g., an air pinch directed at the virtual object followed by movement of the hand to relocate it, a swipe gesture to slide the object across the three-dimensional environment, or a twist motion to rotate the object in place), commands from a handheld controller, cursor movements on a touchpad or screen, or any other inputs described herein. In some embodiments, moving the virtual object to the second location results in a change in the spatial relationship (e.g., position and/or orientation) between the virtual object and a reference surface (e.g., the first surface).

In some embodiments, the first location being further than the threshold distance from the first surface refers to the initial placement of the virtual object being outside the proximity required for a snapping process to engage, as described in greater detail below. In some embodiments, the second location being closer than the threshold distance from the first surface refers to the virtual object being within the proximity required for the snapping process to engage, as described in greater detail below. In some embodiments, the threshold distance is a predefined measure or proximity, determining the point or points at which the system recognizes the virtual object as being at a position for snapping to possibly occur. In some embodiments, the threshold distance varies based on a speed of movement of the virtual object, a direction of movement of the virtual object, an orientation of the virtual object, an application's requirements, the nature of the virtual object and/or surface involved, and/or the intended user experience, as described in greater detail below. For example, the threshold distance may be a distance away from the first surface equal to 1 cm, 2 cm, 5 cm, 10 cm, 20 cm, 50 cm, 1 m, 2 m, or 5 m. In some embodiments, if the second location is closer than the threshold distance from the first surface and the threshold distance from a second surface, the system determines whether to engage the snapping process for the first surface or the second surface in accordance with one or more snapping criteria, as described in greater detail below. In some embodiments, if the second location is further than the threshold distance from the first surface, the system forgoes engaging the snapping process and moves the virtual object to the second location.

In some embodiments, in response to detecting the first input (804), in accordance with a determination that one or more snapping criteria are satisfied while the virtual object is the second distance from the first surface, the computer system moves (806) the virtual object to a third location that is closer to the first surface than the first location and the second location (e.g., automatically moving the virtual object further toward the first surface, and/or snapping the virtual object to the first surface), such as the movement of virtual object 710 as shown in FIGS. 7C-7G.

In some embodiments, the one or more snapping criteria refer to a set of conditions or parameters that must be met for a virtual object to automatically align and/or attach (e.g., snap) to a designated surface within the three-dimensional environment. In some embodiments, the one or more snapping criteria ensure that the snapping action occurs under appropriate circumstances. Some examples of snapping criteria include, but are not limited to, a proximity threshold, stipulating that the object must be within a certain distance from the surface to snap; the speed of movement of the virtual object, where, for example, the virtual object must be moving below a certain speed threshold to ensure controlled and intentional snapping; the direction of movement, for example, requiring that snapping only occur if the virtual object is moving toward the first surface from a specific direction, such as from above or from the side, but not from below; the orientation of the object, where the object's orientation—its pitch, roll, or yaw—at the moment of potential snapping must meet certain criteria to ensure correct alignment with the surface; surface compatibility, with certain surfaces allowing snapping based on properties like material type, texture, or pattern, enabling, for example, a “wooden” surface to have an object snapped to it but not enabling a “glass” surface; object-surface specificity, where some objects may be designed to snap only to specific surfaces and vice versa, according to predefined compatibility rules or user-defined settings; a criterion that during a real-time communication session where the virtual object is shared, snapping may be disabled to avoid disrupting collaborative interactions; environmental context, indicating that the virtual environment itself, including aspects such as lighting conditions or the presence of other virtual objects, may determine whether or how an object snaps; user preferences, allowing users to set preferences that modify or override default snapping criteria; interactive gestures, where certain user gestures or commands might enable or disable snapping; and physical world constraints in augmented reality applications, where virtual objects may snap to surfaces in a manner reflecting physical constraints like gravity or surface area, even if those surfaces are virtual representations of physical surfaces.

In some embodiments, the one or more snapping criteria include a criterion for determining whether the virtual object is snapped to one surface over another, based on characteristics or conditions at the time of interaction. Some examples of the criterion for determining which surface among a plurality of surfaces the virtual object is snapped to include, but are not limited to, the proximity of the virtual object to each surface of the plurality of surfaces, where the virtual object may snap to the nearest surface; the surface orientation relative to the object's trajectory, favoring surfaces that align more with the movement of the virtual object; or the surface's designated priority level, with higher priority surfaces overriding lower priority surfaces for snapping decisions, regardless or in combination with other factors.

In some embodiments, moving the virtual object to the third location refers to the automatic repositioning of the virtual object by the system, from the second location after user manipulation, from the first location, or from another location within the three-dimensional environment, as a result of the system determining that the one or more snapping criteria are satisfied. In some embodiments, moving the virtual object to the third location does not occur as a result of an input different from the first input. In some embodiments, the movement of the virtual object to the third location occurs as a result of the system determining that a user interaction with the virtual object has concluded. In some embodiments, the system refrains from moving the virtual object to the third location until it detects the user interaction with the virtual object has concluded. For example, the user interaction may be an air pinch and drag gesture, and the system may refrain from moving the virtual object to the third location until the air pinch is released. In some embodiments, the system moves the virtual object to the third location while the user interaction is still taking place. For example, the user interaction with the virtual object may be an air pinch and drag gesture, and the system may move the virtual object to the third location when it determines that the one or more snapping criteria are satisfied while the user maintains the air pinch gesture.

In some embodiments, snapping the virtual object to the first surface refers to the process by which the system automatically aligns and/or secures the virtual object to a position and/or orientation relative to the first surface once it has been moved to the third location. In some embodiments, snapping the virtual object to the first surface mimics a physical interaction, such as placing an object on a table or attaching an object to a wall. In some embodiments, snapping occurs while the first input is ongoing (e.g., the user maintains an air pinch) or in response to the computer system detecting termination of the first input (e.g., the user releases the air pinch).

In some embodiments, in response to detecting the first input (804), in accordance with a determination that the one or more snapping criteria are not satisfied while the virtual object is the second distance from the first surface, the computer system moves (808) the virtual object to the second location without moving the virtual object closer to the first surface (e.g., forgoing magnetically attracting or snapping the virtual object to the first surface), such as forgoing the movement of virtual object 710 as shown in two-dimensional view 742c of FIG. 7I.

In some embodiments, moving the virtual object to the second location and forgoing snapping the virtual object to the first surface refers to the system actively and/or automatically repositioning the virtual object to the second location based on the first input, without engaging the snapping process described herein. In some embodiments, forgoing snapping the virtual object to the first surface occurs as a result of the system determining that snapping criteria (e.g., the one or more snapping criteria) are not satisfied. In some embodiments, forgoing snapping the virtual object to the first surface refers to the virtual object remaining independent of the first surface, without adhering to and/or aligning with the first surface as described above. By snapping virtual objects to a surface based on snapping criteria, the computer system reduces the computational complexity and volume of data it must process for spatial analysis, directly leading to optimized memory usage and enhanced real-time processing speeds. This automation facilitates dynamic resource allocation, allowing the system to prioritize processing power for critical tasks, thereby reducing latency and increasing the scalability of three-dimensional environments. Moreover, the disclosed method minimizes power consumption and improves data management by reducing the need for repetitive user inputs and adjustments (e.g., due to incorrect or undesirable snapping of objects to surfaces), thereby conserving resources and enhancing the system's overall efficiency in managing complex three-dimensional environments.

In some embodiments, the first surface corresponds to a detected physical surface in a physical environment that corresponds to the three-dimensional environment, such as surface 722 of table 720, as shown in FIG. 7A. In some embodiments, examples of the detected physical surface include but are not limited to a surface of a table, a floor, a wall, a ceiling, and/or the surface of an object in the physical environment of the user. In some embodiments, the computer system detects the physical surface using image data generated by the one or more outward facing cameras communicatively coupled to the computer system. In some embodiments, the physical environment corresponds to the three-dimensional environment because at least one or more portions (or, optionally, representations of portions) of the physical environment are visible via the one or more display generation components in the three-dimensional environment. By snapping virtual objects to a surface that corresponds to a detected physical surface, the computer system reduces the computational complexity and volume of data it must process for spatial analysis, directly leading to optimized memory usage and enhanced real-time processing speeds. This automation facilitates dynamic resource allocation, allowing the system to prioritize processing power for critical tasks, thereby reducing latency and increasing the scalability of three-dimensional environments. Moreover, the disclosed method minimizes power consumption and improves data management by reducing the need for repetitive user inputs and adjustments (e.g., due to incorrect or undesirable snapping of objects to surfaces), thereby conserving resources and enhancing the system's overall efficiency in managing complex three-dimensional environments.

In some embodiments, the one or more snapping criteria include a criterion that is satisfied when a speed of the virtual object at the second location within the three-dimensional environment is below a threshold speed, such as the speed of virtual object 710, as shown in FIG. 7J. In some embodiments, the speed of the virtual object refers to the rate at which the object moves within the three-dimensional environment. In some embodiments, the speed of the virtual object is measured as the distance the object travels within the three-dimensional environment over a unit of time. In some embodiments, the speed of the virtual object at the second location refers to the rate of movement of the object specifically measured at the particular point within the three-dimensional environment corresponding to the second location. In some embodiments, the threshold speed refers to a predefined limit set within the system that specifies a maximum speed (e.g., 0.1 m/s, 0.2 m/s, 0.5 m/s, 1 m/s, 2 m/s, 5 m/s, or 10 m/s) at which the virtual object can be moving in order for a snapping action to occur. In some embodiments, when the speed of the virtual object at the second location within the three-dimensional environment exceeds the threshold speed, the system does not snap the virtual object to the first surface. The implementation of a speed threshold as a criterion for enabling the snapping of the virtual object to the first surface ensures that the object is deliberately snapped, thereby significantly reducing the likelihood of user errors associated with accidental snapping and subsequent corrections and/or repeated user inputs, thus conserving power and/or computational resources.

In some embodiments, the one or more snapping criteria include a criterion that is satisfied (e.g., and, when satisfied, causes or permits the one or more snapping criteria to be satisfied) when moving the virtual object from the first location to the second location includes moving the virtual object toward the first surface from a first direction, such as a direction of movement of virtual object (e.g., downwards within three-dimensional environment 700), as shown in FIGS. 7B-7G. In some embodiments, the one or more snapping criteria include a criterion that is not satisfied (e.g., and, when not satisfied, causes or permits the one or more snapping criteria to be not satisfied) when moving the virtual object from the first location to the second location includes moving the virtual object toward the first surface from a second direction, different from the first direction, such as a direction of movement of virtual object 710 (e.g., upwards within three-dimensional environment 700), as shown in FIGS. 7K and 7L. In some embodiments, the direction refers to a path or trajectory along which the virtual object moves within the three-dimensional environment.

In some embodiments, the direction is defined relative to specific reference points, such as one or more locations within the three-dimensional environment, the location of the virtual object, and/or the intended destination of the virtual object. In some embodiments, the direction is represented using vectors, coordinates, or relative spatial terms such as “upward,” “downward,” “left,” “right,” “forward,” and “backward.” In some embodiments, the first direction refers to a trajectory or path designated within the three-dimensional environment along which the virtual object moves toward the first surface that meets certain conditions for snapping. For example, the first direction may be aligned with how objects naturally interact with surfaces in a real-life scenario, such as placing a laptop on a table by moving the laptop in a downwards direction towards the top surface of the table. In some embodiments, the first direction is defined by one or more characteristics of the first surface (e.g., orientation of the surface, type of surface, distance to the surface, specific features or markers on the surface, physical properties of the surface).

In some embodiments, moving the virtual object to the second location in the first direction results in the system snapping the virtual object to the first surface and moving the virtual object to the third location (e.g., as described in greater detail herein). In some embodiments, the second direction refers to a trajectory or path along which the virtual object moves toward the first surface that is distinct (e.g., different) from the first direction and does not meet the conditions for snapping. For example, the second direction may be a direction via which an object would not naturally interact with surfaces in a real-life scenario, such as attempting to place a laptop on a table by moving the laptop in an upwards direction from below the surface of the table. In some embodiments, moving the virtual object to the second location in the second direction results in the system forgoing snapping the virtual object to the first surface and moving the virtual object to the second location, as described in greater detail herein. By incorporating a direction-based criterion for snapping, where the virtual object only snaps to the first surface when moving towards it from a specific direction and not from another, the system ensures accurate and contextually appropriate object placement, thereby preventing erroneous snapping, which results in optimized computational efficiency by focusing resources only on valid interaction scenarios.

In some embodiments, the first direction corresponds to moving the virtual object toward the first surface from above the first surface, such as the direction of movement of virtual object 710, as shown in FIGS. 7B-7G. In some embodiments, the second direction corresponds to moving the virtual object toward the first surface from below the first surface, such as the direction of movement of virtual object 710, as shown in FIGS. 7K and 7L.

In some embodiments, a virtual object being above the first surface refers to a positional relationship where the virtual object is located at a higher elevation relative to the plane or contour of the first surface within the three-dimensional environment. In some embodiments, the first surface has one or more sides, with one side corresponding to a top or front side and a different side corresponding to a bottom or back side. In some embodiments, moving the virtual object toward the first surface from above the first surface implies that the virtual object is descending towards the first surface, specifically towards the top side of the first surface. In some embodiments, a virtual object being below the first surface refers to a positional relationship where the virtual object is located at a lower elevation relative to the plane or contour of the first surface within the three-dimensional environment. In some embodiments, moving the virtual object toward the first surface from below the first surface implies that the virtual object is ascending towards the first surface, specifically towards the bottom side of the first surface. The specification of snapping directions, where the virtual object snaps to the surface only when approaching from above and not from below, ensures that interactions mimic real-world physics and intuitive user expectations, reducing user error and limiting snapping calculations to scenarios where they are physically plausible, thereby enhancing the system's performance and user experience.

In some embodiments, in accordance with a determination that the virtual object has a first movement characteristic, the threshold distance from the first surface, that is used to determine how the virtual object moves in response to detecting the first input, is a first threshold distance from the first surface, such as the threshold distance from first surface 722 (e.g., the height of snapping zone 754a) being equal to D1 when virtual object 710 is moving with speed 708a, as shown in two-dimensional view 744a of FIG. 7J.

In some embodiments, in accordance with a determination that the virtual object has a second movement characteristic, different from the first movement characteristic, the threshold distance from the first surface, that is used to determine how the virtual object moves in response to detecting the first input, is a second threshold distance from the first surface, different from the first threshold distance, such as the threshold distance from first surface 722 (e.g., the height of snapping zone 754b) being equal to D2 when virtual object 710 is moving with speed 708b, as shown in two-dimensional view 744b of FIG. 7J. In some embodiments, a movement characteristic refers to a specific attribute or behavior related to the motion of the virtual object within the three-dimensional environment. Some examples of movement characteristics include, but are not limited to, position, orientation, speed, acceleration, trajectory, pattern of movement (e.g., linear, circular, and/or erratic), and/or direction. In some embodiments, the movement characteristics are used by the computer system to evaluate how the virtual object interacts with elements in the three-dimensional environment (e.g., in determining the threshold distance from the first surface for snapping). In some embodiments, the first movement characteristic refers to a particular attribute of the motion of the virtual object (e.g., speed, approach angle, and/or orientation) that causes the system to set the threshold distance from the first surface as the first threshold distance. For example, the first movement characteristic may be a first speed of the virtual object which causes the first threshold distance to be set based on the first speed, as described in greater detail below. In some embodiments, the second movement characteristic refers to a particular attribute of the motion of the virtual object, different from the first movement characteristic, that causes the system to set the threshold distance from the first surface as the second threshold distance, different from the first threshold distance.

In some embodiments, the second threshold distance is a retraction percentage of the first threshold distance (e.g., 5%, 10%, 25%, 40%, 60%, 80%, or 95%) based on the second movement characteristic. In some embodiments, the second threshold distance is the difference between the first threshold distance and a retraction value based on the second movement characteristic (e.g., 0.1 cm, 0.5 cm, 2 cm, 10 cm, 25 cm, or 45 cm). For example, when the threshold distance is 50 cm away from the first surface, the second threshold distance may be 25 cm if the retraction percentage is 50% or the retraction value is 25 cm. By dynamically adjusting the threshold distance for snapping based on the virtual object's movement characteristics, the system ensures precise and context-sensitive placement, reducing the likelihood of improper snapping and enhancing computational efficiency by tailoring the snapping logic to the object's current dynamics, thereby optimizing resource utilization and ensuring smoother interactions within the three-dimensional environment.

In some embodiments, the first movement characteristic corresponds to a first speed of the virtual object, such as speed 708a of virtual object 710, as shown in two-dimensional view 744a of FIG. 7J. In some embodiments, the second movement characteristic corresponds to a second speed of the virtual object, and the second speed is different from the first speed, such as speed 708a of virtual object 710, as shown in two-dimensional view 744b of FIG. 7J. In some embodiments, the first speed and the second speed represent distinct rates of movement of the virtual object within the three-dimensional environment (e.g., 0.01 m/s, 0.05 m/s, 0.1 m/s, 0.3 m/s, 0.5 m/s, 1 m/s, 2 m/s, or 5 m/s). In some embodiments, the threshold distance from the first surface is influenced by the speed at which the virtual object is moving within the three-dimensional environment. In some embodiments, the computer system dynamically adjusts the threshold distance based on the speed of the virtual object. In some embodiments, when the virtual object moves at the first speed, which is relatively slower than the second speed, the system sets the threshold distance as the first threshold distance, which is a larger distance from the first surface than the second threshold. In some embodiments, when the virtual object moves at the second speed, which is relatively faster than the first speed, the system sets the threshold distance as the second threshold distance, which is a smaller distance from the first surface than the first threshold. In some embodiments, the adjustment of the threshold distance from the first surface based on the speed of the virtual object also depends on a type of the virtual object. For example, the threshold distance from the first surface at either the first speed or the second speed may be different depending on whether the virtual object is a window or a three-dimensional volume. Adjusting the snapping threshold distance based on the speed of the virtual object ensures that faster-moving objects have a reduced likelihood of snapping, enhancing realism and preventing unintended interactions, conserving computational resources by focusing processing power on snapping calculations only when virtual object speeds are conducive to stable snapping, thereby improving system efficiency and responsiveness.

In some embodiments, the first movement characteristic corresponds to a first height of the virtual object from the first surface, such as the height of virtual object 710 as shown in two-dimensional view 746e of FIG. 7L. In some embodiments, the second movement characteristic corresponds to a second height of the virtual object from the first surface, and the second height is different from the first height, such as the height of virtual object 710, as shown in two-dimensional view 746f of FIG. 7L. In some embodiments, height refers to the vertical distance between a reference point on the virtual object and the first surface within the three-dimensional environment. In some embodiments, the height of the virtual object from the first surface is measured from various parts of the virtual object, such as the bottom of the virtual object, the lowest point of the virtual object, a baseplate of the virtual object, the top of the virtual object, a highest point of the virtual object, a center point of the virtual object, and/or any other specific point on the virtual object that aligns with the functionality or design aspects of the virtual object or an application. In some embodiments, the first height refers to a specific vertical distance from the first surface to a reference point on the virtual object, and the second height refers to a different vertical distance from the first surface to the reference point on the virtual object.

In some embodiments, the threshold distance from the first surface is dynamically adjusted based on the height of the virtual object from the first surface. In some embodiments, the threshold distance mirrors the height of the virtual object from the first surface as the virtual object moves within the three-dimensional environment. In some embodiments, when the virtual object is initially positioned beneath the first surface and begins to ascend past the first surface, the threshold distance is configured to increase correspondingly with the height of the bottom of the virtual object up to a certain limit. In some embodiments, increasing the threshold distance correspondingly with the height of the virtual object prevents the virtual object from snapping to the first surface when moving upward from an initial position below the first surface but allows for snapping when the direction of the movement of the virtual object changes and begins descending, crossing back through the threshold distance that has been dynamically adjusted based on the height of the virtual object from the first surface.

In some embodiments, when the virtual object first passes through the first surface when moving in an upward direction from a position below the first surface, the threshold distance from the first surface is configured to be set to zero until the reference point at which the height of the virtual object is measured crosses through the first surface. In some embodiments, once the reference point at which the height of the virtual object crosses through the first surface, the threshold distance is dynamically adjusted to correspond to the height of the reference point from the first surface. In some embodiments, once the reference point reaches a maximum threshold distance above the first surface, the threshold distance ceases to correspond to the height of the reference point as the reference point continues to move within the three-dimensional environment and the threshold distance is maintained at the maximum threshold distance above the first surface. In some embodiments, the maximum threshold distance is equal to a default or predetermined distance from the first surface (e.g., 1 cm, 2 cm, 5 cm, 10 cm, 20 cm, 50 cm, 1 m, 2 m, or 5 m). Adjusting the snapping threshold to match the height of the virtual object when it is brought from beneath the first surface ensures precise interaction control, allowing the object to snap only when dipping down below the threshold distance, thus minimizing incorrect snapping and conserving computational resources as a result.

In some embodiments, in response to detecting the first input, the computer system moves the virtual object from the second location to a fourth location in accordance with a first part of the first input and in accordance with a virtual attractive force having a first strength while the virtual object is at the fourth location, wherein the fourth location is closer to the first surface than the second location, such as the movement of virtual object 710 in accordance with virtual attractive force 706e, as shown in FIG. 7C. For example, the distance between the second location and the fourth location, defining a first respective distance, is determined by the sum of the distance directed by the first part of the first input and a first additional distance that results from the influence of the virtual attractive force having the first strength acting upon the first input.

In some embodiments, in response to detecting the first input, the first computer system moves the virtual object from the fourth location to a fifth location in accordance with a second part of the first input, after the first part of the first input, and in accordance with the virtual attractive force, wherein the virtual attractive force has a second strength, greater than the first strength while the virtual object is at the fifth location and the fifth location is closer to the first surface than the fourth location, such as the movement of virtual object 710 in accordance with virtual attractive force 706e, as shown in FIG. 7D. For example, the distance between the fourth location and the fifth location, defining a second respective distance, is determined by the sum of the distance directed by the second part of the first input and a second additional distance that results from the influence of the virtual attractive force having the second strength acting upon the first input, where the virtual attractive force augments the second part's input distance by a larger factor (e.g., associated with the second strength) compared to the factor used for the first part's input distance (e.g., associated with the first strength).

In some embodiments, the virtual attractive force refers to a simulated force within the three-dimensional environment that influences one or more movement characteristics of the virtual object. In some embodiments, the virtual attractive force mimics the behavior of physical forces, such as gravity or magnetism, applied to the virtual object to guide its motion toward a targeted area or surface. In some embodiments, the virtual attractive force varies in intensity based on the distance of the virtual object from the first surface. In some embodiments, as the virtual object moves closer to the first surface, the virtual attractive force increases (e.g., the virtual object moves toward the surface with a steadily increasing velocity as it gets closer to the surface). In some embodiments, the virtual attractive force pulls the virtual object towards the first surface along a specific path. In some embodiments, the strength and nature of the virtual attractive force is based on one or more properties of the virtual object. For example, virtual objects whose real-world counterparts may be heavier or larger may experience stronger virtual attractive forces, or certain types of virtual objects (e.g., or virtual object whose real-world counterparts are made from specific materials) may be deemed more magnetic and be more susceptible to higher virtual attractive forces.

In some embodiments, the application of the virtual attractive force is conditional on one or more factors, such as proximity to the first surface (e.g., the virtual attractive force is not applied to the virtual object until it crosses a threshold, such as the threshold distance from the first surface), an orientation of the virtual object (e.g., when the virtual object does not have the same orientation or a compatible orientation with the first surface, such as when a bottom surface of the virtual object is not parallel with the first surface, the virtual attractive force may not be applied to the virtual object or may be applied in a reduced capacity based on the differences in the orientations of the virtual object and the first surface), and/or the user interaction with the virtual object (e.g., the virtual attractive force is applied to the virtual object while the user interacts with the virtual object or only after the user completes the user interaction, such as by releasing a hand gesture associated with moving the virtual object). In some embodiments, the virtual attractive force is applied to the virtual object while the user interaction with the virtual object is ongoing (e.g., the user has not released a hand gesture associated with moving the virtual object) and influences one or more movement characteristics of the virtual object.

In some embodiments, the fourth location refers to a specific point within the three-dimensional environment that the virtual object moves to after the system detects the first input that is closer to the first surface than the second location, indicating a progression toward the first surface as part of the trajectory of the virtual object influenced by snapping mechanisms. In some embodiments, the first part of the first input refers to a component of a multi-part user command (e.g., the first input) that directs the movement of the virtual object from the second location to the fourth location within the three-dimensional environment. In some embodiments, the second part of the first input refers to a component of a multi-part user command (e.g., the first input) that directs the movement of the virtual object from the fourth location to the fifth location within the three-dimensional environment. In some embodiments, the first strength of the virtual attractive force refers to the simulated force having a first magnitude that the computer system applies to the virtual object when the virtual object is located at the fourth location within the three-dimensional environment. In some embodiments, the system dynamically adjusts the virtual attractive force (e.g., and/or the acceleration) based on the continuously changing distance of the virtual object from the first surface.

In some embodiments, the fifth location refers to a specific point within the three-dimensional environment that the virtual object moves to after reaching the fourth location that is closer to the first surface than the second location and the fourth location, indicating a progression toward the first surface as part of the trajectory of the virtual object influenced by snapping mechanisms. In some embodiments, the second strength of the virtual attractive force refers to the simulated force having a second magnitude that the computer system applies to the virtual object when the virtual object is located at the fifth location within the three-dimensional environment. In some embodiments, the second strength of the virtual attractive force is greater than the first strength of the virtual attractive force (e.g., causing the computer system to move the virtual object by a larger respective distance as it moves from the fourth location to the fifth location than the respective distance the virtual object experienced as it moved from the second location to the fourth location).

In some embodiments, a first respective distance refers to the distance the virtual object travels from the second location to the fourth location under the influence of the first part of the first input and a respective strength (e.g., the first strength) of the virtual attractive force. In some embodiments, a second respective distance refers to the distance the virtual object travels from the fourth location to the fifth location under the influence of the second part of the first input and a respective strength (e.g., the second strength) of the virtual attractive force. In some embodiments, the first respective distance and the second respective distance include both the user-intended movement (e.g., the first part and the second part of the first input, respectively) and an additional displacement caused by the virtual attractive force. For example, when the user intends to move the virtual object towards the first surface by an x amount, when the object is at the second location, the virtual object moves by an x+y amount, and when the object is at the fourth location, the virtual object moves by an x+z amount, where y<z. Implementing a controlled increase in the speed of the virtual object through virtual attractive forces as the object moves closer to the first surface optimizes the object's trajectory and snapping precision, not only enhancing the fluidity and realism of movement but also efficiently using computational resources by dynamically adjusting the object's momentum and/or direction, thus ensuring the object is snapped to the right location and avoiding unnecessary recalculations.

In some embodiments, in response to detecting the first input, the first computer system moves the virtual object from the fifth location to a sixth location in accordance with a third part of the first input, after the first and second parts of the first input, and in accordance with the virtual attractive force, wherein the virtual attractive force has a third strength, less than the second strength while the virtual object is at the sixth location, the sixth location is closer to the first surface than the fifth location, and the sixth (and optionally the fifth) location is within a respective threshold distance from the first surface, such as the movement of virtual object 710 in accordance with virtual attractive force 706e in FIG. 7E and/or FIG. 7F. For example, the distance between the fifth location and the sixth location, defining a third respective distance, is determined by the sum of the distance directed by the third part of the first input and a third additional distance that results from the influence of the virtual attractive force having the second strength acting upon the first input, where the virtual attractive force augments (or, optionally, decreases) the third part's input distance by a smaller factor (e.g., associated with the third strength) compared to the factor used for the second part's input distance (e.g., associated with the second strength).

In some embodiments, the respective threshold distance refers to a specific distance from the first surface (or, optionally, the third location) within the three-dimensional environment that signifies a change in the relationship between the magnitude of the virtual attractive force exerted on the virtual object and the distance of the virtual object the first surface. In some embodiments, when the virtual object is further away from the first surface than the respective threshold distance (e.g., 0.5 cm, 1 cm, 2 cm, 5 cm, 10 cm, 20 cm, 50 cm, 1 m, or 2 m), the virtual attractive force exerted on the virtual object increases as the virtual object moves closer to the first surface. In some embodiments, when the virtual object is closer to the first surface than the respective threshold distance, the virtual attractive force exerted on the virtual object decreases as the virtual object moves closer to the first surface. In some embodiments, the respective threshold distance is based on the type of virtual object (e.g., different attractive force threshold distances for a window versus a three-dimensional volume).

In some embodiments, the virtual attractive force exerted on the virtual object is negative when the virtual object is closer to the first surface than the respective threshold distance (e.g., depending on the distance of the virtual object from the first surface) and repels the virtual object from the first surface, causing the respective distance traveled by the virtual object to be smaller than the user-intended movement as it approaches the first surface.

In some embodiments, the sixth location refers to a specific point within the three-dimensional environment that the virtual object moves to after the system detects the first input that is closer to the first surface than the second location, fourth location, and fifth location, indicating a progression toward the first surface as part of the trajectory of the virtual object influenced by snapping mechanisms. In some embodiments, the third strength of the virtual attractive force refers to the simulated force having a third magnitude that the computer system applies to the virtual object when it is located at the sixth location within the three-dimensional environment. In some embodiments, the third strength of the virtual attractive force is negative and repels the virtual object from the first surface, causing a third respective distance traveled by the virtual object to be smaller than the user-intended movement (e.g., the third part of the first input) as it approaches the first surface. For example, when the user intends to move the virtual object towards the first surface by an x amount when the object is at the sixth location, the virtual object moves by an x+y amount, where y is negative, causing the respective distance to be smaller than x. Reducing the virtual attractive force as the virtual object nears the first surface, once within a specified threshold, enhances precision by preventing overshooting and ensuring smoother final placement, which minimizes the need for corrective actions and recalculations as the object settles into the first surface.

In some embodiments, while moving the virtual object relative to the first surface, the computer system detects a second input, via the one or more input devices, corresponding to a request to rotate the virtual object about an axis parallel to the first surface (e.g., a rotational input such as rotation of a hand or input device), such as the rotation gesture performed by hand 702, as shown in at least one of FIGS. 7M, 7N, and/or 7O. In some embodiments, the second input includes attention (e.g., based on gaze, cursor, and/or hand position) directed to the virtual object (e.g., or directed to a selectable virtual element the computer system displays adjacent to the virtual object in the three-dimensional environment) accompanied by an air gesture (e.g., an air pinch). For example, the air gesture includes movement (e.g., hand movement (e.g., rotation of the hand)). For example, the computer system rotates the virtual object about the axis parallel to the first surface (e.g., when the object is not snapped to the surface) in accordance with the movement included in the air gesture (e.g., by an amount (e.g., corresponding to a distance and/or magnitude of movement of the virtual object and/or an amount of change in orientation of the virtual object relative to the three-dimensional environment) and/or in a direction that corresponds to the amount and/or direction of the movement included in the air gesture). In some embodiments, the second input includes an input on a touch-sensitive surface (e.g., a touchpad) of (e.g., and/or in communication with) the computer system and/or an audio input (e.g., a voice command detected by the one or more input devices of the computer system).

In some embodiments, in response to detecting the second input, in accordance with a determination that the virtual object is within a threshold distance of the first surface, the computer system forgoes rotation of the virtual object about the axis parallel to the first surface, such as the forgoing of rotation of virtual object 710, as shown in FIGS. 7N and 7O. In some embodiments, the threshold distance is 0.1 cm, 0.5 cm, 1 cm, 2 cm, 5 cm, 10 cm, 20 cm, 50 cm, 1 m, or 2 m from the first surface.

In some embodiments, in response to detecting the second input, in accordance with a determination that the virtual object is within a threshold distance of the first surface, the computer system moves the virtual object without rotating the virtual object about the axis parallel to the first surface. In some embodiments, in response to detecting the second input, in accordance with a determination that the virtual object is outside of the threshold distance of the first surface, the computer system moves the virtual object and/or rotates the virtual object about the axis parallel to the first surface. In some embodiments, the axis parallel to the first surface refers to an imaginary line or directional vector within the three-dimensional environment that extends along the plane of the first surface without intersecting it. In some embodiments, the axis parallel to the first surface is oriented such that any movement of the virtual object along this axis results in the virtual object traveling in a direction that maintains a constant distance from the first surface. In some embodiments, the second input corresponding to rotating the virtual object about the axis parallel to the first surface refers to a user or system command received via the one or more input devices that directs the virtual object to rotate about the axis described above. In some embodiments, the second input and/or the rotation of the virtual object about the axis parallel to the first surface is a part of the first input. In some embodiments, an amount and/or a direction of the rotation specified by the second input correspond to a hand gesture, where a specific amount and/or direction of rotation of the gesture dictate the intended rotation of the virtual object.

In some embodiments, forgoing rotation of the virtual object about the axis parallel to the first surface refers to the computer system not executing or allowing the rotation of the virtual object despite receiving an input command to do so. In some embodiments, forgoing rotation of the virtual object is a result of control logic within the system which serves to maintain the current orientation of the virtual object during critical interactions, such as the snapping process, to ensure that the virtual object aligns correctly with the first surface and/or adheres to specific orientation requirements. In some embodiments, the computer system forgoes rotating the virtual object about the axis parallel to the first surface to prevent the virtual object becoming visually partially embedded into the first surface from the viewpoint of the user. Detecting and then disregarding a user's input to rotate the virtual object about the axis parallel to the first surface during the snapping process ensures that the object's orientation remains stable and consistent, reducing the computational load by eliminating unnecessary adjustments and recalculations during critical interaction phases.

In some embodiments, the second input includes a first component that includes rotation about an axis perpendicular to a plane of the first surface and the second input includes a second component that includes rotation about the axis parallel to the plane of the first surface, such as the components of rotation illustrated by the gestures performed by hand 702, as shown in FIGS. 7M-7O.

In some embodiments, in response to detecting the second input, the computer system rotates the virtual object about the axis perpendicular to the plane of the first surface in accordance with the first component of the second input, such as the rotation of virtual object 710, as shown in FIG. 7M. In some embodiments, the computer system rotates the virtual object about the axis perpendicular to the plane of the first surface in accordance with a direction and/or magnitude of the first component of the second input. For example, the amount (e.g., degree) of rotation of the virtual object about the axis perpendicular to the plane of the first surface corresponds to a magnitude of rotation (e.g., an amount of rotation of a hand performing an air gesture) of the first component of the second input. For example, the direction rotation of the virtual object about the axis perpendicular to the plane of the first surface corresponds to a direction of rotation (e.g., a direction of rotation of a hand performing an air gesture) of the first component of the second input.

In some embodiments, in response to detecting the second input, the computer system forgoes rotation of the virtual object about the axis parallel to the plane of the first surface in accordance with the second component of the second input, such as the rotation of virtual object 710, as shown in FIGS. 7N and 7O. In some embodiments, a component refers to a distinct part or element of a larger input command detected by the system. In some embodiments, the component specifies one or more actions to be performed by the computer system with respect to the virtual object within the three-dimensional environment. In some embodiments, each component of an input corresponds to a different aspect of object manipulation, such as movement direction, speed, rotation, and any subdivision thereof. In some embodiments, the first component of the second input refers to the part of the input command that directs the rotation of the virtual object about an axis perpendicular to the plane of the first surface and the second component of the second input refers to the part of the input command that directs the rotation of the virtual object about an axis that is parallel to the plane of the first surface. In some embodiments, the axis perpendicular to the plane of the first surface allows the virtual object to rotate in a manner akin to spinning around a central pole that extends upward from the plane of the first surface. In some embodiments, the axis parallel to the plane of the first surface allows the virtual object to rotate in a manner akin to a rolling action where the object turns along an axis lying flat relative to the first surface.

In some embodiments, forgoing the rotation of the virtual object about the axis parallel to the plane of the first surface in accordance with the second component of the second input involves the system actively preventing or not executing the rotation that would otherwise occur around the axis lying flat relative to the first surface. In some embodiments, the rotation of the virtual object about the axis parallel to the plane of the first surface is prevented to prevent one or more portions of the virtual object from intersecting the first surface as a result of this rotation. In some embodiments, the rotation of the virtual object about the axis perpendicular to the plane of the first surface in accordance with the first component of the second input is executed (e.g., or allowed) since no portions of the virtual object would intersect the first surface as a result of this rotation. In some embodiments, the resulting rotation of the virtual object (e.g., the rotation about the axis perpendicular to the plane of the first surface) has a magnitude and/or direction that corresponds to a magnitude and/or direction imparted by the hand gesture of the user. Allowing rotation of the virtual object about the axis perpendicular to the first surface while ignoring rotation inputs about the axis parallel to the first surface enhances interaction precision by maintaining the virtual object's alignment relative to the first surface, ensuring only relevant rotational movements are executing, thereby improving system efficiency by preventing unnecessary processing of conflicting or undesirable rotational actions.

In some embodiments, before detecting the first input, the computer system displays an orientation indication with the virtual object, wherein the orientation indication indicates a side of the virtual object that is available to snap to a surface, such as baseplate 712, as shown in FIGS. 7B-7F. In some embodiments, the surface has one or more characteristics of the first surface described above. In some embodiments, the orientation indication is displayed adjacent to (e.g., on, aligned, and/or parallel to) the side of the virtual object that is available to snap to the surface. In some embodiments, the orientation indication is displayed at position (e.g., location and/or orientation) in the three-dimensional environment corresponding to a respective position (e.g., location and/or orientation) of the side of the virtual object that is available to snap to the first surface in the three-dimensional environment.

In some embodiments, the virtual object includes a plurality of sides, and a portion of the plurality of sides are available to snap to the surface. For example, a first portion of the plurality of sides is available to snap to the surface, and a second portion, different from the first portion, of the plurality of sides is available to snap to the surface. In some embodiments, the virtual object includes a plurality of sides, and only a first side of the plurality of sides is available to snap to the surface (e.g., the virtual object corresponds to a representation of an electronic device, such as a laptop, and the orientation indication indicates that the bottom surface (e.g., and not a side and/or top surface) of the representation of the electronic device is available to snap to the surface). In some embodiments, the virtual object includes a plurality of sides, and multiple sides of the plurality of sides are available to snap to the surface (e.g., the virtual object includes a plurality of at least partially flat surfaces (e.g., a cube)).

In some embodiments, in response to detecting the first input, in accordance with the determination that the one or more snapping criteria are satisfied, the computer system ceases to display the orientation indication, such as computer system 101 ceasing to display baseplate 712, as shown in FIG. 7G. In some embodiments, in accordance with the determination that the one or more snapping criteria are not satisfied, the computer system continues displaying the orientation indication, such as computer system 101 continuing to display 712 in FIG. 7G if virtual object 710 was not snapped to first surface 722.

In some embodiments, the orientation indication of the virtual object refers to a visual or structural element that forms the bottom-most part of the virtual object within the three-dimensional environment. In some embodiments, the orientation indication is designed to serve as a stabilizing or grounding feature that helps to visually integrate the virtual object into its surroundings by providing an interface between the virtual object and a surface. In some embodiments, the height of the virtual object from the first surface is calculated as the height of the orientation indication from the first surface.

In some embodiments, ceasing to display the orientation indication of the virtual object while the virtual object is snapped to the first surface refers to the intentional omission or hiding of the orientation indication in visual representations when the virtual object is snapped to the first surface. In some embodiments, hiding the orientation indication while the virtual object is snapped to the first surface prevents visual distortions (e.g., when the virtual object is placed on a transparent or glass surface, hiding the baseplate maintains the clarity and integrity of the surface's appearance). In some embodiments, an appearance of the orientation indication is changed while the virtual object is snapped to the first surface based on the first surface itself (e.g., a texture of the orientation indication may be altered to match the texture of a first surface, such as wood or metal). For example, when the virtual object is a virtual laptop snapped to a table (e.g., the first surface) in the three-dimensional environment, an orientation indication of the virtual laptop-designed as a stabilizing feature that visually integrates the laptop with the table during the snapping process—is not displayed, enhancing the realistic appearance by avoiding visual inconsistency. Not displaying the orientation indication of the virtual object while it is snapped to the first surface streamlines the visual presentation and prevents clutter, further enhancing the realism of the virtual environment while reducing the graphical processing load, allowing for more efficient use of computational resources.

In some embodiments, the first surface is a horizontal surface, such as first surface 722 shown in FIGS. 7B-7G. In some embodiments, the horizontal surface refers to a plane within the three-dimensional environment that is parallel or substantially parallel (e.g., 0.1°, 0.5°, 1°, 2°, 5°, or 10° away) to a ground plane (e.g., a physical ground plane of the physical environment or a virtual ground plane in the three-dimensional environment) as defined by the three-dimensional environment. In some embodiments, the horizontal surface refers to a plane within the three-dimensional environment that is perpendicular or substantially perpendicular (e.g., 0.1°, 0.5°, 1°, 2°, 5°, or 10° away) to gravity (e.g., a physical gravity of the physical environment or a virtual gravity of the three-dimensional environment). Some examples of horizontal surface include, but are not limited to, floors, tabletops, countertops, roads or other pathways, platforms, stages, or any other flat area where an object may be placed or moved across in a manner that aligns with gravitational expectations (e.g., not floating or falling without support). Specifying that the snapping action may occur when the first surface is horizontal ensures that the virtual object interacts in a way consistent with real-world gravitational expectations, enhancing the intuitive understanding and realism of the three-dimensional environment, thus minimizing user errors and conserving computational resources and power.

In some embodiments, the first surface is a vertical surface, such as second surface 732 shown in FIG. 7I. In some embodiments, the vertical surface refers to a plane within the three-dimensional environment that is perpendicular or substantially perpendicular (e.g., 0.1°, 0.5°, 1°, 2°, 5°, or 10° away) to a ground plane (e.g., a physical ground plane of the physical environment or a virtual ground plane in the three-dimensional environment) as defined by the three-dimensional environment. In some embodiments, the vertical surface refers to a plane within the three-dimensional environment that is parallel or substantially parallel (e.g., 0.1°, 0.5°, 1°, 2°, 5°, or 10° away) to gravity (e.g., a physical gravity of the physical environment or a virtual gravity of the three-dimensional environment) Some examples of vertical surfaces include, but are not limited to, walls, doors, boards (e.g., whiteboards, bulletin boards, chalkboards, and/or billboards), curtains or partitions, bookcases or shelving units, display panels, screens, or any other upright structure where an object may be placed against or interacted with in a manner that aligns vertically. Specifying that the snapping action may occur when the first surface is vertical allows the virtual object to adhere to walls or similar structures, providing the user with additional streamlined functionality in placing the virtual object within the three-dimensional environment, thus reducing the need for multiple user inputs to achieve a similar effect to snapping the virtual object to the vertical surface, conserving computational resources and/or power.

In some embodiments, the first input includes a first movement component corresponding to movement along a first directional axis in the three-dimensional environment, and a second movement component corresponding to movement along a second directional axis in the three-dimensional environment, different from the first directional axis in the three-dimensional environment, such as movement components 764a and 764b shown in FIGS. 7Q-7S.

In some embodiments, in response to detecting the first input corresponding to moving the virtual object to the second location within the three-dimensional environment from the first location, in accordance with a determination that one or more first criteria are satisfied, the computer system moves the virtual object along the first directional axis in accordance with the first movement component and suppressing at least a portion of (or, optionally suppressing all of) movement of the virtual object along the second directional axis relative to the second movement component, such as the movement of virtual object 710, as shown in FIGS. 7R and 7S. In some embodiments, in response to detecting the first input corresponding to moving the virtual object to the second location within the three-dimensional environment from the first location, and in accordance with a determination that one or more second criteria are satisfied, the computer system moves the virtual object along the second directional axis in accordance with the second movement component and suppressing at least a portion of (e.g., or, optionally suppressing all of) movement of the virtual object along the first directional axis relative to the first movement component, such as if movement component 764b was larger than movement component 764a in FIG. 7R or 7S, causing computer system 101 to move virtual object 710 primarily in the directional axis associated with movement component 764b.

In some embodiments, a movement component refers to a specific part of a larger movement command that dictates how a virtual object is to be manipulated along a particular directional axis within the three-dimensional environment. In some embodiments, each movement component is associated with a distinct directional axis and represents a magnitude of distance along the associated directional axis. In some embodiments, a directional axis refers to a specific line or vector within the three-dimensional environment that defines the direction along which movement may occur. In some embodiments, directional axes are aligned with the primary coordinate system used in the three-dimensional environment. In some embodiments, directional axes are based on the spatial relationship between the first location and the third location (e.g., or, optionally, the first surface). In some embodiments, the first directional axis and the second directional axis are perpendicular to each other. In some embodiments, the first input includes a third movement component in a third directional axis. In some embodiments, the third directional axis refers to a specific axis within the three-dimensional environment within the three-dimensional environment that is perpendicular to the first directional axis and the second directional axis.

In some embodiments, the first and second one or more axis locking criteria refer to sets of conditions or rules that determine whether the movement of the virtual object should be restricted to a specific directional axis and/or suppressing movement in one or more directional axes different from the specific directional axis. Some examples of axis locking criteria include, but are not limited to, the magnitude of the first movement component being larger or smaller than the second movement component, the first directional axis or the second directional axis being in a direction similar or equal to a direction from the first location to the third location, user preferences, proximity to one or more thresholds discussed herein (e.g., snapping threshold), collision avoidance (e.g., suppressing movement in a direction which will lead to a collision with another object), task-specific rules (e.g., restricting movement based on a required level of precision for a task), surface orientation matching, speed of movement, and/or historical user behavior. In some embodiments, the first one or more axis locking criteria are different from the second one or more axis locking criteria. For example, the first one or more axis locking criteria may be satisfied when a magnitude of the first movement component is larger than a magnitude of the second movement component, and the second one or more axis locking criteria may be satisfied when the magnitude of the second movement component is larger than the magnitude of the first movement component.

In some embodiments, suppressing movement of the virtual object along the second directional axis relative to the second movement component refers to reducing, fully or at least partially limiting the movement of the virtual object in a direction that is secondary to the primary movement direction. In some embodiments, the type of suppression (e.g., full or partial limiting) and/or the magnitude of the suppression is determined based on one or more criteria of the one or more axis locking criteria. In some embodiments, the resulting movement along the second directional axis is a fraction or percentage of the magnitude of the second movement component (e.g., 0%, 5%, 10%, 15%, 25%, 50%, 75%, or 99%). In some embodiments, suppressing movement of the virtual object along the first directional axis relative to the first movement component has one or more characteristics of suppressing movement of the virtual object along the second directional axis relative to the second movement component.

In some embodiments, satisfying the one or more axis locking criteria enables an axis locking mode, which refers to a feature applied by the system that restricts movement of the virtual object to a single axis or a predefined set of axes. In some embodiments, the axis locking mode allows decreased movement off the primary axis, as described in greater detail below. In some embodiments, the axis locking mode redirects the movement off the primary axis into movement on the primary axis, as described in greater detail below. In some embodiments, while the axis locking mode is active, the system is capable of dynamically toggling among eliminating, decreasing, or redirecting movement in the second directional axis based on one or more factors. Some examples of these factors include, but are not limited to, distance of the virtual object to the third location (e.g., or, optionally, the first surface), distance of the first location or the second location to the third location (e.g., or, optionally, the first surface), user preferences and/or input, a task or application active within the three-dimensional environment, and one or more properties of the virtual object (e.g., type, size, shape, or intended function). In some embodiments, axis locking mode is activated when the virtual object is within an axis locking threshold distance from the first surface (e.g., 0.5 m, 1 m, 2 m, 3 m, or 5 m). In some embodiments, the axis locking threshold distance is further from the first surface than the snapping threshold distance. In some embodiments, while axis locking mode is active, the display generation component displays one or more visual indicators to the user, such as highlighting the locked axis or displaying a graphical overlay on the object or along the locked axis. Locking movement to a specific directional axis ensures precise control over the trajectory of the virtual object, not only simplifying user input by focusing movement along a primary path (e.g., thus conserving computational resources) but also enhancing the predictability and accuracy of the object's placement within the three-dimensional environment, thus reducing the amount of calculations made by the system.

In some embodiments, the first one or more criteria include a criterion that is satisfied (e.g., and, when satisfied, causes or permits the first one or more to be satisfied) when the first movement component of the first input is larger than the second movement component of the first input, such as a criterion that is satisfied and causes movement of virtual object 710 in a manner similar to as shown in FIG. 7R and/or 7S (e.g., because movement component 764a is larger than movement component 764b).

In some embodiments, the second one or more criteria include a criterion that is satisfied (e.g., and, when satisfied, causes or permits the second one or more criteria to be satisfied) when the second movement component of the first input is larger than the first movement component of the first input, such as a criterion that would be satisfied and would cause movement of virtual object 710 in primarily in the directional axis corresponding to movement component 764b FIGS. 7R and/or 7S when movement component 764b was larger than movement component 764a.

In some embodiments, the first movement component of the first input being larger than the second movement component of the first input refers to a scenario in which the magnitude, extent, and/or intensity of the movement directed along the first directional axis surpasses that directed along the second directional axis. In some embodiments, the first movement component of the first input being larger than the second movement component of the first input indicates that the primary axis of movement is the first directional axis and should be prioritized in the navigation of the virtual object. In some embodiments, the second movement component of the first input being larger than the first movement component of the first input refers to a scenario in which the magnitude, extent, and/or intensity of the movement directed along the second directional axis surpasses that directed along the first directional axis. In some embodiments, the second movement component of the first input being larger than the first movement component of the first input indicates that the primary axis of movement is the second directional axis and should be prioritized in the navigation of the virtual object. Incorporating controlled movement along the locked first directional axis, while also allowing a moderated portion of movement along the second directional axis, enhances the precision and flexibility of positioning the virtual object, reducing the likelihood of placement errors and unnecessary adjustments, thereby improving the efficiency of the system's computational resources.

In some embodiments, in response to detecting the first input corresponding to moving the virtual object to the second location within the three-dimensional environment from the first location, and in accordance with the determination that the one or more first criteria are satisfied, the computer system moving the virtual object along the first directional axis includes moving the virtual object along the first directional axis with a magnitude that is increased based on a magnitude of the second movement component of the first input along the second directional axis, such as moving virtual object 710 in accordance with movement component 764a and at least a portion of movement component 764b along the perpendicular directional axis, as shown in FIGS. 7S and/or 7U.

In some embodiments, in response to detecting the first input corresponding to moving the virtual object to the second location within the three-dimensional environment from the first location, and in accordance with the determination that the one or more second criteria are satisfied, the computer system moves the virtual object along the second directional axis includes moving the virtual object along the second directional axis with a magnitude that is increased based on a magnitude of the first movement component of the first input along the first directional axis, such as moving virtual object 710 in accordance with movement component 760b and at least a portion of movement component 760a along the parallel directional axis, as shown in FIG. 7P, if moving virtual object 710 along the parallel directional axis was based on movement component 760b being larger than movement component 760a. In some embodiments, the magnitude of the first and second movement components refers to the size, extent, or amount of movement input directed along the first and second directional axes, respectively. In some embodiments, moving the virtual object along the first directional axis with the magnitude that is increased based on the magnitude of the second movement component of the first input along the second directional axis involves transforming the magnitude or a portion of the magnitude of the movement intended for the second directional axis into a corresponding magnitude of movement along the first directional axis. In some embodiments, moving the virtual object along the second directional axis with the magnitude that is increased based on the magnitude of the first movement component of the first input along the first directional axis involves transforming the magnitude or a portion of the magnitude of the movement intended for the first directional axis into a corresponding magnitude of movement along the second directional axis.

In some embodiments, when the first axis locking criteria are satisfied, the first movement component along the first directional axis is a primary movement component along a primary directional axis and the second movement component along the second directional axis is a secondary movement component along a secondary directional axis. In some embodiments, when the second axis locking criteria are satisfied, the second movement component along the second directional axis is the primary movement component along the primary directional axis and the first movement component along the first directional axis is the secondary movement component along the secondary directional axis

In some embodiments, determining whether to transform either the magnitude or the portion of the magnitude of the movement intended for the secondary directional axis into movement along the primary directional axis is based on one or more transformation factors. Some examples of transformation factors include, but are not limited to, proximity to a surface (e.g., the first surface), proximity of other objects or thresholds (e.g., the snapping threshold), precision requirements for a task, or any other criteria described herein (e.g., axis locking criteria or snapping criteria). In some embodiments, the portion of the magnitude of the secondary movement component transformed into movement along the primary directional axis is determined as a specific fraction or percentage of the magnitude of the secondary movement component (e.g., 0%, 10%, 20%, 40%, 75%, or 100%).

In some embodiments, moving the virtual object along the primary directional axis in accordance with the primary movement component and the magnitude of the secondary movement component involves translating the virtual object along the primary axis of movement using both the direct input aligned with this axis (e.g., a primary movement component) and at least a portion of the input that was originally intended to move the object along a perpendicular axis (e.g., a secondary movement component). In some embodiments, moving the virtual object along the primary directional axis in accordance with the primary movement component and the magnitude of the secondary movement component optionally results in an increase in the total movement of the virtual object in the primary directional axis when the magnitude of the secondary movement component is non-zero. Redirecting the portion of the movement initially intended for the second directional axis into the first directional axis enhances the integration of user input into a single, coherent trajectory, reducing computational complexity by streamlining the virtual object's path towards its eventual target location (e.g., the third location), thereby improving processing efficiency and ensuring a more predictable and controlled navigation within the three-dimensional environment.

In some embodiments, suppressing the movement of the virtual object along the second directional axis relative to the second movement component includes, in accordance with a determination that a distance between the virtual object and the first surface is a first respective distance within the threshold distance of the first surface, suppressing movement of the virtual object along the second directional axis relative to the second movement component by a first suppression factor, such as the suppression of movement of virtual object 710 as shown in FIGS. 7R and/or 7S. In some embodiments, suppressing the movement of the virtual object along the second directional axis relative to the second movement component includes, in accordance with a determination that the distance between the virtual object and the first surface is a second respective distance, smaller than the first respective distance, within the threshold distance of the first surface, suppressing movement of the virtual object along the second directional axis relative to the second movement component by a second suppression factor, larger than the first suppression factor, such as the suppression of movement of virtual object 710 as shown in FIGS. 7T and/or 7U.

In some embodiments, suppressing the movement of the virtual object along the first directional axis relative to the first movement component includes, in accordance with the determination that the distance between the virtual object and the first surface is the first respective distance within the threshold distance of the first surface, suppressing movement of the virtual object along the first directional axis relative to the first movement component by the first suppression factor, such as the suppression of movement of virtual object 710 as shown in FIGS. 7R and/or 7S.

In some embodiments, in accordance with the determination that the distance between the virtual object and the first surface is the second respective distance, smaller than the first respective distance, within the threshold distance of the first surface, suppressing movement of the virtual object along the first directional axis relative to the first movement component by the second suppression factor, larger than the first suppression factor, such as the suppression of movement of virtual object 710 as shown in FIGS. 7T and/or 7U.

In some embodiments, a respective distance refers to a specific measurement of length or distance from a designated reference point within the three-dimensional environment. In some embodiments, the respective distance refers to the distance between the first location and the first surface (e.g., or, optionally, the third location). In some embodiments, the first respective distance indicates a specific measurement that is larger than the second respective distance.

In some embodiments, the suppression factor refers to a measure or ratio that determines the extent to which movement along a specific directional axis is reduced or constrained. In some embodiments, the computer system applies the suppression factor to the movement component intended for the locked directional axis, modifying the magnitude of the movement component such that the resulting movement of the virtual object in the locked directional axis is lesser than the movement of the virtual object in the locked directional axis directed by the first input. In some embodiments, the suppression factor is a specific fraction or percentage of the magnitude of the second movement component that is suppressed (e.g., 0%, 10%, 20%, 40%, 75%, or 100%). For example, when the suppression factor is 40%, the resulting movement along the secondary directional axis is equal to 60% of the magnitude of the secondary movement component. In some embodiments, the suppression factor is based on one or more factors described herein (e.g., with respect to the snapping criteria or the axis locking criteria). In some embodiments, as the virtual object gets closer to the surface (e.g., moves from the first respective distance to the second respective distance), the suppression factor applied to the movement along the secondary directional axis increases (e.g., movement along the secondary directional axis is further suppressed). In some embodiments, the suppression factor is dynamically adjusted based on the distance between a current location of the virtual object as it moves within the three-dimensional environment and the third location. In some embodiments, while axis locking mode is enabled, the suppression factor is greater as the virtual object moves closer to the first surface. Adjusting the portion of movement allowed in the second directional axis based on the virtual object's proximity to the first surface enhances precision in placement and reduces the need for user adjustments and further inputs, thereby preventing unnecessary recalculations and conserving computational resources and/or power.

In some embodiments, the virtual object is a window, such as window 716 shown in FIGS. 7V-7X. In some embodiments, the window refers to a graphical user interface element that represents a contained view or section of the virtual space. In some embodiments, the window is used to display information, provide interaction options, or serve as a portal through which the user can view or manipulate other parts of the virtual environment. In some embodiments, the window is a display for multimedia content (e.g., video, images, and/or music), interactive controls (e.g., for users to adjust settings, control environmental variables, and/or interact with data), a dashboard, an educational tool, a collaborative workspace, a gaming interface, a virtual marketplace or shop, social media, and/or teleconferencing or video calls. In some embodiments, the window is a component of an application's user interface (e.g., and/or is a user interface of an application) on the computer system, designed to display and manage content generated by the application within the three-dimensional environment. Allowing the virtual object to be a window increases the flexibility in types of virtual objects that can be snapped to a surface, enabling windows to be precisely positioned within the three-dimensional environment with fewer user inputs, thus conserving computational resources and power by reducing the need for repeated adjustments and interactions.

In some embodiments, the virtual object is a three-dimensional volume, such as virtual object 710 (e.g., illustrated as a cube) shown in FIG. 7A. In some embodiments, the three-dimensional volume refers to any virtual object that possesses depth, height, and width within the three-dimensional environment. In some embodiments, the three-dimensional volume corresponds to a region of the three-dimensional environment that the computer system displays content associated with a respective application (e.g., the respective application is accessible through the computer system). For example, the respective application is configured to place content (e.g., virtual content, such as respective media (e.g., video and/or images), and/or user interfaces associated with the respective application (e.g., a web-browsing user interface for a web-browsing application and/or a media streaming user interface for a media streaming application)) within the region of the three-dimensional environment. In some embodiments, the three-dimensional volume has one or more surfaces designed to be used as a display for content, similar to a window. In some embodiments, the three-dimensional volume represents a wide range of objects, from simple geometric shapes such as cubes and spheres to complex models such as vehicles, buildings, or organic structures. Allowing the virtual object to be a three-dimensional volume increases the flexibility in types of virtual objects that can be snapped to a surface, enabling three-dimensional volumes to be precisely positioned within the three-dimensional environment with fewer user inputs, thus conserving computational resources and power by reducing the need for repeated adjustments and interactions.

In some embodiments, the one or more snapping criteria include a criterion that is satisfied (e.g., and, when satisfied, causes or permits the one or more snapping criteria to be satisfied) when the first surface is a first surface type and the one or more snapping are not satisfied when the first surface is a second surface type, different from the first surface type, such as a criterion satisfied with respect to second surface 732 of two-dimensional view 742c and not satisfied with respect to second surface 732 of two-dimensional view 742d, as shown in FIG. 7I.

In some embodiments, a surface type refers to the classification or categorization of a surface within the three-dimensional environment based on one or more characteristics or intended use. In some embodiments, the surface type of the first surface determines how the virtual object interacts with or adheres to it, influencing one or more behaviors such as snapping, sliding, or other forms of placement and/or movement. Some examples of characteristics influencing surface types include, but are not limited to, texture (e.g., smooth, rough, and/or patterned), material composition (e.g., wood, metal, glass, and/or concrete), structural properties (e.g., flexibility, density, and/or porosity), and functional attributes (e.g., magnetized, electrified, and/or hot/cold). In some embodiments, the virtual object is configured to snap to the first surface depending on its surface type (e.g., the virtual object can snap to the first surface if it is a first surface type, but not if it is a second surface type). In some embodiments, the virtual object is configured to snap to a horizontal surface but not a vertical surface. In some embodiments, the virtual object is configured to snap to a vertical surface but not a horizontal surface. In some embodiments, the first surface is configured to allow the virtual object to snap to it depending on a virtual object type of the virtual object or one or more characteristics of the virtual object. The implementation of a determination of the type of the first surface as a criterion for enabling the snapping of the virtual object to the first surface ensures that the object is deliberately snapped, thereby significantly reducing the likelihood of user errors associated with accidental snapping and subsequent corrections and/or repeated user inputs, thus conserving power and/or computational resources.

In some embodiments, the one or more snapping criteria include a criterion that is satisfied when the virtual object is not being shared during a communication session with an external computer system, such as virtual object 710 not snapping to first surface 722 when it is shared between computer systems 101a and 101b, and snapping to first surface 722 when it is not shared with computer system 101b, as shown in FIGS. 7Y-7AD.

In some embodiments, the communication session is a real-time (e.g., or nearly real-time) communication session that includes audio (e.g., real-time voice audio from the first user and/or the second user, and/or audio content from media shared between the first user and the second user), video (e.g., real-time video of the environment of the first user and/or second user, and/or video content from media shared between the first user and the second user) and/or other shared content (e.g., images, applications, and/or interactive media (e.g., video game media)). In some embodiments, the external computer system displays, via a respective display generation component, a respective three-dimensional environment to a respective participant in the communication session.

In some embodiments, the virtual object is shared during a communication session when it is displayed and/or accessible not only on the computer system but also on other computer systems participating in the communication session. In some embodiments, the virtual object is not shared during a communication session when it is displayed on the computer system, but it is not displayed and/or accessible on other computer systems participating in the communication session. In some embodiments, in response to detecting the first input, in accordance with a determination that the virtual object is being shared during the communication session, the computer system moves the virtual object to the second location without moving the virtual object closer to the first surface. In some embodiments, in response to detecting the first input, in accordance with a determination that the virtual object is not being shared in the communication session (e.g., or is no longer being shared in the communication session (e.g., the communication session is terminated prior to the computer system detecting the first input), the computer system moves the virtual object to the third location that is closer to the first surface than the first location and the second location. For example, the computer system does not permit snapping of the virtual object to respective surfaces (e.g., physical and/or virtual surfaces, such as the first surface) in the three-dimensional environment when the virtual object is shared in a respective communication session and/or permits snapping of the virtual object to respective surfaces in the three-dimensional environment when the virtual object is not shared in a respective communication session.

In some embodiments, the one or more snapping criteria include a criterion that is satisfied when the first surface is being shared in a communication session with an external computer system (e.g., additionally, or alternatively, to the criterion that is satisfied when the virtual object is not being shared during the communication session with the external computer system). For example, while in the communication session with the external computer system, the computer system permits snapping of the virtual object to respective surfaces (e.g., physical and/or virtual surfaces, such as the first surface) in the three-dimensional environment that are shared in the communication session, and does not permit snapping of the virtual object to respective surfaces in the three-dimensional environment that are not shared in the communication session. In some embodiments, the one or more snapping criteria including a criterion that is satisfied when the virtual object is not being shared during the communication session ensures that snapping actions are disabled or not triggered when the virtual object is visible or accessible to external systems (e.g., because the external systems involved may not have the same environmental context, specifically the first surface to which the virtual object would snap to). In some embodiments, when the computer system is in the communication session with the external computer system, but the virtual object is not being shared with the external computer system, the virtual object is allowed to snap to the first surface if the rest of the one or more snapping criteria are met. The implementation of determining whether the virtual object is shared with the external computer system during the communication session as a criterion for enabling the snapping of the virtual object to the first surface ensures that the object is deliberately snapped, thereby significantly reducing the likelihood of user errors associated with accidental snapping and subsequent corrections and/or repeated user inputs, thus conserving power and/or computational resources.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9JJ illustrate examples of a computer system displaying representations of respective types of virtual objects in a three-dimensional environment.

FIG. 9A illustrates computer system 101 (e.g., an electronic device) displaying, via display generation component 120, a virtual window 908 in a three-dimensional environment 902. In some embodiments, computer system 101 is a head-mounted device (e.g., a head-mounted display) worn by a user of computer system 101. In some embodiments, computer system 101 is a different type of device, such as a mobile phone, tablet, laptop, or smart watch (e.g., the embodiment of computer system 101 shown and described with reference to FIGS. 9GG-9JJ). In some embodiments, three-dimensional environment 902 is visible to the user of computer system 101 through display generation component 120 (e.g., display generation component 120 includes a transparent and/or translucent display). For example, three-dimensional environment 902 is visible to the user of computer system 101 while the user wears computer system 101. In some embodiments, computer system 101 includes a plurality of images sensors 314a through 314c (e.g., corresponding to image sensors 314 of FIG. 3A). The image sensors optionally include one or more of a visible light camera, an infrared camera, a depth sensor, or any other sensor computer system 101 would be able to use to capture one or more images of a user of computer system 101 or a part of the user (e.g., one or more hands of the user) while the user interacts with computer system 101.

In some embodiments, display generation component 120 is configured to display one or more virtual objects (e.g., virtual content, such as virtual window 908 (e.g., as shown in FIG. 9A) and/or representation 916a (e.g., as shown in FIG. 9B)) in three-dimensional environment 902. In some embodiments, as shown in FIG. 9A, computer system 101 displays one or more virtual objects within a representation of a physical environment. For example, one or more computer-generated virtual objects (e.g., virtual window 908) and one or more physical objects (e.g., real-world window 904, or real-world table 906) from a physical environment of a user of computer system 101 are visible to the user in three-dimensional environment 902 (e.g., as optical and/or video passthrough through display generation component 120). Alternatively, or additionally, in some embodiments, computer system 101 displays one or more virtual objects within (e.g., superimposed on) a representation of a virtual environment (e.g., an at least partially immersive virtual environment, such as a representation of an outdoor environment (e.g., a beach, lake, mountain, or desert scene)). In some embodiments, three-dimensional environment 902 has one or more characteristics of the three-dimensional environments described with reference to methods 800 and/or 1000.

In FIG. 9A, computer system 101 displays a virtual window 908 in three-dimensional environment 902. In some embodiments, virtual window 908 is associated with a respective application that is accessible through computer system 101. For example, the respective application is for previewing one or more virtual objects (e.g., as described with reference to method 1000) in three-dimensional environment 902. For example, the respective application is associated with a web-browser (e.g., virtual window 908 includes a user interface for a website associated with purchasing one or more products (e.g., electronic devices)). For example, virtual window 908 is associated with an electronic commerce website and/or application (e.g., for previewing and/or purchasing one or more products).

In FIG. 9A, a user interface is displayed within virtual window 908 that includes a virtual object 901. As shown in FIG. 9A, virtual object 901 is a virtual representation of an electronic device (e.g., a smart watch). For example, virtual object 901 is a representation of a product (e.g., a smart watch) that may be purchased through the respective application and/or web-browser described above (e.g., the product is an electronic device, or a different type of object, such as a piece of furniture). In some embodiments, the user interface included in virtual window 908 includes information about the electronic device represented by virtual object 901 (e.g., product specifications) and/or one or more options to purchase the electronic device. In some embodiments, the user interface included in virtual window 908 includes one or more selectable options to change one or more features of virtual object 901 (e.g., corresponding to different configurations of the electronic device represented by virtual object 901 and/or different models of the electronic device (e.g., to view different models and/or configuration of the electronic device within virtual window 908)). In some embodiments, the user interface included in virtual window 908 has one or more selectable options to change the type of virtual object displayed in the user interface (e.g., the one or more selectable options are selectable to view a different type of product (e.g., a different type of electronic device)).

As shown in FIG. 9A, virtual window 908 includes an affordance 910 that is selectable to display a representation of virtual object 901 (e.g., outside of virtual window 908) in three-dimensional environment 902 (e.g., an affordance includes an image, icon, and/or text that is selectable (e.g., through user input) to perform one or more operations in three-dimensional environment 902). In some embodiments, the representation of virtual object 901 has one or more characteristics of a representation of the respective type of virtual object (e.g., with the first value for the first visual characteristics and/or the second value for the first visual characteristic) described with reference to method 1000.

In FIG. 9A, computer system 101 detects an input corresponding to selection of affordance 910. As shown in FIG. 9A, the input includes an air gesture (e.g., a hand pinch) performed by hand 914 while attention (e.g., gaze 912) is directed to affordance 910. In response to detecting selection of affordance 910 in FIG. 9A, computer system 101 displays a representation 916a in FIG. 9B (e.g., and optionally ceases to display virtual window 908). For example, representation 916a corresponds to the representation of virtual object 901 described above.

In some embodiments, representation 916a includes one or more visual characteristics corresponding to one or more features of virtual object 901 shown in virtual window 908. For example, representation 916a includes a representation of a band 938a (e.g., a watch band) of a color and/or material corresponding to a color and/or material of a band of the electronic device represented by virtual object 901 in virtual window 908. For example, representation 916a includes a representation of a display 940a (e.g., a smart watch display) with a size corresponding to a size of a display of the electronic device represented by virtual object 901 in virtual window 908.

As shown in FIG. 9B, computer system 101 displays representation 916a along with one or more affordances. A first affordance 918a is optionally selectable (e.g., through a user input having one or more characteristics of the input shown and described with reference to FIG. 9A) to performing an operation in three-dimensional environment 902 associated with the representation 916a (e.g., by displaying a user interface (e.g., associated with the respective application described above) for purchasing a smart watch with the specifications and/or configurations of representation 916a). In some embodiments, affordance 918a has one or more characteristics of the affordance that is selectable to perform the operation associated with the respective type of virtual object described with reference to method 1000 (e.g., the respective type of virtual object has one or more characteristics of virtual object 901). A second affordance 918b (e.g., which is optionally displayed separated from affordance 918a or as part of the same interface) is optionally selectable to display a menu for changing one or more visual characteristics of representation 916a (e.g., as shown and described with reference to FIGS. 9E-9F). In FIG. 9B, affordances 918a and 918b are displayed within a virtual object adjacent to representation 916a (e.g., below and/or optionally in front of representation 916a (e.g., from a current viewpoint of a user of computer system 101)). Alternatively, in some embodiments, affordance 918a and affordance 918b are displayed separately in three-dimensional environment 902 (e.g., at different locations in three-dimensional environment 902 and/or not within the same virtual object (e.g., as shown in FIGS. 9GG-9JJ)).

In FIG. 9B, computer system 101 displays representation 916a at a first pose (e.g., location and/or orientation) in three-dimensional environment 902. For example, the first pose of representation 916a corresponds to a default and/or pre-set pose (e.g., a location and/or orientation computer system 101 displays a respective representation of a respective type of virtual object at in response to an input to initiate display of the respective representation of the respective type of virtual object in three-dimensional environment 902). For example, the first pose of representation 916a corresponds to a previous pose a representation of virtual object 901 (e.g., optionally with one or more different visual characteristics from representation 916a) was displayed at in three-dimensional environment 902 prior to computer system 101 displaying representation 916a (e.g., during one or more previous user interactions with the respective application described above).

FIG. 9B (and FIGS. 9D, 9J, 9L, 9M, 9T, and 9V) includes a close-up view 920 of representations of virtual object 901 displayed in three-dimensional environment 902 (e.g., representation 916a shown in FIG. 9B). Close-up view 920 is shown as reference in the figures to further illustrate differences (e.g., and/or optionally similarities) in pose and/or visual appearance of respective representations of virtual object 901 (e.g., representation 916a shown in FIG. 9B, or representation 916b shown in FIG. 9J) computer system 101 displays in three-dimensional environment 902. In some embodiments, representation 916a is selectable to move (e.g., to change the pose of representation 916a) in three-dimensional environment 902. As shown in FIG. 9B, representation 916a is displayed with a virtual element 922 (e.g., displayed below and/or in front of representation 916a from a current viewpoint of a user of computer system 101). In some embodiments, virtual element 922 is selectable to move representation 916a in three-dimensional environment 902 (e.g., to change a location and/or orientation of representation 916a in three-dimensional environment 902).

In FIG. 9C, computer system 101 detects an input corresponding to a request to change the pose of (e.g., and/or to move) representation 916a in three-dimensional environment 902. As shown in FIG. 9C, the input includes a hand gesture (e.g., an air pinch) with movement (e.g., represented by arrow 924a) performed by hand 914 while gaze 912 is directed to virtual element 922. In some embodiments, computer system 101 moves representation 916a in three-dimensional environment 902 in accordance with the movement performed by hand 914 (e.g., represented by arrow 924a) during the input. For example, in response to detecting translational movement of hand 914 during the input, computer system 101 moves representation 916a to a different location in three-dimensional environment 902 (e.g., in a direction and/or by an amount corresponding to the direction and/or magnitude of the translational movement of hand 914 during the input). For example, in response to detecting rotational movement of hand 914 during the input, computer system 101 changes an orientation of representation 916a relative to three-dimensional environment 902 (e.g., by rotating representation 916a about an axis corresponding to the current location of representation 916a in three-dimensional environment (e.g., in a direction and/or by an amount corresponding to the direction and/or magnitude of the rotational movement of hand 914 during the input)). Alternatively, in some embodiments, the input includes a hand gesture (e.g., such as the hand gesture shown in FIG. 9C) while gaze 912 is directed to at least a portion of representation 916a. Alternatively, or additionally, in some embodiments, the input includes a multi-hand input.

In response to the input detected in FIG. 9C, computer system 101 displays, in FIG. 9D, representation 916a at a second pose, different from the first pose (shown in FIG. 9C), in three-dimensional environment 902 (e.g., during the input shown in FIG. 9C, hand 914 rotates counter-clockwise to move representation 916a to the second pose in three-dimensional environment 902). For example, at the second pose, representation 916a has a different orientation relative to three-dimensional environment 902 (e.g., compared to as shown in FIG. 9C).

In FIG. 9E, computer system 101 detects an input corresponding to selection of affordance 918b. The input includes gaze 912 directed to virtual element 922 while an air gesture (e.g., an air pinch) is performed by hand 914. In response to detecting the input in FIG. 9E, computer system 101 displays a menu 926a in FIG. 9F. In some embodiments, menu 926a includes a plurality of selectable options 928a through 928c corresponding to visual characteristics of virtual object 901 (e.g., as shown in FIG. 9A). For example, the visual characteristics correspond to features of the product (e.g., smart watch) that virtual object 901 represents (e.g., features of one or more components of the smart watch represented by virtual object 901). In some embodiments, selectable option 928a corresponds to a first visual characteristic (e.g., a size of a display of the smart watch corresponding to virtual object 901). In some embodiments, selectable option 928b corresponds to a second visual characteristic, different from the first visual characteristic (e.g., a type of case (e.g., including color and/or material) of the smart watch corresponding to virtual object 901). In some embodiments, selectable option 928c corresponds to a third visual characteristic, different from the first visual characteristic and the second visual characteristic (e.g., a type of band (e.g., including color and/or material) of the smart watch corresponding to virtual object 901). In some embodiments, the first visual characteristic (e.g., corresponding to selectable option 928a), the second visual characteristic (e.g., corresponding to selectable option 928b), and/or the third characteristic (e.g., corresponding to selectable option 928c) have one or more characteristics of the first visual characteristic and/or the second visual characteristic of the respective type of virtual object described with reference to method 1000.

As shown in FIG. 9F, menu 926a includes an indication 930 showing a current scale of representation 916a in three-dimensional environment 902. Menu 926a further includes an affordance 932 that is selectable to share representation 916a (e.g., through a messaging application (e.g., a message link to view the user interface included in virtual window 908 shown in FIG. 9A) or in a communication session (e.g., as described with reference to FIGS. 9CC-9FF)).

In some embodiments, in FIG. 9F, computer system 101 displays menu 926a as an environment-locked virtual object. In some embodiments, computer system 101 displays menu 926a with a respective spatial relationship with respect to representation 916a (e.g., having one or more characteristics of displaying the plurality of selectable options with the first spatial relationship with respect to a representation of the respective type of virtual object (e.g., with the first value for the first visual characteristic) described with reference to method 1000). For example, computer system 101 displays menu 926a adjacent to (e.g., above, below, or to the side of (e.g., from the current viewpoint of a user of computer system 101)) representation 916a in three-dimensional environment 902. For example, the respective spatial relationship includes a distance and/or orientation relative to representation 916a (e.g., the distance and/or orientation corresponds to a default spatial arrangement computer system 101 displays menu 926a at relative to a respective representation of a virtual object (e.g., having one or more characteristics of the default spatial relationship of the plurality of selectable options described with reference to method 1000). In some embodiments, computer system 101 displays menu 926a at a location in three-dimensional environment 902 that overlaps at least a portion of representation 916a from the current viewpoint of a user of computer system 101. In some embodiments, computer system 101 displays menu 926a such that at least a portion of representation 916a is visible in three-dimensional environment 902 from the current viewpoint of a user of computer system 101.

In FIG. 9G, computer system 101 detects an input corresponding to selection of selectable option 928c. As shown in FIG. 9G, the input includes an air gesture (e.g., an air pinch) performed by hand 914 while gaze 912 is directed to selectable option 928c. In response to detecting the input in FIG. 9G, computer system 101 displays a plurality of selectable options 934a through 934c as shown in FIG. 9H. In some embodiments, selectable options 934a through 934c correspond to values for the third visual characteristic (e.g., corresponding to selectable option 928c) (e.g., band colors computer system 101 can display a representation of virtual object 901 with in three-dimensional environment 902). For example, selectable option 934a corresponds to a first value for the third visual characteristic (e.g., a blue band of a smart watch), selectable option 934b corresponds to a second value, different from the first value, for the third visual characteristic (e.g., a red band of a smart watch), and selectable option 934c corresponds to a third value, different from the first value and the second value, for the third visual characteristic (e.g., a black band of a smart watch). In some embodiments, the first value associated with selectable option 934a, the second value associated with selectable option 934b, and/or the third value associated with selectable option 934c have one or more characteristics of the first value and/or the second value for the first visual characteristic described with reference to method 1000.

In FIG. 9H, computer system 101 detects an input corresponding to selection of selectable option 934a. As shown in FIG. 9H, the input includes an air gesture (e.g., an air pinch) performed by hand 914 while gaze 912 is directed to selectable option 934a. In some embodiments, the input shown in FIG. 9H corresponds to a request to display a representation of virtual object 901 with the first value for the third visual characteristic (e.g., a representation of a smart watch with a blue band). For example, the representation of virtual object 901 with the first value for the third visual characteristic includes a different colored band than band 938a included in representation 916a (e.g., representation 916a includes a respective value for the third visual characteristic that is different from the first value for the third visual characteristic (e.g., the second value or the third value)). In some embodiments, in response to detecting the input shown in FIG. 9H, computer system 101 displays a representation of virtual object 901 with the first value for the third visual characteristic in three-dimensional environment 902 (e.g., representation 916b shown in FIG. 9J).

In some embodiments, while computer system 101 renders the representation of virtual object 901 with the first value for the third visual characteristic in three-dimensional environment 902, computer system 101 ceases to display representation 916a in three-dimensional environment 902. In some embodiments, while computer system 101 renders the representation of virtual object 901 with the first value for the third visual characteristic in three-dimensional environment 902, computer system 101 maintains display of representation 916a in three-dimensional environment 902 (e.g., and changes a visual appearance (e.g., changes the opacity, and/or color) of the band included in representation 916a (e.g., replaces the band 938a with a band of a different visual appearance)).

In FIG. 9I, while rendering the representation of virtual object 901 with the first value for the third visual characteristic, computer system 101 displays a visual indication 936 in three-dimensional environment 902. In some embodiments, visual indication 936 is displayed at the location and/or orientation in three-dimensional environment 902 that computer system 101 displayed representation 916a at in FIGS. 9D-9H (e.g., the second pose in three-dimensional environment 902 as described above). In some embodiments, visual indication 936 has one or more characteristics of the visual indication that is displayed in the three-dimensional environment before displaying the representation of the respective type of virtual object with the second value for the first visual characteristic as described with reference to method 1000.

From FIG. 9I to FIG. 9J, after displaying visual indication 936, computer system 101 displays a virtual representation 916b at the second pose in three-dimensional environment 902 (e.g., at the same pose virtual representation 916a was displayed at in three-dimensional environment 902 when the input corresponding to selection of selectable option 934a was detected by computer system 101 in FIG. 9H). In some embodiments, representation 916b has one or more characteristics of the representation of virtual object 901 with the first value for the third visual characteristic described with reference to FIG. 9H (e.g., and/or the representation of the respective type of virtual object with the second value for the first visual characteristic described with reference to method 1000). As shown in FIG. 9J, representation 916b includes a band 938b (e.g., and does not include band 938a of representation 916a). For example, band 938b of representation 916b has a different color (e.g., a different value for the third visual characteristic) than band 938a of representation 916a shown in FIGS. 9B-9H (e.g., as represented by the fill-pattern of band in FIG. 9J).

In FIG. 9K, computer system 101 detects an input corresponding to a request to change the pose of representation 916b in three-dimensional environment 902. In some embodiments, the input shown in FIG. 9K has one or more characteristics of the input shown and described with reference to FIG. 9C. As shown in FIG. 9K, the input includes movement of hand 914 (e.g., represented by arrow 924b) (e.g., to rotate representation 916b to a horizontal orientation in three-dimensional environment 902). In response to detecting the input in FIG. 9K, computer system 101 displays, in FIG. 9L, representation 916b at a third pose, different from the second pose, in three-dimensional environment 902.

In FIG. 9L, computer system 101 detects an input corresponding to a request to the change the pose of representation 916b in three-dimensional environment 902. In some embodiments, the input shown in FIG. 9L has one or more characteristics of the input shown and described with reference to FIG. 9C. As shown in FIG. 9L, the input includes movement of hand 914 (e.g., downward to move representation 916b downward in three-dimensional environment 902 from a current viewpoint of a user of computer system 101). In some embodiments, the input shown in FIG. 9L corresponds to a request to snap representation 916b to a surface of real-world table 906 in three-dimensional environment 902. For example, snapping representation 916b to the surface of real-world table 906 has one or more characteristics of snapping an object to a surface as described with reference to method 800.

In response to the input detected in FIG. 9L, computer system 101 snaps representation 916b to the surface of real-world table 906 in FIG. 9M (e.g., computer system 101 displays representation 916b at a fourth pose, different from the third pose, in three-dimensional environment 902). As shown in FIG. 9M, computer system 101 optionally changes a location of affordances 918a and 918b (e.g., to avoid visual conflicts with the surface of real-world table 906). In some embodiments, computer system 101 does not change the location of affordances 918a and 918b when snapping a respective representation of a respective virtual object to a surface in three-dimensional environment 902 (e.g., computer system 101 displays affordances 918a and 918b at a location in front of the respective representation of the respective virtual object in three-dimensional environment 902 from the current viewpoint of the user of computer system 101 (e.g., such that there is not a spatial conflict between the surface the respective representation is snapped to and affordances 918a and/or 918b).

In FIG. 9N, computer system 101 detects an input corresponding to selection of affordance 918b (e.g., having one or more characteristics of the input shown and described with reference to FIG. 9E). In response to detecting the input shown in FIG. 9N, computer system 101 displays, in FIG. 9O, menu 926a in three-dimensional environment 902 (e.g., having one or more characteristics of displaying menu 926a described with reference to FIG. 9F). For example, computer system 101 displays menu 926a in three-dimensional environment 902 with the respective spatial relationship with respect to representation 916b (e.g., as described with reference to FIG. 9E).

FIG. 9O includes a top-down view 942 of three-dimensional environment 902. Top-down view 942 includes a user 944 of computer system 101 (e.g., user 944 is wearing computer system 101) viewing three-dimensional environment 902 from a current viewpoint (e.g., represented by arrow 946). Top-down view 942 includes schematic representations of representation 916b, menu 926a, and real-world table 906.

In FIG. 9P, computer system 101 detects a change in the current viewpoint of user 944 relative to three-dimensional environment 902 (e.g., as shown in top-down view 942, user 944 moves (e.g., while wearing computer system 101) laterally in three-dimensional environment 902)). In response to detecting the change in the current viewpoint of user 944 relative to three-dimensional environment 902, computer system 101 maintains display of menu 926a with the respective spatial relationship with respect to representation 916b. For example, computer system 101 maintains display of menu 926a at the same location and/or orientation (e.g., pose) relative to three-dimensional environment 902 during (e.g., and/or after) the change in the current viewpoint of user 944 (e.g., such that a display location of menu 926a changes from the current viewpoint of user 944 as a result of the change in viewpoint). For example, computer system 101 maintains display of menu 926a at the same distance and/or orientation relative to representation 916b.

In FIG. 9Q, computer system 101 detects selection of selectable option 928a (e.g., corresponding to the first visual characteristic of virtual object 901 described with reference to FIG. 9F (e.g., corresponding to a size of a display of a smart watch)). As shown in FIG. 9Q, the input includes an air gesture (e.g., an air pinch) performed by hand 914 while gaze 912 is directed to selectable option 928a. In response to detecting the input in FIG. 9Q, computer system 101 displays selectable options 948a and 948b in three-dimensional environment 902 in FIG. 9R. In some embodiments, selectable options 948a and 948b correspond to values of the first visual characteristic (e.g., corresponding to selectable option 928a). For example, selectable option 948a corresponds to a first value for the first visual characteristic (e.g., a first size of a display of a smart watch), and selectable option 948a corresponds to a second value, different from the first value, for the first visual characteristic (e.g., a second size, different from the first size, of a display of a smart watch)). In some embodiments, the first value for the first visual characteristic (e.g., associated with selectable option 948a) and the second value for the first visual characteristic (e.g., associated with selectable option 948b) have one or more characteristics of the first value and/or second value for the first visual characteristic described with reference to method 1000.

In some embodiments, computer system 101 delays displaying a representation of virtual object 901 (e.g., including the first value for the first visual characteristic) until a user of computer system 101 finishes making selections in menu 926a. For example, computer system 101 maintains display of representation 916b in three-dimensional environment 902 until a threshold amount of time (e.g., having one or more characteristics of the first time threshold described with reference to method 1000) has elapsed since a selection of a respective selectable option in menu 926a. In FIGS. 9R-9U, a time glyph 950 is shown to illustrate the amount of time that has elapsed since a selection of a respective selectable option in menu 926a. For example, a shaded portion of time glyph 950 corresponds to the amount of time that has passed since selection of a respective selectable option in menu 926a. For example, the threshold amount of time has passed since selection of a respective selectable option in menu 926a when glyph 950 is completely shaded (e.g., as shown in FIG. 9U).

In FIG. 9R, computer system 101 detects an input corresponding to selection of selectable option 948b (e.g., associated with the second value for the first visual characteristic) (e.g., the input has one or more characteristics of the input shown and described with reference to FIG. 9H). In response to detecting the input in FIG. 9R, computer system 101 maintains display of representation 916b in three-dimensional environment 902 in FIG. 9S. As shown in FIG. 9S, less than the threshold amount of time has elapsed since computer system 101 detected the input corresponding to selection of selectable option 948b in FIG. 9R (e.g., as shown by time glyph 950 in FIG. 9S).

From FIG. 9R to 9T, computer system 101 displays selectable options 934a through 934c in three-dimensional environment 902 (e.g., in response to an input corresponding to selection of selectable option 928c, as shown and described with reference to FIG. 9G). In some embodiments, in FIG. 9T, computer system 101 detects an input corresponding to selection of selectable option 934b (e.g., associated with the second value for the third visual characteristic described with reference to FIG. 9H) (e.g., the input has one or more characteristics of the input shown and described with reference to FIG. 9H). In response to detecting the input shown in FIG. 9T, computer system 101 maintains display of representation 916b until the threshold amount of time has elapsed since computer system 101 detected selection of selectable option 934b (e.g., as shown in FIG. 9T, time glyph 950 is reset (e.g., does not include a shaded portion) in response to the selection of selectable option 934b).

In some embodiments, in response to selection of selectable option 948b, computer system 101 displays a representation of virtual object 901 with an increased size compared to representation 916b. For example, the representation of virtual object 901 includes a larger display than display 940a included in representation 916b.

As shown in FIG. 9T, close-up view 920 includes a schematic representation of a ruler 952 including four segments. Ruler 952 is illustrated for reference to show a difference in size between representation 916b (e.g., as shown in FIG. 9T) and representation 916c (e.g., as shown in FIG. 9V). It should be appreciated that, in some embodiments, the segments of ruler 952 illustrated in FIG. 9T and FIG. 9V correspond to a consistent unit of measurement.

From FIG. 9T to FIG. 9U, the threshold amount of time has elapsed since computer system 101 detected selection of selectable option 934b. In accordance with a determination that the threshold amount of time has elapsed since computer system 101 detected the input corresponding to selection of selectable option 934b in FIG. 9T (e.g., and in accordance with there being no intervening selection of one or more selectable options since selection of selectable option 934b), computer system 101 displays a representation of virtual object 901 with the second value for the first visual characteristic (e.g., associated with selectable option 948b shown in FIG. 9R) and with the second value for the third visual characteristic (e.g., associated with selectable option 934b shown in FIG. 9T) in three-dimensional environment 902 (e.g., representation 916c shown in FIG. 9V). As shown in FIG. 9U, prior to displaying (e.g., while rendering) the representation of virtual object 901 in three-dimensional environment 902, computer system 101 displays visual indication 936 in three-dimensional environment 902 (e.g., displaying visual indication 936 in three-dimensional environment 902 includes one or more characteristics of displaying visual indication 936 shown and described with reference to FIG. 9I).

In FIG. 9V, computer system 101 displays representation 916c at the same pose (e.g., fourth pose) in three-dimensional environment 902 computer system 101 displayed representation 916b at, prior to rendering representation 916c (e.g., prior to the input detected by computer system 101 in FIG. 9T). For example, in FIG. 9V, computer system 101 displays representation 916c at the same location and/or orientation relative to three-dimensional environment 902 in FIG. 9V as representation 916b in FIGS. 9M-9T. For example, in FIG. 9V, computer system 101 displays representation 916c snapped to the surface of real-world table 906 in the same manner (e.g., at the same location and/or position relative to the surface) as representation 916b in FIGS. 9M-9T). In some embodiments, representation 916c corresponds to the representation of virtual object 901 with the second value for the first visual characteristic (e.g., corresponding to a size of a display of a smart watch) and the second value for the third visual characteristic (e.g., corresponding to a color of a band of a smart watch) described above. For example, representation 916c includes a band 938c with a different color than band 938b included in representation 916b (e.g., band 938c corresponds to selectable option 934b). For example, representation 916c includes a display 940b with a larger size than display 940a included in representation 916b (e.g., display 940b corresponds to selectable option 948b).

In some embodiments, displaying representation 916c in three-dimensional environment 902 includes scaling representation 916c from the bottom of representation 916c (e.g., upward from the surface of real-world table 906 (e.g., to prevent spatial and/or visual conflicts between representation 916c and real-world table 906)). For example, computer system 101 scales representation 916c upward (e.g., from the surface of real-world table 906) in accordance with a determination that representation 916b was displayed on and/or snapped to the surface of real-world table 906 (e.g., because computer system 101 displays representation 916c at the same pose in three-dimensional environment 902 that computer system 101 displayed representation 916b at in three-dimensional environment 902). As shown in FIG. 9V, representation 916c is displayed on and/or snapped to the surface of real-world table 906 (e.g., in the same manner (e.g., at the same pose) as representation 916b in FIG. 9T)) and with an increased size compared to representation 916b (e.g., as shown relative to ruler 952 in close-up view 920 (e.g., compared to FIG. 9T)). In some embodiments, displaying representation 916c in FIG. 9V includes one or more characteristics of scaling the respective type of virtual object to the second length along the first dimension in the three-dimensional environment in the first direction and not the second direction, as described with reference to method 1000.

FIGS. 9W-9BB illustrate computer system 101 displaying a representation of a respective type of virtual object in three-dimensional environment 902 that is different from virtual object 901 (e.g., the respective type of virtual object corresponds to a representation of a piece of furniture (e.g., a loveseat or sectional couch) as opposed to an electronic device (e.g., a smart watch)). As shown in FIG. 9W, a user of computer system 101 views a different region of three-dimensional environment 902 (e.g., corresponding to a different room of a physical environment of the user of computer system 101) than the region of three-dimensional environment 902 viewed in FIGS. 9A-9V. For example, the view of three-dimensional environment 902 shown in FIG. 9W includes a real-world painting 956 (e.g., and does not include real-world window 904 or real-world table 906 shown in FIGS. 9A-9V). For example, the view of three-dimensional environment 902 shown in FIG. 9W includes an empty space where representations of furniture can be displayed by computer system 101 (e.g., on and/or snapped to a surface of real-world floor 962) without causing visual conflicts (e.g., a user of computer system 101 desires to preview an appearance of one or more pieces of furniture in the room shown in three-dimensional environment 902 in FIG. 9W).

In FIG. 9W, computer system 101 displays a representation 954a of a respective type of virtual object in three-dimensional environment 902. For example, the respective type of virtual object corresponds to a couch (e.g., a loveseat or sectional that may be purchased through a respective application, such as the respective application described with reference to FIG. 9A). For example, computer system 101 displays representation 954a in response to an input corresponding to a request to display a respective representation of the respective type of virtual object (e.g., corresponding to a loveseat) in three-dimensional environment 902 (e.g., having one or more characteristics of the input shown and described with reference to FIG. 9A). As shown in FIG. 9W, computer system 101 displays representation 954a with affordances 918a and 918b and virtual element 922 (e.g., described with reference to FIG. 9B). In some embodiments, computer system 101 displays representation 954a at a first pose in three-dimensional environment 902 (e.g., in response to an input corresponding to the request to display representation 954a in three-dimensional environment 902 (e.g., having one or more characteristics of the input shown and described with reference to FIG. 9A), or in response to an input corresponding to a request to move representation 954a to the first pose in three-dimensional environment 902 (e.g., having one or more characteristics of the input shown and described with reference to FIG. 9C)). For example, displaying representation 954a at the first pose in three-dimensional environment 902 includes displaying representation 954a on and/or snapped to a surface of real-world floor 962.

As shown in FIG. 9W, computer system 101 detects an input corresponding to selection of affordance 918b (e.g., having one or more characteristics of the input shown and described with reference to FIG. 9E). In response to detecting the input in FIG. 9W, computer system 101 displays a menu 926b in three-dimensional environment 902 in FIG. 9X. In some embodiments, menu 926b has one or more characteristics of menu 926a shown and described with reference to FIG. 9F (e.g., menu 926b is displayed with a respective spatial relationship with respect to representation 954a). For example, in FIG. 9X, computer system 101 displays menu 926 as an environment-locked virtual object.

As shown in FIG. 9X, menu 926b includes a plurality of selectable options 958a through 958c corresponding to visual characteristics computer system 101 can display a representation of the respective type of virtual object within three-dimensional environment 902. For example, the visual characteristics correspond to different features and/or models of the product (e.g., couches) that the respective type of virtual object represents. In some embodiments, selectable option 958a corresponds to a first visual characteristic of the respective type of virtual object (e.g., the type and/or size of couch). In some embodiments, selectable option 958b corresponds to a second visual characteristic, different from the first visual characteristic of the respective type of virtual object (e.g., the material of the couch). In some embodiments, selectable option 958c corresponds to a third visual characteristic, different from the first visual characteristics and the second visual characteristic of the respective type of virtual object (e.g., the color of the couch). In some embodiments, the first visual characteristic (e.g., corresponding to selectable option 958a), the second visual characteristic (e.g., corresponding to selectable option 958b), and the third visual characteristic (e.g., corresponding to selectable option 958c) have one or more characteristics of the first visual characteristic and/or the second visual characteristic of the respective type of virtual object described with reference to method 1000. As shown in FIG. 9X, menu 926b includes indication 930 showing a current scale of representation 954a in three-dimensional environment 902. For example, as shown in FIG. 9X, computer system 101 displays representation 954a at a 100 percent scale (e.g., corresponding to a real-world size of the loveseat product). Menu 926b further includes affordance 932 that is selectable to share representation 954a (e.g., as described with reference to FIG. 9F).

In FIG. 9X, computer system 101 detects an input corresponding to selection of selectable option 958a (e.g., having one or more characteristics of the input shown and described with reference to FIG. 9G). In response to detecting the input in FIG. 9X, computer system 101 displays, in FIG. 9Y, selectable options 960a and 960b in three-dimensional environment 902. In some embodiments, selectable options 960a and 960b correspond to values for the first visual characteristic (e.g., corresponding to selectable option 958a) (e.g., types of couches computer system 101 can display as a representation in three-dimensional environment 902 (e.g., the types of couches include couches of different sizes)). For example, selectable option 960a corresponds to a first value for the first visual characteristic (e.g., a loveseat) and selectable option 960b corresponds to a second value, different from the first value, for the first visual characteristic (e.g., a sectional). In some embodiments, the first value associated with selectable option 960a and/or the second value associated with selectable option 960b have one or more characteristics of the first value and/or the second value for the first visual characteristic described with reference to method 1000.

In FIG. 9Y, computer system 101 detects an input corresponding to selection of selectable option 960b (e.g., corresponding to a request to display a representation of the respective type of virtual object with the second value for the first visual characteristic (e.g., a sectional couch)). For example, the input shown in FIG. 9Y has one or more characteristics of the input shown and described with reference to FIG. 9H.

In response to detecting the input in FIG. 9Y, computer system 101 displays representation 954b in FIG. 9Z. For example, representation 954b corresponds to the representation of the respective type of virtual object with the second value for the first visual characteristic (e.g., a representation of a sectional couch). In some embodiments, computer system 101 displays representation 954b at the same pose (e.g., the first pose) in three-dimensional environment 902 that computer system 101 displayed representation 954a at in FIGS. 9W-9Y. For example, computer system 101 displays representation 954b at the same location and/or orientation relative to three-dimensional environment 902 as representation 954a. For example, computer system 101 displays representation 954b on and/or snapped to the surface of real-world floor 962 in the same manner (e.g., at the same pose relative to real-world floor 962) as representation 954a.

In some embodiments, in accordance with a determination that displaying representation 954b according to the same scale as representation 954a (e.g., a 100 percent scale as shown by indication 930 in FIG. 9X) in three-dimensional environment 902 would cause the size of representation 954b to exceed a threshold amount, computer system 101 displays representation 954b in FIG. 9Z according to a different scale (e.g., a reduced scale) compared to representation 954a in three-dimensional environment 902 (e.g., automatically in response to selection of selectable option 960b in FIG. 9Y (e.g., without additional user input to change the scale of representation 954b)). In some embodiments, the threshold amount includes a dimension that is more than 0.5, 1, 2, 5, 10, 15, 20, 25, 50, or 100 meters. In some embodiments, the threshold amount corresponds to an amount of a current field of view of a user of computer system 101 representation 954b would occupy if computer system 101 displays representation 954b according to the same scale as representation 954a. For example, in accordance with a determination that displaying representation 954b at a 100 percent scale would cause, from the current viewpoint of the user of computer system 101, representation 954b to be displayed at least partially outside the viewport of computer system 101, computer system 101 displays representation 954b at a reduced scale in three-dimensional environment 902 compared to representation 954a (e.g., automatically (e.g., without user input corresponding to a change and/or selection of scale of representation 954b)). In some embodiments, the threshold amount corresponds to a difference in size between representation 954b and representation 954a when displayed according to the same scale (e.g., the threshold amount corresponds to a size that is 1.05, 1.1, 1.2 1.5, 2, 3, 4, 5, or 10 times larger than the size of representation 954a relative to three-dimensional environment 902). In some embodiments, displaying representation 954b according to the different scale in three-dimensional environment 902 has one or more characteristics of displaying the representation of the respective type of virtual object with the second value for the first visual characteristic according to the second scale as described with reference to method 1000.

In FIG. 9AA, computer system 101 detects an input corresponding to selection of affordance 918b (e.g., having one or more characteristics of the input shown and described with reference to FIG. 9W). In response to detecting the input in FIG. 9AA, computer system 101 displays menu 926b in FIG. 9BB. As shown in FIG. 9BB, indication 930 includes a different value of the current scale than shown in FIG. 9X (e.g., in FIG. 9BB, indication 930 reads a 40 percent scale as opposed to a 100 percent scale). For example, the difference in value of the current scale shown by indication 930 in FIG. 9BB compared to FIG. 9X corresponds to the difference in scale computer system 101 displays representation 954b at (e.g., automatically as described above) compared to representation 954a in three-dimensional environment 902 (e.g., because the size of representation 954b at the 100 percent scale exceeds the threshold amount described above).

FIGS. 9CC-9FF illustrate computer system 101 sharing respective representations of virtual object 901 (e.g., as shown in FIG. 9A) with a second computer system 903 in a communication session. For example, the communication session has one or more characteristics of the communication session described with reference to methods 800 and/or 1000.

In some embodiments, second computer system 903 has one or more characteristics of computer system 101 described above. As shown in FIGS. 9CC-9FF, second computer system 903 includes image sensors 913a through 913c (e.g., having one or more characteristics of images sensors 314a through 314c described above). In some embodiments, second computer system includes a display generation component 921 that is configured to display one or more virtual objects (e.g., virtual content, such as representation 916a) in a three-dimensional environment 970 (e.g., from a perspective of a user of second computer system 903). For example, display generation component 921 has one or more characteristics of display generation component 120 described above. For example, three-dimensional environment 970 has one or more characteristics of three-dimensional environment 902 described above. For example, three-dimensional environment 970 includes a representation of a physical environment of a user of second computer system 903 (e.g., the physical environment includes real-world door 968). For example, the user of second computer system 903 is located at a different physical location (e.g., in the real-world) from the user of computer system 101.

As shown in FIG. 9CC, while in the communication session, computer system 101 displays a virtual representation 964 of a participant of the communication session in three-dimensional environment 902 (e.g., from the perspective of the user of computer system 101). For example, virtual representation 964 corresponds to an avatar and/or virtual persona of the user of second computer system 903. For example, computer system 101 displays virtual representation 964 at a pose in three-dimensional environment 902 corresponding to a current viewpoint of the user of second computer system 903 (e.g., the location and/or orientation of the current viewpoint of the user of second computer system 903) relative to the communication session (e.g., a pose of virtual representation 964 corresponds to a spatial truth of the current viewpoint of the user of second computer system 903 in the communication session).

As shown in FIG. 9CC, while in the communication session, second computer system 903 displays a virtual representation 966 of a participant of the communication session in three-dimensional environment 902 (e.g., from the perspective of the user of second computer system 903). For example, virtual representation 966 corresponds to an avatar and/or virtual persona of the user of computer system 101. For example, second computer system 903 displays virtual representation 966 at a pose in three-dimensional environment 970 corresponding to a current viewpoint of the user of computer system 101 (e.g., the location and/or orientation of the current viewpoint of the user of second computer system 903) relative to the communication session (e.g., a pose of virtual representation 966 corresponds to a spatial truth of the current viewpoint of the user of computer system 101 in the communication session).

Alternatively, in some embodiments, computer system 101 and/or second computer system 903 displays non-spatial representations of the participants of the communication session. For example, computer system 101 displays a virtual window (e.g., associated with the communication session) in three-dimensional environment 902 that includes a representation of the user of second computer system 903 (e.g., the virtual window includes real-time video or computer-generated (e.g., simulated) video of the user of second computer system 903). For example, a pose of the virtual window in three-dimensional environment 902 does not correspond to a spatial truth of the current viewpoint of the user of second computer system 903 in the communication session (e.g., the virtual window is not displayed at a location and/or orientation corresponding to the current viewpoint of the user of second computer system 903). For example, second computer system 903 displays a virtual window (e.g., associated with the communication session) in three-dimensional environment 970 that includes a representation of the user of computer system 101 (e.g., the virtual window includes real-time video or computer-generated (e.g., simulated) video of the user of computer system 101). For example, the pose of the virtual window in three-dimensional environment 970 does not correspond to a spatial truth of the current viewpoint of the user of computer system 101 in the communication session (e.g., the virtual window is not displayed at a location and/or orientation corresponding to the current viewpoint of the user of computer system 101).

Computer system 101 optionally shares representation 916a in the communication session (e.g., with second computer system 903) (e.g., in response to an input corresponding to a request to share representation 916a). For example, while in the communication session and while displaying representation 916a in three-dimensional environment 902, computer system 101 presents a selectable option (e.g., an affordance) that is selectable to share representation 916a with second computer system 903 in the communication session. In some embodiments, the selectable option that is selectable to share representation 916a in the communication session corresponds to affordance 932 included in menu 926a (e.g., as shown and described with reference to FIG. 9F). In some embodiments, after computer system 101 detects selection of the selection option to share representation 916a with second computer system 903 in the communication session, second computer system 903 detects an indication (e.g., received from computer system 101) corresponding to a request to share representation 916 in the communication session. In some embodiments, in response to detecting the indication, second computer system 903 displays representation 916a in three-dimensional environment 970 from the perspective of the user of second computer system 903 (e.g., representation 916a is displayed with spatial truth in the communication session from the perspective of the user of second computer system 903). In some embodiments, in FIG. 9CC, in response to sharing representation 916a with second computer system 903 in the communication session, computer system 101 displays a visual indication 972 (e.g., adjacent (e.g., and/or above)) representation 916a from the perspective of the user of computer system 101) in three-dimensional environment 902. For example, visual indication 972 informs the user of computer system 101 that representation 916a is shared in the communication session (e.g., in response to ceasing to share representation 916a in the communication session, computer system 101 ceases to display visual indication 972 in three-dimensional environment 902).

In FIG. 9CC, computer system 101 displays representation 916a at a first pose in three-dimensional environment 902 from the perspective of the user of computer system 101 (e.g., viewing representation 916a at the first pose from the perspective of the user of computer system 101 corresponds to the spatial relationship shown between virtual representation 966 and representation 916a in three-dimensional environment 970). For example, at the first pose, computer system 101 displays representation 916a on and/or snapped to a surface of real-world table 906. As shown in FIG. 9CC, representation 916a includes representations of band 938a and display 940a. Further, in FIG. 9CC, second computer system 903 displays representation 916a (e.g., including band 938a and display 940a) at the first pose (e.g., location and/or orientation) in three-dimensional environment 970 from the perspective of the user of second computer system 903 (e.g., viewing representation 916a at the first pose from the perspective of the user of second computer system 903 corresponds to the spatial relationship shown between virtual representation 964 and representation 916a in three-dimensional environment 902). Second computer system 903 optionally does not display representation 916a snapped to a surface in three-dimensional environment 970 (e.g., because three-dimensional environment 970 does not include a surface at the location corresponding to the first pose). In some embodiments, representation 916a is selectable by participants in the communication session to change a pose of representation 916a (e.g., to move representation 916a from the perspective of participants in the communication session).

As shown in FIG. 9CC, computer system 101 displays affordances 918a and 918b in three-dimensional environment 902 from the perspective of the user of computer system 101, and second computer system 903 displays affordance 918a and 918b in three-dimensional environment 970 from the perspective of the user of second computer system 903 (e.g., selection of affordance 918a and/or 918b by the user of computer system 101 and/or by the user of second computer system 903 has one or more characteristics of selection of affordance 918a and/or 918b described with reference to FIG. 9B). In some embodiments, three-dimensional environment 970 does not include affordances 918a and/or 918b. For example, only the user of computer system 101 (e.g., the participant of the communication session sharing representation 916a) is permitted to perform the operation associated with selection of affordance 918a (e.g., displaying a user interface for purchasing a product associated with virtual object 901, such as the user interface included in virtual window 908 shown and described with reference to FIG. 9A) and/or to display a respective representation of virtual object 901 with a different visual appearance (e.g., including a different value for a respective visual characteristic) than representation 916a (e.g., by selecting one or more selectable options included in menu 926a shown and described with reference to FIGS. 9F-9H).

In FIG. 9DD, computer system 101 detects an input corresponding to selection of affordance 918b (e.g., the input has one or more characteristics of the input shown and described with reference to FIG. 9E). In response to detecting the input in FIG. 9DD, computer system 101 displays menu 926a in three-dimensional environment 902 from the perspective of the user of computer system 101 in FIG. 9EE. As shown in FIG. 9EE, second computer system 903 does not display menu 926a in three-dimensional environment 970 from the perspective of the user of second computer system 903. Alternatively, in some embodiments, after computer system 101 detects the input in FIG. 9DD, second computer system 903 detects an indication (e.g., from computer system 101) corresponding to the selection of affordance 918b. For example, in response to detecting the indication, second computer system 903 displays menu 926a in three-dimensional environment 970 from the perspective of the user of second computer system 903 (e.g., in response to detecting an indication (e.g., from computer system 101) that one or more respective selectable options are displayed in three-dimensional environment 902 from the perspective of the user of computer system 101, second computer system 903 displays the one or more respective selectable options in three-dimensional environment 970 from the perspective of the user of second computer system 903). In some embodiments, computer system 101 displaying menu 926a in three-dimensional environment 902 in FIG. 9DD includes one or more characteristics of computer system 101 displaying menu 926a in three-dimensional environment 902 in FIG. 9F (e.g., in FIG. 9DD, menu 926a is displayed with a respective spatial relationship with respect to representation 916a in three-dimensional environment 902).

From FIG. 9DD to FIG. 9EE, computer system 101 displays selectable options 934a through 934c in three-dimensional environment 902 (e.g., in response to detecting an input corresponding to selection of selectable option 928c, such as the input shown and described with reference to FIG. 9G). In FIG. 9EE, computer system 101 detects an input corresponding to selection of selectable option 934b (e.g., corresponding to the second value for the third visual characteristic described with reference to FIG. 9H). For example, the input includes an air gesture (e.g., air pinch) performed by hand 914 while gaze 912 is directed to selectable option 934b. For example, the input shown in FIG. 9EE corresponds to a request to display a representation of virtual object 901 with the second value for the third visual characteristic (e.g., the representation of virtual object 901 with the second value for the third visual characteristic has a different value for the third visual characteristic than representation 916a). For example, the representation of virtual object 901 with the second value for the third visual characteristic corresponds to a representation of virtual object 901 with a different band than band 938a of representation 916a (e.g., a band of a different color than band 938a).

In response to detecting the input in FIG. 9EE, computer system 101 displays a representation 916d in three-dimensional environment 902 from the perspective of the user of computer system 101 in FIG. 9FF (e.g., from FIG. 9EE to FIG. 9FF, computer system 101 optionally displays visual indication 936 in three-dimensional environment 902, as shown and described with reference to FIG. 9I). For example, representation 916d corresponds to the representation of virtual object 901 with the second value for the third visual characteristic described above. As shown in FIG. 9FF, computer system 101 displays representation 916d with a band 938d (e.g., and without band 938a of representation 916a). For example, band 938d has a different color from band 938a of representation 916a (e.g., as shown by the different fill-pattern of band 938d in FIG. 9FF compared to band 938a in FIG. 9EE) (e.g., the color of band 938d corresponds to the second value for the third visual characteristic, and the color of band 938a corresponds to a respective value different from the second value (e.g., the first value or the third value) for the third visual characteristic). In FIG. 9FF, computer system 101 displays representation 916d at the same pose (e.g., the first pose) in three-dimensional environment 902 that computer system 101 displayed representation 916a at in three-dimensional environment 902 in FIGS. 9CC-9EE (e.g., prior to detecting the input in FIG. 9EE).

In some embodiments, after computer system 101 detects the input in FIG. 9EE, second computer system 903 detects an indication (e.g., received from computer system 101) corresponding to a request to display representation 916d in the communication session. In some embodiments, in response to detecting the indication, second computer system 903 displays representation 916a in three-dimensional environment 970 from the perspective of the user of second computer system 903. In some embodiments, second computer system 903 displays representation 916a at the same pose (e.g., the first pose) in three-dimensional environment 902 that second computer system 903 displayed representation 916a at in three-dimensional environment 970 in FIGS. 9CC-9EE (e.g., prior to detecting the indication).

FIGS. 9GG-9JJ illustrate an alternative embodiment of computer system 101 (e.g., compared to FIGS. 9A-9FF) displaying respective representations of virtual object 901 (e.g., as shown in FIG. 9A) in three-dimensional environment 902. In FIGS. 9GG-9JJ, computer system 101 corresponds to a tablet (e.g., different from the head-mounted device shown in FIGS. 9A-9FF). In some embodiments, computer system 101 includes a plurality of image sensors, including image sensor(s) 314d shown in FIGS. 9GG-9JJ (e.g., having one or more characteristics of image sensors 314a-314c described with reference to FIG. 9A). In some embodiments, in FIGS. 9GG-9JJ, display generation component 120 corresponds to a touch display.

In some embodiments, in FIGS. 9GG-9JJ, computer system 101 views a different region of three-dimensional environment 902 compared to the regions of three-dimensional environment 902 viewed in FIGS. 9A-9FF. For example, as shown in FIGS. 9GG-9JJ, a real-world surface 980 and a real-world window 978 are visible (e.g., via display generation component 120) in three-dimensional environment 902.

In FIG. 9GG, computer system 101 displays representation 916a in three-dimensional environment 902 at a first pose. In some embodiments, at the first pose, computer system 101 displays representation 916a on and/or snapped to a real-world surface 980 in three-dimensional environment 902. As shown in FIG. 9GG, representation 916a includes a representation of band 938a and display 940b. As shown in in FIG. 9GG, computer system 101 displays a plurality of affordances in three-dimensional environment 902. For example, computer system 101 displays affordance 918a (e.g., affordance 918a is selectable to perform an operation associated with representation 916a as described with reference to FIG. 9B) and affordance 918b (e.g., affordance 918b is selectable to display a plurality of selectable options corresponding to one or more visual characteristics of representation 916a). For example, computer system 101 displays an affordance 974 that is optionally selectable to cease display of representation 916a in three-dimensional environment 902 (e.g., affordance 974 is selectable to exit a preview mode associated with the respective application described with reference to FIG. 9A and/or to display a user interface similar to the user interface included in virtual window 908 in FIG. 9A). For example, computer system 101 displays an affordance 976 that is selectable to share representation 916a (e.g., such as affordance 932 shown and described with reference to FIG. 9F).

In FIG. 9GG, computer system 101 detects a touch input 990a (e.g., schematically represented by a dashed oval) corresponding to selection of affordance 918b. For example, touch input 990a corresponds to a tap input performed using an object (e.g., a finger of a user of computer system 101). In response to detecting touch input 990a in FIG. 9GG, computer system 101 displays a menu 926c in FIG. 9HH. In some embodiments, in FIG. 9HH, computer system 101 displays menu 926c as a viewpoint-locked virtual object. For example, computer system 101 displays menu 926c at a fixed display location relative to a current viewpoint of the user of computer system 101. As shown in FIG. 9GG, menu 926c is displayed superimposed on the view of three-dimensional environment 902 (e.g., menu 926c is at least partially obstructs a view of three-dimensional environment 902 from the current viewpoint of the user of computer system 101). In some embodiments, displaying menu 926c has one or more characteristics of displaying the plurality of selectable options in the three-dimensional environment with the first spatial relationship with respect to the current viewpoint of the user of the computer system described with reference to method 1000.

As shown in FIG. 9HH, menu 926c includes a plurality of selectable options (e.g., selectable options 982a through 982b, selectable options 984a through 984b, and selectable options 986a through 986c). In some embodiments, the plurality of selectable options correspond to values of respective visual characteristics that computer system 101 can display respective representations of virtual object 901 with in three-dimensional environment 902. For example, selectable option 982a corresponds to a first value for a first visual characteristic (e.g., a first display size of a smart watch) and selectable option 982b corresponds to a second value, different from the first value, for the first visual characteristic (e.g., a second display size, different from the first display size, of a smart watch). For example, selectable option 984a corresponds to a first value for a second visual characteristic, different from the first visual characteristic (e.g., a first material of a case of a smart watch), and selectable option 984b corresponds to a second value, different from the first value, for the second visual characteristic (e.g., a second material, different from the first material, of a case of a smart watch). For example, selectable option 986a corresponds to a first value for a third visual characteristic (e.g., a first color of a band of a smart watch), selectable option 986b corresponds to a second value, different from the first value, for the third visual characteristic (e.g., a second color, different from the first color, of a band of a smart watch), and selectable option 986c corresponds to a third value, different from the first value and the second value, for the third visual characteristic (e.g., a third color, different from the first color and the second color, of a band of a smart watch). In some embodiments, the plurality of selectable options are selectable through touch inputs (e.g., having one or more characteristics of touch input 990a shown and described with reference to FIG. 9GG). As shown in FIG. 9HH, selectable option 982a, selectable option 984a, and selectable option 986a are currently selected in menu 926c (e.g., selectable options 982a, 984a, and 986a have the current focus in menu 926c (e.g., as shown by the rectangles surrounding selectable options 982a, 984a, and 986a)). For example, representation 916a includes the first value for the first visual characteristic (e.g., the first size of display), the first value for the second visual characteristic (e.g., the first case material), and the first value for the third visual characteristic (e.g., the first band color).

As shown in FIG. 9GG, menu 926c includes an indication 988 of a scale that representation 916a is displayed according to in three-dimensional environment 902 (e.g., indication 988 has one or more characteristics of indication 930 shown and described with reference to FIG. 9F).

FIGS. 9HH-9II include a top-down view 992. Top-down view 992 illustrates a user 994 of computer system 101 viewing three-dimensional environment 902 from a current viewpoint (e.g., represented by arrow 996). Top-down view 992 includes schematic representations of representation 916a and real-world surface 980.

From FIG. 9HH to FIG. 9II, user 994 changes their current viewpoint relative to three-dimensional environment 902 (e.g., as shown by the difference in location of user 994 in top-down view in FIG. 9II compared to FIG. 9HH). For example, user 994 moves (e.g., while holding computer system 101) farther from a location corresponding to representation 916a in three-dimensional environment 902. In response to detecting the change of the current viewpoint of user 944 relative to three-dimensional environment 902, computer system 101 maintains display of menu 926c at the fixed display location in FIG. 9II (e.g., the same display location that menu 926c was displayed at by computer system 101 in FIG. 9HH). For example, displaying menu 926c at the fixed display location in response to detecting the change in the current viewpoint of user 944 from FIG. 9HH to FIG. 9II has one or more characteristics of displaying the plurality of selectable options with the first spatial relationship with respect to the second viewpoint of the user as described with reference to method 1000.

In FIG. 9II, computer system 101 detects a touch input 990b (e.g., schematically represented by a dashed oval) corresponding to selection of selectable option 986c (e.g., touch input 990b has one or more characteristics of touch input 990a shown and described with reference to FIG. 9GG). For example, touch input 990b corresponds to a request to display a representation of virtual object 901 with the third value for the third visual characteristic (e.g., the third band color) in three-dimensional environment 902. For example, the representation of virtual object 901 with the third value for the third visual characteristic includes a different band from band 938a of representation 916a.

In response to detecting the input in FIG. 9II, computer system 101 displays a representation 916e at the first pose in three-dimensional environment 902 in FIG. 9JJ (e.g., at the same pose (e.g., the same location and/or orientation) relative to three-dimensional environment 902 that computer system 101 displayed representation 916a at in FIGS. 9GG-9II). For example, computer system 101 displays representation 916e on and/or snapped to real-world surface 980 (e.g., in the same manner (e.g., at the same location and/or orientation relative to real-world surface 980) as representation 916a).

In some embodiments, representation 916e corresponds to the representation of virtual object 901 with the third value for the third visual characteristic described above. For example, as shown in FIG. 9JJ, computer system 101 displays representation 916e with a representation of a band 938e (e.g., and not with band 938a of representation 916a). For example, band 938e corresponds to the third value for the third visual characteristic (e.g., associated with selectable option 986c included in menu 926c). For example, band 938e of representation 916e (e.g., as shown in FIG. 9JJ) includes a different color from the color of band 938a of representation 916a (e.g., as shown in FIGS. 9GG-9II).

FIG. 10 is a flowchart illustrating an exemplary method 1000 of displaying a representation of a respective type of virtual object in a three-dimensional environment. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system (e.g., computer system 101 as shown in FIG. 9A) in communication with one or more display generation components (e.g., display generation component 120 as shown in FIG. 9A) and one or more input devices (e.g., image sensors 314a through 314c as shown in FIG. 9A). In some embodiments, the computer system has one or more characteristics of the computer system of method 800. In some embodiments, the one or more display generation components have one or more characteristics of the one or more display generation components of method 800. In some embodiments, the one or more input devices have one or more characteristics of the one or more input devices of method 800.

In some embodiments, while displaying, via the one or more display generation components, a representation of a respective type of virtual object at a first pose (e.g., spatial configuration, location and/or orientation) in a three-dimensional environment (e.g., representation 916a displayed in three-dimensional environment 902 as shown in FIG. 9E), wherein the displayed representation of the respective type of virtual object includes a first value for a first visual characteristic (e.g., the color of band 938a of representation 916a as shown in FIG. 9E), the computer system receives (1002) a request to display a representation of the respective type of virtual object with a second value for the first visual characteristic, wherein the second value for the first visual characteristic is different from the first value for the first visual characteristic, such as the selection of selectable option 934a shown in FIG. 9H. In some embodiments, the three-dimensional environment has one or more characteristics of the three-dimensional environment described with reference to method 800. In some embodiments, the computer system moves the representation to the first pose in the three-dimensional environment in response to user input. For example, the representation is selectable and/or movable by a user of the computer system in the three-dimensional environment (e.g., in response to an input including attention (e.g., based on gaze, cursor, and/or hand position) and/or a hand gesture that optionally includes movement (e.g., an air pinch)). In some embodiments, the representation is a two-dimensional or a three-dimensional virtual object displayed in the three-dimensional environment. In some embodiments, the respective type of virtual object corresponds to a respective type of real-world object (e.g., the representation is a virtual representation of the real-world object). For example, the real-world object is an electronic device and/or a computer system (e.g., a mobile phone, laptop, wearable device (e.g., a smart watch or head-mounted display), tablet, monitor, or television). For example, the real-world object is a physical product (e.g., that is optionally not an electronic device), such as furniture, clothing, jewelry, or kitchenware. In some embodiments, the respective type of virtual object corresponds to (e.g., is a virtual representation of) a real-world object that includes multiple available configurations. For example, displaying the representation of the respective type of virtual object with the first value for the first visual characteristic corresponds to displaying a representation of the respective type of virtual object with a first configuration (e.g., model) of a plurality of configurations (e.g., a plurality of models) of the respective type of virtual object. In some embodiments, the first visual characteristic corresponds to a physical feature of the real-world object that is represented by the representation, such as a size and/or color of the real-world object (e.g., or the size and/or color of one or more components of the real-world object). For example, the first value of the first visual characteristic corresponds to a first size and/or color of the real-world object (e.g., or a first size and/or color of one or more components of the real-world object). In some embodiments, the computer system displays the representation in the three-dimensional environment with a size that is scaled to the real-world size of the real-world object (e.g., the size of the representation of the respective type of virtual object relative to the three-dimensional environment corresponds to the real size of the real-world object relative to the three-dimensional environment). In some embodiments, the first visual characteristic corresponds to one or more components included in the first configuration of the respective type of virtual object (e.g., a second configuration, different from the first configuration, of the respective type of virtual object does not include the one or more components). For example, a first configuration of the real-world object (e.g., corresponding to the first configuration of the respective type of virtual object) includes one or more hardware components (e.g., a case, or one or more input devices (e.g., cameras)) that a second configuration, different from the first configuration, of the real-world object does not include. In some embodiments, the first visual characteristic corresponds to a first component of the respective type of virtual object. For example, the respective type of virtual object corresponds to an electronic device, the first visual characteristic corresponds to a display of the electronic device, and the first value corresponds to a first size of the display included in the representation of the respective type of virtual object. In some embodiments, the request to display the representation of the respective type of virtual object with the second value for the first visual characteristic includes one or more inputs detected by the one or more input devices of the computer system. For example, the request to display the representation of the respective type of virtual object with the second value for the first visual characteristic includes a sequence of inputs (e.g., the sequence of inputs includes a first input including selection of a first selectable option (e.g., corresponding to the second value for the first visual characteristic) and a second input including selection of a second selectable option, different from the first selectable option (e.g., corresponding to a respective value of a second visual characteristic, different from the first visual characteristic). In some embodiments, the request to display a representation of the respective type of virtual object with the second value for the first characteristic corresponds to a request to change the display of the representation of the respective type of virtual object from a representation of a first configuration of the respective type of virtual object (e.g., including one or more first components and/or features) to a representation of a second configuration, different from the representation of the first configuration, of the respective type of virtual object (e.g., including one or more second components and/or physical features, different from the one or more first components and/or physical features). For example, the request to display the representation of the respective type of virtual object with the second value for the first visual characteristic corresponds to a request to replace the first value for the first visual characteristic with the second value for the first visual characteristic (e.g., the first value corresponds to a first size and/or color of a component of the representation of the respective type of virtual object, and the second value corresponds to a second size and/or color of the component, different from the first size and/or color of the component). In some embodiments, the request to display the representation of the respective type of virtual object with the second value for the first visual characteristic includes selection of a selectable option (e.g., or selection of a plurality of selectable options corresponding to one or more values of one or more respective visual characteristics of the respective type of virtual object) displayed in the three-dimensional environment (e.g., in a menu including a plurality of selectable options corresponding to a plurality of respective values of one or more respective visual characteristics of the representation of the respective type of virtual object, as described below). In some embodiments, the request to display the representation of the respective type of virtual object with the second value for the first visual characteristic corresponds to an input detected by a second computer system, different from the computer system (e.g., the input is performed by a user of the second computer system). For example, while the computer system is in a communication session (e.g., having one or more characteristics of the communication session described below) with the second computer system, the first computer system receives an indication corresponding to the request to display the respective type of virtual object with the second value for the first visual characteristic.

In some embodiments, in response to receiving the request to display a representation of the respective type of virtual object with the second value for the first visual characteristic, the computer system displays (1004), via the one or more display generation components, a representation of the respective type of virtual object with a second value for the first visual characteristic with the first pose in the three-dimensional environment, wherein displaying the virtual object with the second value for the first visual characteristic includes displaying the virtual object without the first value for the first visual characteristic, such as representation 916b including band 938b (e.g., having a different color from band 938a shown in FIG. 9E) displayed in three-dimensional environment 902 as shown in FIG. 9J. In some embodiments, displaying the representation of the respective type of virtual object with the second value for the first visual characteristic includes displaying a representation of a different configuration and/or model of the respective type of virtual object from the configuration and/or model of the respective type of virtual object previously represented (e.g., the respective type of virtual object corresponds to a real-world electronic device, the representation of the respective type of virtual object with the first value for the first visual characteristic corresponds to a first model of the electronic device, and the representation of the respective type of virtual object with the second value for the first visual characteristic corresponds to a second model, different from the first model, of the electronic device (e.g., the first model of the electronic device includes one or more components with a different size and/or color from the second model of the electronic device, and/or the first model of the electronic device includes a first set of components and the second model of the electronic device includes a second set of components, different from the first set of components)). In some embodiments, in response to the request to display a representation of the respective type of virtual object with the second value for the first visual characteristic, the computer system displays a representation of the respective type of virtual object with the second value for the first visual characteristic at the same pose (e.g., location and/or orientation) in the three-dimensional environment that the representation of the respective type of virtual object with the first value for the first visual characteristic was displayed at when (or prior to when) the request to display the representation of the respective type of virtual object with the second value for the first visual characteristic was received (e.g., the user of the computer system previously moved the representation of the respective type of virtual object with the first value for the first visual characteristic to the first pose prior to requesting to display a representation of the respective type of virtual object with the second value for the first visual characteristic). In some embodiments, the computer system displays a representation of the respective type of virtual object at the first pose with a reduced visual prominence (e.g., opacity, color, and/or brightness) while the first visual characteristic is changed (e.g., by gradually increasing the visual prominence (e.g., opacity, color, and/or brightness) of at least a portion of the representation associated with the first visual characteristic (e.g., over 0.1, 0.2, 0.5, 1, 2, 5, or 10 seconds)). In some embodiments, displaying the representation of the respective type of virtual object with the second value for the first visual characteristic includes displaying a representation of the respective type of virtual object with a different visual appearance from the representation of the respective type of virtual object with the first value for the first visual characteristic. For example, at least a first portion of the respective type of virtual object includes a first visual appearance when the respective type of virtual object is represented with the first value for the first visual characteristic, and the at least the first portion of the respective type of virtual object includes a second visual appearance, different from the first visual appearance, when the respective type of virtual object is represented with the second value for the first visual characteristic (e.g., the at least the first portion of the respective type of virtual object is associated with the first visual characteristic). In some embodiments, in response to the request to display a representation of the respective type of virtual object with the second value for the first visual characteristic, the computer system displays the representation of the respective type of virtual object with the second value for the first visual characteristic without ceasing to display a second visual characteristic, different from the first visual characteristic. For example, the first visual characteristic is associated with a different component of the real-world object that is represented by the representation than the second visual characteristic. Maintaining a pose of a representation of a virtual object in a three-dimensional environment in response to a request to change a visual characteristic of the virtual object enables a user to change a visual appearance of the virtual object (e.g., while previewing the appearance of the virtual object in an XR environment) without moving the virtual object from a user preferred location and/or orientation, thereby improving user device interaction and conserving computing resources associated with user inputs to correct a change in pose of the virtual object.

In some embodiments, displaying the representation of the respective type of virtual object with the first value for the first visual characteristic includes displaying the respective type of virtual object with a first size in the three-dimensional environment, such as the size of representation 916a relative to three-dimensional environment 902 as shown in FIG. 9E. In some embodiments, displaying the representation of the respective type of virtual object with the second value for the first visual characteristic includes displaying the respective type of virtual object with the first size in the three-dimensional environment, such as the size of representation 916b relative to three-dimensional environment 902 as shown in FIG. 9J. In some embodiments, the first visual characteristic corresponds to a property that is different from the size of the respective type of virtual object (e.g., the first visual characteristic corresponds to scale, color, and/or a model of the respective type of virtual object). In some embodiments, the first size of the representation of the respective type of virtual object is relative to the three-dimensional environment. For example, the representation of the respective type of virtual object with the second value for the first visual characteristic has the same size relative to the three-dimensional environment as the representation of the respective type of virtual object with the first value for the first visual characteristic. In some embodiments, the first size of the representation of the respective type of virtual object corresponds to a display size (e.g., a size relative to a current viewpoint of a user of the computer system). For example, the representation of the respective type of virtual object with the second value for the first visual characteristic has the same display size relative to the three-dimensional environment as the representation of the respective type of virtual object with the first value for the first visual characteristic. Maintaining a size of a representation of a virtual object in a three-dimensional environment in response to a request to change a visual characteristic of the virtual object enables a user to change a visual appearance of the virtual object (e.g., while previewing the appearance of the virtual object in an XR environment) without changing the virtual object from a user preferred size, thereby improving user device interaction and conserving computing resource associated with user inputs to correct a size of the virtual object.

In some embodiments, displaying the representation of the respective type of virtual object with the first value for the first visual characteristic includes displaying the representation of the respective type of virtual object according to a first scale relative to a reference scale for the respective type of virtual object in the three-dimensional environment, such as computer system 101 displaying representation 954a according to the scale (e.g., as represented by indication 930) as shown in FIG. 9X. In some embodiments, displaying the representation of the respective type of virtual object with the second value for the first visual characteristic includes displaying the representation of the respective type of virtual object according to a second scale, different from the first scale, relative to the reference scale for the respective type of virtual object in the three-dimensional environment, such as computer system 101 displaying representation 954b according to the scale (e.g., as represented by indication 930) as shown in FIG. 9BB. In some embodiments, the first visual characteristic corresponds to a size of the respective type of virtual object (e.g., the first value corresponds to a first size, and the second value corresponds to a second size, different from the first size). In some embodiments, the first visual characteristic corresponds to a model of the respective type of virtual object (e.g., the first value corresponds to a first model including a first size, and the second value corresponds to a second model, different from the first model, including a second size different from the first size). In some embodiments, the reference scale corresponds to a range of sizes that the respective type of virtual object is able to be displayed with in the three-dimensional environment. For example, at a respective value corresponding to 100 percent on the reference scale, electronic device displays a representation of the respective type of virtual object with a size in three-dimensional environment that corresponds to a real-life size of the respective type of virtual object (e.g., the respective type of virtual object corresponds to an electronic device, such as a laptop, and the real-life size corresponds to a physical size of the electronic device). In some embodiments, the representation of the respective type of virtual object according to the first scale relative to the reference scale has the same size (e.g., relative to the three-dimensional environment) as the representation of the respective type of virtual object according to the second scale relative to the reference scale. In some embodiments, the computer system displays the representation of the respective type of virtual object with the second value for the first visual characteristic with a different scale from the representation of the respective type of virtual object with the first value for the first visual characteristic automatically (e.g., without user input corresponding to a request to represent the respective type of virtual object at a different scale). In some embodiments, in accordance with a determination that a representation of the respective type of virtual object has a size relative to the three-dimensional environment that exceeds a threshold amount (e.g., a dimension that is more than 0.5, 1, 2, 5, 10, 15, 20, 25, 50 or 100 meters and/or a dimension that exceeds a current field of view of a user of the computer system), the computer system displays the representation of the respective type of virtual object according to a scale relative to the reference scale that is less than 100 percent (e.g., automatically (e.g., without user input requesting to change the scale of the representation)). In some embodiments, in accordance with a determination that a representation of the respective type of virtual object has a size relative to the three-dimensional environment that is less than a threshold amount (e.g., a dimension that is less than 0.01, 0.05, 0.1, 0.5, or 1 meter), the computer system displays the representation of the respective type of virtual object according to a scale that is greater than 100 percent relative to the reference scale (e.g., automatically (e.g., without user input request to change the scale of the representation)). In some embodiments, in accordance with a determination that the respective type of virtual object with the second value for the first visual characteristic has a respective size that differs from the representation of the respective type of virtual object with the first value for the first visual characteristic by more than a threshold amount (e.g., the representation of the respective type of virtual object with the second value for the first visual characteristic is 1.05, 1.1, 1.2, 1.5, 2, 3, 4, 5, or 10 times larger than the representation of the respective type of virtual object with the first value for the first visual characteristic), the computer system displays the representation of the respective type of virtual object with the second value for the first visual characteristic at a different scale relative to the reference scale than the representation of the respective type of virtual object with the first value for the first visual characteristic (e.g., automatically (e.g., without user input requesting to change the scale of the representation)). Changing a scale of a representation of a virtual object in a three-dimensional environment in response to a request to change a visual characteristic of the virtual object enables a visual appearance of the virtual object (e.g., while previewing the appearance of the virtual object in an XR environment) without changing a user preferred size of the representation of the virtual object relative to the three-dimensional environment, thereby improving user device interaction and conserving computing resources associated with user inputs to correct a change in size of the virtual object.

In some embodiments, displaying the representation of the respective type of virtual object with the first value for the first visual characteristic includes displaying the representation of the respective type of virtual object at a first orientation in the three-dimensional environment, such as the orientation of representation 916a in three-dimensional environment 902 as shown in FIG. 9E. In some embodiments, the first orientation in the three-dimensional environment corresponds to an environment-locked orientation (e.g., the representation of the respective type of virtual object corresponds to an environment-locked virtual object). In some embodiments, while displaying the representation of the respective type of virtual object at the first orientation in the three-dimensional environment, the computer system detects a change in viewpoint of the user of the computer system relative to the three-dimensional environment. In some embodiments, in response to detecting the change in viewpoint, the computer system maintains display of the representation of the respective type of virtual object at the first orientation in the three-dimensional environment.

In some embodiments, displaying the representation of the respective type of virtual object with the second value for the first visual characteristic includes displaying the representation of the respective type of virtual object at the first orientation in the three-dimensional environment, such as the orientation of representation 916b in three-dimensional environment 902 as shown in FIG. 9J. In some embodiments, the first orientation is relative to the three-dimensional environment. For example, the computer system displays the representation of the respective type of virtual object with the first value for the first visual characteristic at the same orientation relative to the three-dimensional environment as the representation of the respective type of virtual object with the second value for the first visual characteristic. In some embodiments, the first orientation is relative to a current viewpoint of a user of the computer system (e.g., independent of an orientation relative to the three-dimensional environment). For example, the computer system displays the representation of the respective type of virtual object with the first value for the first visual characteristic at the same orientation relative to the current viewpoint of the user as the representation of the respective type of virtual object with the first value for the first visual characteristic (e.g., the representation of the respective type of virtual object with the first value for the first visual characteristic is displayed at a first orientation relative to a first viewpoint of the user, and the representation of the respective type of virtual object with the second value for the first visual characteristic is displayed at the first orientation relative to a second viewpoint of the user, different from the first viewpoint of the user). In some embodiments, the computer system displays the representation of the respective type of virtual object with the second value for the first visual characteristic at the same location in the three-dimensional environment as the representation of the respective type of virtual object with the first value for the first visual characteristic. Maintaining an orientation of a representation of a virtual object in a three-dimensional environment in response to a request to change a visual characteristic of the virtual object enables a user to change a visual appearance of the virtual object (e.g., while previewing the appearance of the virtual object in an XR environment) without moving the virtual object from a user preferred orientation, thereby improving user device interaction and conserving computing resources associated with user inputs to correct a change in orientation of the virtual object.

In some embodiments, displaying the representation of the respective type of virtual object with the first value for the first visual characteristic includes displaying the representation of the respective type of virtual object snapped to a first surface in the three-dimensional environment, such as displaying representation 916b snapped to the surface of real-world table 906 as shown in FIG. 9M. In some embodiments, snapping the representation of the respective type of virtual object to the first surface includes displaying the representation of the respective type of virtual object on or near (e.g., within a threshold distance of) the first surface in the three-dimensional environment (e.g., from a current viewpoint of the user of the computer system). For example, the computer system displays a portion (e.g., a bottom portion (e.g., from the current viewpoint of the user of the computer system)) of the representation of the respective type of virtual object aligned with the first surface in the three-dimensional environment (e.g., from the current viewpoint of the user of the computer system). For example, the computer system displays the portion (e.g., the bottom portion) of the representation of the respective type of virtual object at a position (e.g., location and/or orientation) that is less than a threshold distance (e.g., less than 0.001, 0.05, 0.01, 0.05, or 0.1 meters) from the first surface in the three-dimensional environment (e.g., from the current viewpoint of the user of the computer system). In some embodiments, displaying the representation of the respective type of virtual object snapped to the first surface in the three-dimensional environment includes applying a virtual attractive force between the first surface and at least a portion (e.g., the bottom portion) of the representation of the respective type of virtual object (e.g., the virtual attractive force has one or more characteristics of the virtual attractive force described with reference to method 800). For example, while displaying the representation of the respective type of virtual object snapped to the first surface in the three-dimensional environment, in response to detecting an input corresponding to a request to move the representation of the respective type of virtual object from (e.g., away from) the first surface in the three-dimensional environment, the computer system at least partially resists the movement of the representation of the respective type of virtual object from (e.g., away from) the first surface in the three-dimensional environment. In some embodiments, displaying a representation of the respective type of virtual object snapped to the first surface includes one or more characteristics of snapping a virtual object to a surface (e.g., and/or moving a virtual object to a location closer to the location of a surface (e.g., the first surface)) as described with reference to method 800.

In some embodiments, displaying the representation of the respective type of virtual object with the second value for the first visual characteristic includes displaying the respective type of virtual object snapped to the first surface in the three-dimensional environment, such as displaying representation 916c snapped to the surface of real-world table 906 as shown in FIG. 9V. In some embodiments, the first surface corresponds to a virtual surface that is displayed in the three-dimensional environment (e.g., a computer-generated surface included in a virtual environment). In some embodiments, the first surface corresponds to a surface of a representation of a physical object visible in the three-dimensional environment (e.g., in video passthrough). In some embodiments, the first surface has one or more characteristics as one or more surfaces described with reference to method 800. In some embodiments, the representation of the respective type of virtual object with the second value for the first visual characteristic is snapped to the first surface at the same orientation and/or location as the representation of the respective type of virtual object with the first value for the first visual characteristic. Maintaining a representation of a virtual object snapped to a surface in a three-dimensional environment in response to a request to change a visual characteristic of the virtual object enables a user to change a visual appearance of the virtual object (e.g., while previewing the appearance of the virtual object in an XR environment) without moving the virtual object from a user preferred surface, thereby improving user device interaction and conserving computing resources associated with user inputs to correct movement of the representation of the virtual object from the surface.

In some embodiments, the first value corresponds to a first color for the respective type of virtual object, such as the color of band 938a of representation 916a as shown in FIG. 9H. In some embodiments, the second value corresponds to a second color for the respective type of virtual object, and the second color is different from the first color, such as the color of band 938b of representation 916b as shown in FIG. 9J. In some embodiments, displaying the representation of the respective type of virtual object with the second value for the first visual characteristic includes displaying one or more second visual characteristics, different from color, with the same value as the representation of the respective type of virtual object with the first value for the first visual characteristic. For example, the computer system displays the representation of the respective type of virtual object with the second value for the first visual characteristic with the same size and/or at the same scale as the representation of the respective type of virtual object with the first value for the first visual characteristic. In some embodiments, the first value and/or the second value for the first visual characteristic corresponds to a color of at least a portion of the respective type of virtual object (e.g., the entire exterior of the respective type of virtual object, or of a component of the respective type of virtual object). In some embodiments, the first visual characteristic has a plurality of selectable values corresponding to different colors of a component of the respective type of virtual object (e.g., of one or more surfaces of the respective type of virtual object). In some embodiments, the plurality of values for the first visual characteristic corresponds to different patterns and/or textures of at least a portion of the respective type of virtual object (e.g., a texture, pattern, and/or exterior design of a component of the respective type of virtual object (e.g., the design of a band of a smart watch, which optionally includes one or more textures, patterns, and/or colors)). Maintaining a pose of a representation of a virtual object in a three-dimensional environment in response to a request to change a color of the virtual object enables a user to change the color of the virtual object (e.g., while previewing the appearance of the virtual object in an XR environment) without moving the virtual object from a user preferred location and/or orientation, thereby improving user device interaction and conserving computing resources associated with user inputs to correct a change in pose of the virtual object.

In some embodiments, the first value corresponds to a first size for the respective type of virtual object, such as the size of representation 916b as shown in FIG. 9T (e.g., as shown relative to ruler 952 in close-up view 920 as shown in FIG. 9T). In some embodiments, the second value corresponds to a second size for the respective type of virtual object, and the second size is different from the first size, such as the size of representation 916c as shown in FIG. 9V (e.g., as shown relative to ruler 952 in close-up view 920 as shown in FIG. 9V). In some embodiments, displaying the representation of the respective type of virtual object with the second value for the first visual characteristic includes displaying one or more second visual characteristics, different from size, with the same value as the representation of the respective type of virtual object with the first value for the first visual characteristic. For example, the computer system displays the representation of the respective type of virtual object with the second value for the first visual characteristic with the same color as the representation of the respective type of virtual object with the first value for the first visual characteristic. In some embodiments, the first value and/or the second value for the first visual characteristic corresponds to a size of at least a portion of the respective type of virtual object (e.g., the overall size of the respective type of virtual object, or the size of a component of the respective type of virtual object (e.g., a size of a display of an electronic device)). In some embodiments, the first visual characteristic has a plurality of selectable values corresponding to different sizes of at least a portion of the respective type of virtual object (e.g., of one or more components of the respective type of virtual object. In some embodiments, in accordance with a determination that the representation of the respective type of virtual object with the second size differs from (e.g., is greater than or smaller than) the representation of the respective type of virtual object with the first size by more than a threshold amount (e.g., the representation of the respective type of virtual object with the second size is 1.05, 1.1, 1.2, 1.5, 2, 3, 4, 5, or 10 times larger than the representation of the respective type of virtual object with the first size), the computer system displays the representation of the respective type of virtual object with the second size at a different scale than the representation of the respective type of virtual object with the first size (e.g., automatically (e.g., without user input)). Maintaining a pose of a representation of a virtual object in a three-dimensional environment in response to a request to change a size of the virtual object enables a user to change the size of the virtual object (e.g., while previewing the appearance of the virtual object in an XR environment) without moving the virtual object from a user preferred location and/or orientation, thereby improving user device interaction and conserving computing resources associated with user inputs to correct a change in pose of the virtual object.

In some embodiments, the first size includes a first length along a first dimension in the three-dimensional environment, such as the length (e.g., and/or height) of representation 916b shown relative to ruler 952 in close-up view 920 as shown in FIG. 9T. In some embodiments, displaying the representation of the respective type of virtual object with the second size includes scaling the respective type of virtual object to a second length, different from the first length, along the first dimension in the three-dimensional environment in a first direction and not in a second direction, opposite from the first direction, such as computer system 101 scaling representation 916c upward (e.g., from the surface of real-world table 906 (e.g., from the current viewpoint of the user of computer system 101)) as shown in FIG. 9V. In some embodiments, the first dimension corresponds to a height of the respective type of virtual object (e.g., corresponding to a vertical axis in the three-dimensional environment). In some embodiments, the first direction is an upward direction along a vertical axis in the three-dimensional environment, and the second direction is a downward direction along the vertical axis in the three-dimensional environment. In some embodiments, the first direction is a downward direction along the vertical axis in the three-dimensional environment, and the second direction is an upward direction along the vertical axis in the three-dimensional environment. For example, scaling the respective type of virtual object to the second length along the first dimension in the first direction includes scaling the size of the respective type of virtual object from the bottom of the respective type of virtual object. For example, scaling the respective type of virtual object to the second length along the first dimension in the second direction includes scaling the size of the respective type of virtual object from the top of the respective type of virtual object. In some embodiments, the representation of the respective type of virtual object with the second value for the first visual characteristic includes a different height from the representation of the respective type of virtual object with the first value for the first visual characteristic. For example, displaying the representation of the respective type of virtual object with the second value for the first visual characteristic includes expanding a height of the respective type of virtual object in the first direction (e.g., in an upward direction and not a downward direction). For example, displaying the representation of the respective type of virtual object with the second value for the first visual characteristic includes decreasing a height of the respective type of virtual object in the first direction (e.g., in a downward direction and not an upward direction). In some embodiments, when the request to display the representation of the respective type of virtual object with the second value for the first visual characteristic is received, the representation of the respective type of virtual object with the first value for the first visual characteristic is displayed on (e.g., snapped to) a surface in the three-dimensional environment (e.g., having one or more characteristics of snapping an object on a surface as described with reference to method 800). In some embodiments, displaying the representation of the respective type of virtual object with the second value for the first visual characteristic includes increasing a size of the respective type of virtual object in a direction away from (e.g., upward from) the surface, and not in a direction toward the surface (e.g., such that the increased size of the representation of the respective type of virtual object with the second value for the first visual characteristic does not spatially and/or visually conflict with the surface). In some embodiments, displaying the representation of the respective type of virtual object with the second value for the first visual characteristic includes decreasing a size of the respective type of virtual object in a direction toward (e.g., downward to) the surface, and not in a direction away from the surface (e.g., such that the decreased size of the representation of the respective type of virtual object with the second value for the first visual characteristic remains displayed on (e.g., snapped to) the surface). Scaling a representation of a virtual object in a three-dimensional environment in a first direction and not in a second direction in response to a request to change a size of the virtual object enables a user to change the size of the virtual object (e.g., while previewing the appearance of the virtual object in an XR environment) while preventing spatial and/or visual conflicts with one or more surfaces in the three-dimensional environment, thereby improving user device interaction and conserving computing resources associated with user input to correct the change in size of the virtual object.

In some embodiments, the first value corresponds to a first model for generating a representation of the respective type of virtual object, such as the model of virtual object 901 (e.g., as shown in FIG. 9A) represented by representation 916b as shown in FIG. 9M (e.g., including display 940a). In some embodiments, the second value corresponds to a second model for generating a representation of the respective type of virtual object, and the second model is different from the first model, such as the model of virtual object 901 represented by representation 916c as shown in FIG. 9V (e.g., including display 940b). In some embodiments, the first model of the respective type of virtual object and the second model of the respective type of virtual object have one or more characteristics of the first model and/or the second model described above. For example, the first model corresponds to a first configuration of the respective type of virtual object (e.g., including a first set of features and/or components) and the second model corresponds to a second configuration, different from the first configuration, of the respective type of virtual object (e.g., including a second set of features and/or components, different from the first set of features and/or components). In some embodiments, the first model includes one or more first visual features and the second model includes one or more second visual features, different from the one or more first visual features. For example, the respective type of virtual object corresponds to a piece of furniture, the first model includes a first size, color, and/or material of the piece of furniture, and the second model includes a second size, color, and/or material of the piece of furniture different from the first size, color, and/or material). For example, the respective type of virtual object is a smart watch, the first model includes a first display size and/or a first band color, and the second model includes a second display size and/or a second band color, different from the first display size and/or first band color. In some embodiments, the respective type of virtual object corresponds to an electronic device, the first model includes one or more first specifications (e.g., technical specifications) and/or features (e.g., a first set of hardware components and/or technical capabilities), and the second model includes one or more second specifications and/or features, different from the one or more first specifications and/or features (e.g., a second set of hardware components, different from the first set of hardware components and/or technical capabilities). In some embodiments, the computer system displays the first model of the respective type of virtual object using information retrieved from a first file associated with the first model of the respective type of virtual object, and displays the second mode of the respective type of virtual object using information retrieved from a second file, different from the first file, associated with the second model of the respective type of virtual object. For example, after retrieving the information from the second file associated with the second model of the respective type of virtual object, the computer system displays that second model of the respective type of virtual object at the same pose in the three-dimensional environment that the first model of the respective type of virtual object was displayed at. Maintaining a pose of a representation of a virtual object in a three-dimensional environment in response to a request to change a model of the virtual object displayed in the three-dimensional environment enables a user to change the model of the virtual object displayed (e.g., while previewing the appearance of the virtual object in an XR environment) without moving the virtual object from a user preferred location and/or orientation, thereby improving user device interaction and conserving computing resources associated with users inputs to correct a change in pose of the virtual object.

In some embodiments, before displaying the representation of the respective type of virtual object with the second value for the first visual characteristic, the computer system displays, via the one or more display generation components, a visual indication in the three-dimensional environment while the representation of the respective type of virtual object with the second value for the first visual characteristic is rendered, wherein displaying the representation of the respective type of virtual object with the second value for the first visual characteristic is after displaying the visual indication in the three-dimensional environment, such as computer system 101 displaying visual indication 936 in three-dimensional environment 902 as shown in FIG. 9U while representation 916c (e.g., shown in FIG. 9V) is rendered. In some embodiments, displaying the representation of the respective type of virtual object with the second value for the first visual characteristic in the three-dimensional environment includes ceasing to display the visual indication in the three-dimensional environment. In some embodiments, the computer system displays the visual indication at the same location and/or orientation in the three-dimensional environment that the representation of the respective type of virtual object with the first value for the first visual characteristic was displayed at (e.g., and at the same location and/or orientation in the three-dimensional environment that the representation of the respective type of virtual object with the second value for the first visual characteristic will be displayed at). In some embodiments, the computer displays a representation of the respective type of virtual object (e.g., with the first value for the first visual characteristic or the second value for the first visual characteristic) in the three-dimensional environment while displaying the visual indication (e.g., the visual indication is displayed after the representation of the respective type of virtual object with the first value for the first visual characteristic ceases to be displayed in the three-dimensional environment and before the representation of the respective type of virtual object with the second value for the first visual characteristic is displayed in the three-dimensional environment). In some embodiments, the visual indication includes text (e.g., a message including the word “loading” or “rendering”). In some embodiments, the visual indication includes a symbol and/or logo (e.g., a loading bar and/or a wheel or circle including one or more hash marks). In some embodiments, the visual indication changes in visual appearance as the representation of the respective type of virtual object with the second value for the first visual characteristic is rendered (e.g., a shading of a bar and/or hash marks arranged in a circle change while the visual indication is displayed). The change of visual appearance of visual indication optionally represents the progress of rendering (e.g., by changing a percentage that is displayed representing rendering progress, and/or by changing the value indicated by a loading bar). In some embodiments, the computer system displays the visual indication in the three-dimensional environment in accordance with a determination that the representation of the respective type of virtual object with the second value for the first visual characteristic is displayed using information retrieved from a different file from the representation of the respective type of virtual object with the first value for the first visual characteristic (e.g., the visual indication is displayed while the computer system retrieves information from a file associated with the representation of the respective type of virtual object with the second value for the first visual characteristic and/or renders the representation of the respective type of virtual object with the second value for the first visual characteristic in the three-dimensional environment). Displaying a visual indication in a three-dimensional environment while rendering a virtual object with a changed visual characteristic provides a guided and continuous user interface for previewing the appearance of the virtual object by indicating to a user viewing the three-dimensional environment that the appearance of the virtual object is currently being changed, thereby avoiding errors in interaction and improving user device interaction.

In some embodiments, while displaying, via the one or more display generation components, the representation of the respective type of virtual object in the three-dimensional environment, the computer system displays, via the one or more display generation components, a plurality of selectable options in the three-dimensional environment, wherein the plurality of selectable options are associated with a plurality of visual characteristics of the respective type of virtual object, such as computer system 101 displaying menu 926a in three-dimensional environment 902 including selectable options 928a through 928c and selectable options 934a through 934c as shown in FIG. 9H. In some embodiments, the computer system displays the plurality of selectable options in response to a request to display the plurality of selectable options in the three-dimensional environment (e.g., corresponding to selection of an affordance displayed in the three-dimensional environment that is selectable to display the plurality of selectable options in the three-dimensional environment). For example, in response to the request to display the plurality of selectable options in the three-dimensional environment, the computer system displays the plurality of selectable options at a default spatial arrangement (e.g., the first spatial arrangement as described below) relative to the current pose of the representation of the respective type of virtual object (e.g., the default spatial arrangement is defined by the computer system and/or stored in a memory). In some embodiments, the computer system displays the plurality of selectable options within a user interface (e.g., corresponding to a menu) in the three-dimensional environment. For example, the computer system displays the user interface including the plurality of selectable options within a virtual object and/or window in the three-dimensional environment. In some embodiments, the plurality of selectable options correspond to one or more visual characteristics of the respective type of virtual object. In some embodiments, in response to detecting selection of a selectable option of the plurality of options, wherein the selectable option corresponds to a respective value for a respective visual characteristic for the respective type of virtual object, the computer system displays a representation of the respective type of virtual object with the respective value for the respective visual characteristic (e.g., and ceases to display a representation of the respective type of virtual object with a different value for the respective visual characteristic). In some embodiments, a first set of selectable options of the plurality of selectable options correspond to the first visual characteristic of the respective type of virtual object (e.g., the first value for the first visual characteristic and the second value for the first visual characteristic are selectable options within the first set of selectable options). For example, the first visual characteristic corresponds to a size of the respective type of virtual object, the first value corresponds to a first selectable option that is selectable to display a representation of the respective type of virtual object with a first size, and the second value corresponds to a second selectable option, different from the first selectable option, that is selectable to display a representation of the respective type of virtual object with a second size, different from the first size. In some embodiments, a second set of selectable options, different from the first set of selectable options, of the plurality of selectable options corresponds to a second visual characteristic, different from the first visual characteristic, of the respective type of virtual object. For example, the second visual characteristic corresponds to a color of at least a portion of the respective type of virtual object, and the second set of selectable options includes a first value corresponding to a first selectable option that is selectable to display a representation of the respective type of virtual object including a first color of the at least the portion of the respective type of virtual object, and a second value corresponding to a second selectable option, different from the first selectable option, that is selectable to display a representation of the respective type of virtual object including a second color, different from the first color, of the at least the portion of the respective type of virtual object. In some embodiments, a first selectable option of the plurality of selectable options are selectable through a user input that includes a user of the computer system directing attention (e.g., based on gaze, cursor, and/or hand position) toward the first selectable option while concurrently performing a respective air gesture (e.g., an air tap, air drag (e.g., air pinch and drag), air pinch, or air long pinch (e.g., an air pinch for a threshold amount of time, such as 0.1, 0.2, 0.5, 1, 2, 5, or 10 seconds)). Displaying a plurality of selectable options in a three-dimensional environment that are selectable to change one or more visual characteristics of a representation of a virtual object displayed in a three-dimensional environment provides a continuous and guided user interface for previewing the appearance of the virtual object by enabling a user to change a visual appearance of the virtual object without requiring the user to cease the visual preview of the virtual object, thereby reducing errors in interaction and conserving computing resources associated with user inputs to cease the visual preview of the virtual object.

In some embodiments, while displaying the representation of the respective type of virtual object with the first value for the first visual characteristic (e.g., at the first pose) in the three-dimensional environment, and while displaying the plurality of selectable options in the three-dimensional environment with a first spatial relationship with respect to the representation of the respective type of virtual object (e.g., from a first viewpoint of a user of the computer system), the computer system detects, via the one or more input devices, a change of a current viewpoint of a user of the computer system relative to the three-dimensional environment (e.g., from the first viewpoint relative to the three-dimensional environment to a second viewpoint, different from the first viewpoint, relative to the three-dimensional environment), such as computer system 101 detecting the change in the current viewpoint of user 944 (e.g., shown in top-down view 942) relative to three-dimensional environment 902 while menu 926a is displayed in three-dimensional environment 902 as shown from FIG. 9O to FIG. 9P. In some embodiments, displaying the plurality of selectable options with the first spatial arrangement relative to the representation of the respective type of virtual object with the first value for the first visual characteristic includes displaying the plurality of selectable options (e.g., the menu and/or virtual window including the plurality of selectable options) at a second pose in the three-dimensional environment. For example, the second pose corresponds to a respective distance and/or orientation relative to the current pose (e.g., the first pose) of the representation of the respective type of virtual object with the first value for the first visual characteristic. In some embodiments, in response to detecting a user input corresponding to a request to change a location (e.g., and optionally orientation) of the representation of the respective type of virtual object with the first value for the first visual characteristic in the three-dimensional environment, in accordance with a determination that the plurality of selectable options are displayed in the three-dimensional environment, the computer system moves the representation of the respective type of virtual object with the first value for the first visual characteristic in accordance with the user input and moves the plurality of selectable options in the three-dimensional environment to maintain display of the plurality of selectable options with the first spatial arrangement relative to the representation of the respective type of virtual object with the first value for the first visual characteristic (e.g., the computer system moves the plurality of selectable options from the second pose to a third pose, different from the second pose, having the first spatial arrangement with the current pose of the representation of the respective type of virtual object with the first value for the first visual characteristic).

In some embodiments, in response to detecting the change of the current viewpoint of the user of the computer system relative to the three-dimensional environment (e.g., from the first viewpoint to the second viewpoint), the computer system displays, via the one or more display generation components, the plurality of selectable options in the three-dimensional environment with the first spatial relationship with respect to the representation of the respective type of virtual object with the first value for the first visual characteristic (e.g., from the second viewpoint of the user), such as computer system 101 maintaining display of menu 926a with the respective spatial relationship with respect to representation 916b as shown from FIG. 9O to FIG. 9P. In some embodiments, the computer system displays the plurality of selectable options as environment-locked in the three-dimensional environment. In some embodiments, maintaining display of the plurality of selectable options with the first spatial arrangement relative to the representation of the respective type of virtual object with the first value for the first visual characteristic includes maintaining display of the plurality of selectable options (e.g., and/or the menu and/or virtual window that includes the plurality of selectable options) at the same location and/or orientation in the three-dimensional environment (e.g., such that a spatial arrangement between the plurality of selectable options and the viewpoint of the user of the computer system changes). In some embodiments, the plurality of selectable options are displayed at a fixed location in the three-dimensional environment (e.g., with the first spatial relationship with a representation of the respective type of virtual object) in accordance with the computer system corresponding to a head-mounted display (e.g., and not when the computer system corresponds to a mobile phone, laptop, and/or tablet). Displaying a plurality of selectable options for changing a visual appearance of a representation of a virtual object with a spatial relationship relative to a current pose of the virtual object provides a continuous and guided user interface for previewing the appearance of the virtual object by displaying the selectable options in a region of the three-dimensional environment that a user is already directing attention to, thereby reducing errors in interaction and improving user device interaction.

In some embodiments, while displaying the representation of the respective type of virtual object with the first value for the first visual characteristic in the three-dimensional environment, and while displaying the plurality of selectable options in the three-dimensional environment with a first spatial relationship with respect to a current viewpoint of a user of the computer system (e.g., while the user has a first viewpoint relative to the three-dimensional environment), the computer system detects a change in the current viewpoint of the user of the computer system from a first viewpoint relative to the three-dimensional environment to a second viewpoint, different from the first viewpoint, relative to the three-dimensional environment, such as computer system 101 detecting the change in the current viewpoint of user 994 (e.g., shown in top-down view 992) relative to three-dimensional environment 902 while menu 926c is displayed as shown from FIG. 9HH to FIG. 9II. In some embodiments, displaying the plurality of selectable options in the three-dimensional environment includes displaying the plurality of selectable options (e.g., and/or the menu and/or virtual window that includes the plurality of selectable options) at a fixed display location (e.g., at a fixed location and/or orientation relative to the current viewpoint of the user of the computer system). For example, in response to a request to change a pose of the representation of the respective type of virtual object with the first value for the first visual characteristic in the three-dimensional environment (e.g., from the first pose to a second pose, different from the first pose), the computer system moves the representation of the respective type of virtual object with the first value for the first visual characteristics and forgoes moving the plurality of selectable options in the three-dimensional environment (e.g., to maintain display of the plurality of selectable options at the same display location).

In some embodiments, in response to detecting the change in the current viewpoint of the user of the computer system (e.g., from the first viewpoint to the second viewpoint), the computer system displays the plurality of selectable options with the first spatial relationship with respect to the second viewpoint of the user (e.g., while the user has the second viewpoint relative to the three-dimensional environment), such as computer system 101 maintaining display of menu 926c as viewpoint-locked (e.g., at the same display location) as shown from FIG. 9HH to FIG. 9II. In some embodiments, the computer system displays the plurality of selectable options as viewpoint-locked in the three-dimensional environment (e.g., relative to a current viewpoint of the user of the computer system). In some embodiments, displaying the plurality of selectable options with the first spatial relationship with the second viewpoint of the user includes maintaining display of the plurality of selectable options at the same location and/or orientation relative to the current viewpoint of the user. In some embodiments, displaying the plurality of selectable options with the first spatial relationship with the second viewpoint of the user includes changing the location and/or orientation of the plurality of selectable options relative to the three-dimensional environment (e.g., to maintain the same spatial relationship with the current viewpoint of the user as a result of the change in viewpoint). In some embodiments, the computer system displays the plurality of selectable options at a fixed display location (e.g., at an upper, lower, and/or side region of a display relative to the current viewpoint of the user of the computer system). For example, in response to moving the representation of the respective type of virtual object with the first value for the first visual characteristic in the three-dimensional environment (e.g., in response to user input), the computer system maintains display of the plurality of selectable options at the fixed display location. In some embodiments, the plurality of selectable options are displayed at the fixed display location in accordance with the computer system corresponding to a mobile phone, laptop, and/or tablet. Displaying a plurality of selectable options for changing a visual appearance of a representation of a virtual object with a spatial relationship relative to a current viewpoint of a user viewing the virtual object in a three-dimensional environment provides a continuous and guided user interface for changing the appearance of the virtual object by enabling a user to complete selection of the one or more visual characteristics of the virtual object the user desires to change when a user moves their viewpoint away from a location of the virtual object, thereby reducing errors in interaction and improving user device interaction.

In some embodiments, while displaying, via the one or more display generation components, the representation of the respective type of virtual object with the first value for the first visual characteristic in the three-dimensional environment, the computer system displays, via the one or more display generation components, an affordance in the three-dimensional environment that is selectable to perform an operation associated with the respective type of virtual object, such as affordance 918a and/or affordance 918b shown in FIG. 9A. In some embodiments, the computer system displays the affordance that is selectable to perform the operation associated with the respective type of virtual object adjacent to the representation of the respective type of virtual object with the first value for the first visual characteristic (e.g., below, above, or to a side of the representation of the respective type of virtual object with the first value for the first visual characteristic). In some embodiments, the computer system displays the affordance that is selectable to perform the operation associated with the respective type of virtual object adjacent to an affordance that is selectable to display the plurality of selectable options (e.g., as described above). For example, the computer system displays the affordance that is selectable to perform the operation associated with the respective type of virtual object and the affordance that is selectable to display the plurality of selectable options within the same virtual object (e.g., the virtual object is displayed adjacent to the representation of the respective type of virtual object with the first value for the first visual characteristic). In some embodiments, the computer system displays the affordance that is selectable to perform the operation associated with the respective type of virtual object at a location in the three-dimensional environment that is independent of the representation of the respective type of virtual object with the first value for the first visual characteristic (e.g., and/or independent of an affordance to display the plurality of selectable options).

In some embodiments, while displaying the affordance in the three-dimensional environment, the computer system detects, via the one or more input devices, an input corresponding to selection of the affordance, such as the selection of affordance 918b shown in FIG. 9E. In some embodiments, detecting the input that includes detecting attention (e.g., of a user of the computer system (e.g., based on gaze, cursor, and/or hand position)) toward the affordance and a respective air gesture (e.g., an air tap, air drag (e.g., air pinch and drag), air pinch, or air long pinch (e.g., an air pinch for a threshold amount of time, such as 0.1, 0.2, 0.5, 1, 2, 5, or 10 seconds). For example, the attention directed toward the affordance with the respective air gesture are performed concurrently by the user of the computer system.

In some embodiments, in response to detecting the input corresponding to selection of the affordance, the computer system performs the operation associated with the respective type of virtual object in the three-dimensional environment, such as computer system 101 displaying virtual window 908 in three-dimensional environment 902 in FIG. 9A and/or computer system 101 displaying menu 926a in three-dimensional environment 902 as shown in FIG. 9F. In some embodiments, the operation includes displaying a user interface for purchasing a product corresponding to the respective type of virtual object in the three-dimensional environment. For example, the user interface includes one or more selectable options for purchasing the product corresponding to the respective type of virtual object. In some embodiments, the operation includes displaying a user interface that includes information associated with a product corresponding to the respective type of virtual object. For example, the information associated with the product includes specifications of the product (e.g., and/or specifications of different models of the product, such as different models of an electronic device (e.g., a mobile phone, laptop, or smart watch)). Displaying an affordance that is selectable to perform an operation associated with a virtual object while a representation of the virtual object is displayed in a three-dimensional environment provides a continuous and guided user interface for previewing the appearance of the virtual object by providing a user the option to perform an operation associated with the virtual object (e.g., displaying a user interface for purchasing a product associated with the virtual object) while the representation of the virtual object is visible to the user, thereby improving user device interaction and conserving computing resources associated with additional user inputs to perform the operation.

In some embodiments, the representation of the respective type of virtual object with the first value for the first visual characteristic is displayed using information retrieved from a respective file associated with the respective type of virtual object, such as computer system 101 using information retrieved from a respective file to display representation 916a as shown in FIG. 9B. In some embodiments, the representation of the respective type of virtual object with the second value for the first visual characteristic is displayed using information retrieved from the respective file associated with the respective type of virtual object, such as computer system 101 using information retrieved from a respective file (e.g., the same respective file used to display representation 916a in FIG. 9B) to display representation 916b as shown in FIG. 9J. In some embodiments, the information corresponds to metadata stored in the respective file associated with the respective type of virtual object. In some embodiments, in response to receiving the request to display a representation of the respective type of virtual object with the second value for the first visual characteristic, the computer system accesses the respective file associated with the respective type of virtual object and retrieves the metadata stored in the respective file. For example, the computer system displays the representation of the respective type of virtual object with the second value for the first visual characteristic using the metadata retrieved from the respective file. In some embodiments, the respective file (e.g., and the information included in the respective file) is stored in a memory of the computer system. In some embodiments, the respective file is associated with an application that is accessible to a user through the computer system. For example, the application is for previewing one or more respective types of virtual objects in the three-dimensional environment (e.g., for previewing different models and/or visual appearances of a respective type of virtual object). In some embodiments, the respective file associated with the respective type of virtual object includes information associated with one or more respective visual characteristics of the respective type of virtual object, different from the first visual characteristic. For example, the first visual characteristic corresponds to a size of a component of the respective type of virtual object, and the respective file includes information associated with a second visual characteristic corresponding to a color of a component of the respective type of virtual object. In some embodiments, the computer system retrieves information from different respective files based on the type of virtual object that is displayed (e.g., as a representation) in the three-dimensional environment. For example, in accordance with a determination that the respective type of virtual object is a virtual object of a first type, the computer system retrieves information from a first file associated with the first type of virtual object, and in accordance with a determination that the respective type of virtual object is a virtual object of a second type, different from the first type, the computer system retrieves information from a second file, different from the first file, associated with the second type of virtual object. For example, the first file and the second file are associated with the same respective application for previewing one or more virtual objects in the three-dimensional environment (e.g., and are stored in a memory of the computer system).

For example, the first type of virtual object corresponds to a first type of electronic device (e.g., a mobile phone) and the second type of virtual object corresponds to a second type of electronic device, different from the first type (e.g., a laptop). Retrieving information from a file to display a representation of a respective type of virtual object with a first visual appearance, and retrieving information from the same file to display a representation of the respective type of virtual object with a second visual appearance, different from the first visual appearance, conserves memory and processing resources by preventing the need to parse data from separate sources to change the appearance of the same type of virtual object.

In some embodiments, the request to display the representation of the respective type of virtual object with the second value for the first visual characteristic corresponds to a selection of a selectable option of a plurality of selectable options displayed in the three-dimensional environment, such as the input corresponding to selection of selectable option 948b shown in FIG. 9R. In some embodiments, the selectable option of the plurality of selectable options has one or more characteristics of one or more of the plurality of selectable options described above (e.g., the first selectable option). In some embodiments, selection of the selectable option has one or more characteristics of selection of the first selectable option described above.

In some embodiments, after (e.g., and/or in response to) receiving the request to display the representation of the respective type of virtual object with the second value for the first visual characteristic, in accordance with a determination that more than a first time threshold has elapsed since the selection of the selectable option (e.g., and optionally in accordance with a determination that one or more different selectable options of the plurality of selectable options have not been selected within the first time threshold), the computer system displays the representation of the respective type of virtual object with the second value for the first visual characteristic in the three-dimensional environment, such as computer system 101 displaying representation 938c in three-dimensional environment 902 as shown in FIG. 9V after the threshold amount of time has elapsed (e.g., as shown by time glyph 950 in FIG. 9U) since detecting selection of selectable option 934b as shown in FIG. 9T. In some embodiments, the first time threshold is 0.1, 0.2, 0.5, 1, 2, 5, 10, 15, or 30 seconds.

In some embodiments, after (e.g., and/or in response to) receiving the request to display the representation of the respective type of virtual object with the second value for the first visual characteristic, in accordance with a determination that less than the first time threshold has elapsed since the selection of the selectable option, the computer system maintains display of the representation of the respective type of virtual object with the first value for the first visual characteristic in the three-dimensional environment (e.g., without displaying the representation of the respective type of virtual object with the second value for the first visual characteristic), such as computer system 101 maintaining display of representation 916b in three-dimensional environment 902 as shown in FIG. 9S after less than the threshold amount of time (e.g., as shown by time glyph 950 in FIG. 9S) has elapsed since detecting selection of selectable option 948b as shown in FIG. 9R. In some embodiments, in accordance with the determination that less than the first time threshold has elapsed since the selection of the selectable option, the computer system delays the display of the representation of the respective type of virtual object with the second value for the first visual characteristic (e.g., until the first time threshold has elapsed since selection of a respective selectable option of the plurality of selectable options). In some embodiments, in response to detecting selection of a selectable option of the plurality of selectable options, the computer system resets the first time threshold (e.g., such that the computer system maintains display of the representation of the respective type of virtual object with the first value for the first visual characteristic until an amount of time corresponding to the first time threshold has passed since the last selection of a selectable option of the plurality of selectable options). In some embodiments, in accordance with a determination that the selection of the selectable option occurred within the first time threshold (e.g., the first time threshold has not elapsed since the selection of the selectable option), the computer system maintains display of the plurality of selectable options in the three-dimensional environment (e.g., additionally, or alternatively, to maintaining display of the representation of the respective type of virtual object with the first value for the first visual characteristic). In some embodiments, after the selection of the selectable option of the plurality of selectable options, the computer system receives a request to display a representation of the respective type of virtual object with the second value for the first visual characteristic and a third value for a second visual characteristic, different from the first visual characteristic. For example, a user of the computer system selects a second selectable option, different from the selectable option, of the plurality of selectable options corresponding to the third value for the second visual characteristic (e.g., selection of the second selectable option is made within the first time threshold from selection of the selectable option). In some embodiments, after the selection of the second selectable option of the plurality of selectable options, in accordance with a determination more than the first time threshold has elapsed since the selection of the second selectable option occurred, the computer system displays the representation of the respective type of virtual object with the second value for the first visual characteristic and the third value for the second visual characteristic. In some embodiments, after the selection of the second selectable option of the plurality of selectable options, in accordance with a determination that less than the first time threshold has elapsed since the selection of the second selectable option, the computer system maintains display of the representation of the respective type of virtual object with the first value for the first visual characteristic (e.g., without displaying the representation of the respective type of virtual object with the second value for the first visual characteristic and the third value for the second visual characteristic). In some embodiments, the computer system maintains display of the representation of the respective type of virtual object with the first value for the first visual characteristic during and/or after a plurality of inputs corresponding to selection of a portion of the plurality of selectable options (e.g., the computer system maintains display of the representation of the respective type of virtual object with the first value for the first visual characteristic until the first time threshold has elapsed since the computer system detected a respective input of the plurality of inputs). Displaying a representation of a virtual object when selection of a selectable option associated with the appearance of the virtual object occurred in time beyond a first time threshold ensures a user has completed selection of the visual characteristics they prefer prior to rendering the representation of the virtual object, thereby conserving computing resources associated with rendering the representation of the virtual object with an appearance the user did not intend and correcting the appearance of the representation of the virtual object through additional user input.

In some embodiments, while sharing the representation of the respective type of virtual object with the second value for the first visual characteristic in a communication session with a second computer system, different from the computer system (e.g., the communication session between computer system 101 and second computer system 903 shown in FIGS. 9CC-9FF), wherein the computer system is associated with a first user and the second computer system is associated with a second user, the computer system receives, from the second computer system, an indication corresponding to a request to display a representation of the respective type of virtual object with a third value, different from the second value, for the first visual characteristic from a perspective of the second user, such as the indication detected by second computer system 903 (e.g., from computer system 101) corresponding to the request to display representation 916d as shown in FIG. 9EE. In some embodiments, the communication session has one or more characteristics of the communication session described with reference to method 800. In some embodiments, the communication session is associated with a respective application accessible through the computer system (e.g., by the first user) and the second computer system (e.g., by the second user), such as an application for facilitating real-time video and/or audio calls (e.g., through the reception and transmission of audio and/or video signals). In some embodiments, the communication session is a real-time (e.g., or nearly real-time) communication session that includes audio (e.g., real-time voice audio from the first user and/or the second user, and/or audio content from content shared between the first user and the second user), video (e.g., real-time video of the first user and/or the second user, and/or video content from content shared between the first user and the second user), and/or other shared content (e.g., virtual representations (e.g., representations of virtual environments, avatars, and/or personas associated with the first user and/or the second user), images, applications, and/or interactive media (e.g., video game media)). In some embodiments, the communication session includes simulated and/or computer-generated video (e.g., by changing one or more visual characteristics of an avatar) and/or real-time video of the plurality of users and/or real-world objects (e.g., captured by one or more cameras of the computer system and/or second computer system). In some embodiments, a representation of the respective type of virtual object is displayed in the three-dimensional environment and is visible from a perspective of the second user (e.g., in a three-dimensional environment visible via one or more display generation components of the second computer system). In some embodiments, the indication is received from the second computer system in the communication session. In some embodiments, the indication is a signal received from the second computer system (e.g., through a network such as a personal, local, or wide area network), or from one or more servers in communication with the computer system and the second computer system. In some embodiments, the request to display the representation of the respective type of virtual object with the third value for the first visual characteristic has one or more characteristics of the request to display the representation of the respective type of virtual object with the second value for the first visual characteristic described above. For example, the request is performed by the second user at the second computer system (e.g., by selecting a selectable option of a plurality of selectable options displayed in a three-dimensional environment that is visible to the second user via one or more display generation components of the second computer system (e.g., the selectable option of the plurality of selectable options has one or more characteristics of the first selectable option and/or the plurality of selectable options described above)). In some embodiments, the first user views the respective type of virtual object from a different viewpoint (e.g., perspective) than the second user (e.g., the first user and the second user view modifications to the visual appearance of the respective type of virtual object from different perspectives). In some embodiments, the first user views the respective type of virtual object from a viewpoint corresponding to a spatial relationship between a virtual representation of the first user and the respective type of virtual object in a view of the communication session from the perspective of the second user (e.g., in a second three-dimensional environment visible to the second user at the second computer system). In some embodiments, the second user views the respective type of virtual object from a viewpoint corresponding to a spatial relationship between a virtual representation of the second user and the respective type of virtual object in a view of the communication session from the perspective of the first user (e.g., in the three-dimensional environment).

In some embodiments, in response to receiving the indication from the second computer system, the computer system displays, via the one or more display generation components, a representation of the respective type of virtual object with the third value for the first visual characteristic in the three-dimensional environment from a perspective of the first user, such as second computer system 903 displaying representation 916d in three-dimensional environment 970 as shown in FIG. 9FF. In some embodiments, displaying the representation of the respective type of virtual object with the third value for the first visual characteristic includes displaying the representation of the respective type of virtual object without the second value (e.g., and/or without the first value) for the first visual characteristic. In some embodiments, in response to the request to display the representation of the respective type of virtual object with the third value for the first visual characteristic, the second computer system displays, via one or more display generation components of the second computer system, the representation of the respective type of virtual object with the third value for the first visual characteristic from a perspective of the second user (e.g., in a three-dimensional environment that is visible to the second user via the one or more display generation components of the second computer system). Alternatively, in some embodiments, while sharing the representation of the respective type of virtual object with the second value for the first visual characteristic in the communication session with the second computer system, the computer system receives a request to display the representation of the respective type of virtual object with the third value for the first visual characteristic (e.g., the request is performed by the first user of the computer system). In some embodiments, in response to receiving the request to display the representation of the respective type of virtual object with the third value for the first visual characteristic, the second computer system displays, via one or more display generations of the second computer system, the representation of the respective type of virtual object with the third value for the first visual characteristic from the perspective of the second user, wherein displaying the representation of the respective type of virtual object with the third value for the first visual characteristic includes displaying the representation of the respective type of virtual object without the second value for the first visual characteristic from the perspective of the second user (e.g., the representation of the respective type of virtual object with the third value for the first visual characteristic is displayed in a three-dimensional environment that is visible to the second user via one or more display generation components of the second computer system). In some embodiments, in response to the request to display the representation of the respective type of virtual object with the third value for the first visual characteristic, the computer system displays, via the one or more display generation components, the representation of the respective type of virtual object with the third value for the first visual characteristic. In some embodiments, in accordance with a determination that the communication session with the second computer system is terminated, the computer system ceases to display a representation of the respective type of virtual object shared by the second computer system in the three-dimensional environment from the perspective of the first user. For example, the computer system removes one or more values for one or more visual characteristics that were selected by the second user of the second computer system (e.g., the computer system ceases to display the representation of the respective type of virtual object with the third value for the first visual characteristics (e.g., and optionally displays the representation of the respective type of virtual object with the second value for the first visual characteristic)). In some embodiments, in accordance with a determination that the communication session with the computer system is terminated, the second computer system ceases to display a representation of the respective type of virtual object shared by the computer system in a three-dimensional environment from the perspective of the second user. For example, the second computer system removes one or more value for one or more visual characteristics that were selected by first user of the first computer system. Changing a visual appearance of a representation of a virtual object that is shared in a communication session from a perspective of a first user in response to a request made by a second user in the communication session, different from the first user, to change the visual appearance of the representation of the virtual object prevents errors in interaction in the communication session by ensuring the participants are previewing the same appearance of the virtual object and conserves computing resources by avoiding requiring the first user to manually change (e.g., through additional user inputs) the appearance of the virtual object from their perspective.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

In some embodiments, aspects/operations of methods 800 and/or 1000 may be interchanged, substituted, and/or added between these methods. For example, the three-dimensional environments of methods 800 and/or 1000, the virtual objects (e.g., representations of respective type of virtual objects) of methods 800 and/or 1000, the surfaces (e.g., virtual and/or physical surfaces) of methods 800 and/or 1000, the moving of virtual objects of methods 800 and/or 1000, the snapping of virtual objects of methods 800 and/or 1000, the attention and attention-based inputs (e.g., selection inputs) of methods 800 and/or 1000, and/or the communication sessions of methods 800 and/or 1000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method, comprising:
at a computer system in communication with a display generation component and one or more input devices:
while displaying, via the display generation component, a virtual object at a first location that is a first distance from a first surface in a three-dimensional environment, detecting a first input, via the one or more input devices, corresponding to moving the virtual object to a second location within the three-dimensional environment that is at a second distance, different from the first distance, from the first surface, wherein the first location is further than a threshold distance from the first surface and the second location is closer than the threshold distance from the first surface; and
in response to detecting the first input:
in accordance with a determination that one or more snapping criteria are satisfied while the virtual object is the second distance from the first surface, moving the virtual object to a third location that is closer to the first surface than the first location and the second location; and
in accordance with a determination that the one or more snapping criteria are not satisfied while the virtual object is the second distance from the first surface, moving the virtual object to the second location without moving the virtual object closer to the first surface.

2. The method of claim 1, wherein the first surface corresponds to a detected physical surface in a physical environment that corresponds to the three-dimensional environment.

3. The method of claim 1, wherein the one or more snapping criteria include a criterion that is satisfied when a speed of the virtual object at the second location within the three-dimensional environment is below a threshold speed.

4. The method of claim 1, wherein:
the one or more snapping criteria include a criterion that is satisfied when moving the virtual object from the first location to the second location includes moving the virtual object toward the first surface from a first direction; and
the one or more snapping criteria include a criterion that is not satisfied when moving the virtual object from the first location to the second location includes moving the virtual object toward the first surface from a second direction, different from the first direction.

5. The method of claim 4, wherein:
the first direction corresponds to moving the virtual object toward the first surface from above the first surface; and
the second direction corresponds to moving the virtual object toward the first surface from below the first surface.

6. The method of claim 1, wherein:
in accordance with a determination that the virtual object has a first movement characteristic, the threshold distance from the first surface, that is used to determine how the virtual object moves in response to detecting the first input, is a first threshold distance from the first surface; and
in accordance with a determination that the virtual object has a second movement characteristic, different from the first movement characteristic, the threshold distance from the first surface, that is used to determine how the virtual object moves in response to detecting the first input, is a second threshold distance from the first surface, different from the first threshold distance.

7. The method of claim 6, wherein:
the first movement characteristic corresponds to a first speed of the virtual object;
and the second movement corresponds to a second speed of the virtual object; and
the second speed is different from the first speed.

8. The method of claim 6, wherein:
the first movement characteristic corresponds to a first height of the virtual object from the first surface;
the second movement characteristic corresponds to a second height of the virtual object from the first surface; and
the second height is different from the first height.

9. The method of claim 1, including, in response to detecting the first input:
moving the virtual object from the second location to a fourth location in accordance with a first part of the first input and in accordance with a virtual attractive force having a first strength while the virtual object is at the fourth location, wherein the fourth location is closer to the first surface than the second location; and
moving the virtual object from the fourth location to a fifth location in accordance with a second part of the first input, after the first part of the first input, and in accordance with the virtual attractive force, wherein:
the virtual attractive force has a second strength, greater than the first strength while the virtual object is at the fifth location; and
the fifth location is closer to the first surface than the fourth location.

10. The method of claim 9, including, in response to detecting the first input:
moving the virtual object from the fifth location to a sixth location in accordance with a third part of the first input, after the first and second parts of the first input, and in accordance with the virtual attractive force, wherein:
the virtual attractive force has a third strength, less than the second strength while the virtual object is at the sixth location;
the sixth location is closer to the first surface than the fifth location; and
the sixth location is within a respective threshold distance from the first surface.

11. The method of claim 1, further comprising:
while moving the virtual object relative to the first surface, detecting a second input, via the one or more input devices, corresponding to a request to rotate the virtual object about an axis parallel to the first surface; and
in response to detecting the second input, in accordance with a determination that the virtual object is within a threshold distance of the first surface, forgoing rotation of the virtual object about the axis parallel to the first surface.

12. The method of claim 11, wherein:
the second input includes a first component that includes rotation about an axis perpendicular to a plane of the first surface;
the second input includes a second component that includes rotation about the axis parallel to the plane of the first surface; and
the method further comprises, in response to detecting the second input:
rotating the virtual object about the axis perpendicular to the plane of the first surface in accordance with the first component of the second input; and
forgoing rotation of the virtual object about the axis parallel to the plane of the first surface in accordance with the second component of the second input.

13. The method of claim 1, further comprising:
before detecting the first input, displaying an orientation indication with the virtual object, wherein the orientation indication indicates a side of the virtual object that is available to snap to a surface; and
in response to detecting the first input:
in accordance with the determination that the one or more snapping criteria are satisfied, ceasing to display the orientation indication; and
in accordance with the determination that the one or more snapping criteria are not satisfied, continuing display of the orientation indication.

14. The method of claim 1, wherein the first surface is a horizontal surface.

15. The method of claim 1, wherein the first surface is a vertical surface.

16. The method of claim 1, wherein the first input includes a first movement component corresponding to movement along a first directional axis in the three-dimensional environment, and a second movement component corresponding to movement along a second directional axis in the three-dimensional environment, different from the first directional axis in the three-dimensional environment, the method further comprising:
in response to detecting the first input corresponding to moving the virtual object to the second location within the three-dimensional environment from the first location:
in accordance with a determination that one or more first criteria are satisfied, moving the virtual object along the first directional axis in accordance with the first movement component and suppressing at least a portion of movement of the virtual object along the second directional axis relative to the second movement component; and
in accordance with a determination that one or more second criteria are satisfied, moving the virtual object along the second directional axis in accordance with the second movement component and suppressing at least a portion of movement of the virtual object along the first directional axis relative to the first movement component.

17. The method of claim 16, wherein:
the first one or more criteria include a criterion that is satisfied when the first movement component of the first input is larger than the second movement component of the first input; and
the second one or more criteria include a criterion that is satisfied when the second movement component of the first input is larger than the first movement component of the first input.

18. The method of claim 16, wherein:
in response to detecting the first input corresponding to moving the virtual object to the second location within the three-dimensional environment from the first location, and in accordance with the determination that the one or more first criteria are satisfied, moving the virtual object along the first directional axis includes moving the virtual object along the first directional axis with a magnitude that is increased based on a magnitude of the second movement component of the first input along the second directional axis; and
in response to detecting the first input corresponding to moving the virtual object to the second location within the three-dimensional environment from the first location, and in accordance with the determination that the one or more second criteria are satisfied, moving the virtual object along the second directional axis includes moving the virtual object along the second directional axis with a magnitude that is increased based on a magnitude of the first movement component of the first input along the first directional axis.

19. The method of claim 16, wherein:
suppressing the movement of the virtual object along the second directional axis relative to the second movement component includes:
in accordance with a determination that a distance between the virtual object and the first surface is a first respective distance within the threshold distance of the first surface, suppressing movement of the virtual object along the second directional axis relative to the second movement component by a first suppression factor; and
in accordance with a determination that the distance between the virtual object and the first surface is a second respective distance, smaller than the first respective distance, within the threshold distance of the first surface, suppressing movement of the virtual object along the second directional axis relative to the second movement component by a second suppression factor, larger than the first suppression factor; and
suppressing the movement of the virtual object along the first directional axis relative to the first movement component includes:
in accordance with the determination that the distance between the virtual object and the first surface is the first respective distance within the threshold distance of the first surface, suppressing movement of the virtual object along the first directional axis relative to the first movement component by the first suppression factor; and
in accordance with the determination that the distance between the virtual object and the first surface is the second respective distance, smaller than the first respective distance, within the threshold distance of the first surface, suppressing movement of the virtual object along the first directional axis relative to the first movement component by the second suppression factor, larger than the first suppression factor.

20. The method of claim 1, wherein the virtual object is a window.

21. The method of claim 1, wherein the virtual object is a three-dimensional volume.

22. The method of claim 1, wherein:
the one or more snapping criteria include a criterion that is satisfied when the first surface is a first surface type; and
the one or more snapping are not satisfied when the first surface is a second surface type, different from the first surface type.

23. The method of claim 1, wherein the one or more snapping criteria include a criterion that is satisfied when the virtual object is not being shared during a communication session with an external computer system.

24. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, a virtual object at a first location that is a first distance from a first surface in a three-dimensional environment, detecting a first input, via the one or more input devices, corresponding to moving the virtual object to a second location within the three-dimensional environment that is at a second distance, different from the first distance, from the first surface, wherein the first location is further than a threshold distance from the first surface and the second location is closer than the threshold distance from the first surface; and
in response to detecting the first input:
in accordance with a determination that one or more snapping criteria are satisfied while the virtual object is the second distance from the first surface, moving the virtual object to a third location that is closer to the first surface than the first location and the second location; and
in accordance with a determination that the one or more snapping criteria are not satisfied while the virtual object is the second distance from the first surface, moving the virtual object to the second location without moving the virtual object closer to the first surface.

25. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, a virtual object at a first location that is a first distance from a first surface in a three-dimensional environment, detecting a first input, via the one or more input devices, corresponding to moving the virtual object to a second location within the three-dimensional environment that is at a second distance, different from the first distance, from the first surface, wherein the first location is further than a threshold distance from the first surface and the second location is closer than the threshold distance from the first surface; and
in response to detecting the first input:
in accordance with a determination that one or more snapping criteria are satisfied while the virtual object is the second distance from the first surface, moving the virtual object to a third location that is closer to the first surface than the first location and the second location; and
in accordance with a determination that the one or more snapping criteria are not satisfied while the virtual object is the second distance from the first surface, moving the virtual object to the second location without moving the virtual object closer to the first surface.

26-52. (canceled)
